(19) United States
(12) Patent Application Publication
(10) Pub. No.: US 2014/0032310 A1
(43) Pub. Date: Jan. 30, 2014

(54) MULTI-STAGE CROWD FUNDING PROCESS

(71) Applicant: CORRIE-JONES COMPANY LLC, Portland, OR (US)

(72) Inventors: Cathleen Eva Corrie, Portland, OR (US); Ian Denio Jones, Portland, OR (US)

(73) Assignee: CORRIE-JONES COMPANY LLC, Portland, OR (US)

(21) Appl. No.: 13/949,520

(22) Filed: Jul. 24, 2013

Related U.S. Application Data
(60) Provisional application No. 61/675,217, filed on Jul. 24, 2012.
(60) Provisional application No. 61/694,116, filed on Aug. 28, 2012.
(60) Provisional application No. 61/713,274, filed on Oct. 12, 2012.
(60) Provisional application No. 61/792,555, filed on Mar. 15, 2013.
(60) Provisional application No. 61/819,917, filed on May 6, 2013.

(51) Int. Cl. G06Q 30/02

(52) U.S. Cl. CPC G06Q 30/0246
USPC 705/14.45

(57) ABSTRACT

Embodiments herein may include a computer-implemented method that may include generating, using one or more computing devices, a plurality of user accounts, each associated with a particular user, the plurality of user accounts associated with a crowd-funding website. The method may further include allowing, via a graphical user interface associated with at least one of the plurality of user accounts, the particular user to determine what personal information to disclose to one or more merchants. The method may also include assigning an initial engagement value to each user account based upon, at least in part, each user's actions with one or more merchants and identifying at least one trackable purchase event associated with each user account. The method may also include adjusting the initial engagement value based upon a level of personal information disclosed to the one or more merchants and the at least one trackable purchase event.

### CROSS-REFERENCE TO RELATED APPLICATIONS

This application claims the benefit of U.S. Provisional Application having Ser. No. 61/675,217, filed Jul. 24, 2012, U.S. Provisional Application having Ser. No. 61/694,116, filed Aug. 28, 2012, U.S. Provisional Application having Ser. No. 61/713,274, filed Oct. 12, 2012, U.S. Provisional Application having Ser. No. 61/792,555, filed Mar. 15, 2013, and U.S. Provisional Application having Ser. No. 61/819,917, filed May 6, 2013, of which the entire contents are incorporated herein by reference.

### BACKGROUND

Marketing historically has based its approach primarily upon the sampling of very large singular audiences and the extrapolation of that sampling into current demographic systems. However, with the heavy fragmentation of media, from traditional network and cable advertising into numerous forms of online delivery systems, the logistical and statistical value of traditional demographic systems have strained to keep up with the evolution of the audience and its engagement with all the entertainment available. The effect of this approach has led to a system that values quantity of consumers, not the quality of their relationship to your advertising delivery system.

### SUMMARY

In one or more embodiments of the present disclosure, a computer-implemented method may include generating, using one or more computing devices, a plurality of user accounts, each associated with a particular user, the plurality of user accounts associated with a crowd-funding website. The method may further include allowing, via a graphical user interface associated with at least one of the plurality of user accounts, the particular user to determine what personal information to disclose to one or more merchants. The method may also include assigning an initial engagement value to each user account based upon, at least in part, each user's actions with one or more merchants and identifying at least one trackable purchase event associated with each user account. The method may also include adjusting the initial engagement value based upon a level of personal information disclosed to the one or more merchants and the at least one trackable purchase event.

One or more of the following features may be included. In some embodiments, the method may include allowing, via the plurality of user accounts, at least one financial contribution to a beneficiary. In some embodiments, allowing may include allowing a plurality of contributions to a plurality of beneficiaries. The plurality of user accounts may each include a security randomizer. The crowd-funding website may include an ignition phase. The crowd-funding website may also include an achievement phase. The crowd-funding website may further include a sustain phase.

In some embodiments, a computer-readable storage medium for electronic design simulation is provided. The computer-readable storage medium may have stored thereon instructions that when executed by a machine result in one or more operations. Operations may include generating, using one or more computing devices, a plurality of user accounts, each associated with a particular user, the plurality of user accounts associated with a crowd-funding website. Operations may further include allowing, via a graphical user interface associated with at least one of the plurality of user accounts, the particular user to determine what personal information to disclose to one or more merchants. Operations may also include assigning an initial engagement value to each user account based upon, at least in part, each user's actions with one or more merchants and identifying at least one trackable purchase event associated with each user account. Operations may also include adjusting the initial engagement value based upon a level of personal information disclosed to the one or more merchants and the at least one trackable purchase event.

One or more of the following features may be included. In some embodiments, operations may include allowing, via the plurality of user accounts, at least one financial contribution to a beneficiary. In some embodiments, allowing may include allowing a plurality of contributions to a plurality of beneficiaries. The plurality of user accounts may each include a security randomizer. The crowd-funding website may include an ignition phase. The crowd-funding website may also include an achievement phase. The crowd-funding website may further include a sustain phase.

In one or more embodiments of the present disclosure, a system may include a computing device having at least one processor configured to generate a plurality of user accounts, each associated with a particular user, the plurality of user accounts associated with a crowd-funding website. The one or more processors may be further configured to allow, via a graphical user interface associated with at least one of the plurality of user accounts, the particular user to determine what personal information to disclose to one or more merchants. The one or more processors may be further configured to assign an initial engagement value to each user account based upon, at least in part, each user's actions with one or more merchants. The one or more processors may be further configured to identify at least one trackable purchase event associated with each user account. The one or more processors may be further configured to adjust the initial engagement value based upon a level of personal information disclosed to the one or more merchants and the at least one trackable purchase event.

One or more of the following features may be included. In some embodiments, the one or more processors may be further configured to allow, via the plurality of user accounts, at least one financial contribution to a beneficiary. Allowing may include allowing a plurality of contributions to a plurality of beneficiaries. The plurality of user accounts may each include a security randomizer. In some embodiments, the crowd-funding website may include at least an ignition phase and an achievement phase.

Additional features and advantages of embodiments of the present disclosure will be set forth in the description which follows, and in part will be apparent from the description, or may be learned by practice of embodiments of the present disclosure. The objectives and other advantages of the embodiments of the present disclosure may be realized and attained by the structure particularly pointed out in the written description and claims hereof as well as the appended drawings.

It is to be understood that both the foregoing general description and the following detailed description are exemplary and explanatory and are intended to provide further explanation of embodiments of the invention as claimed.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 is a system diagram depicting aspects of the marketing process in accordance with an embodiment of the present disclosure;

FIG. 2 is a flow diagram of a process in accordance with one or more embodiments of the present disclosure;

FIG. 3 is a schematic depicting aspects of the marketing process in accordance with an embodiment of the present disclosure;

FIG. 4 is a schematic depicting aspects of the marketing process in accordance with an embodiment of the present disclosure;

FIG. 5 is a schematic depicting aspects of the marketing process in accordance with an embodiment of the present disclosure;

FIG. 6 is a schematic depicting aspects of the marketing process in accordance with an embodiment of the present disclosure;

FIG. 7 is a schematic depicting aspects of the marketing process in accordance with an embodiment of the present disclosure;

FIG. 8 is a schematic depicting aspects of the marketing process in accordance with an embodiment of the present disclosure;

FIG. 9 is a schematic depicting aspects of the marketing process in accordance with an embodiment of the present disclosure;

FIG. 10 is a schematic depicting aspects of the marketing process in accordance with an embodiment of the present disclosure;

FIG. 11 is a schematic depicting aspects of the marketing process in accordance with an embodiment of the present disclosure;

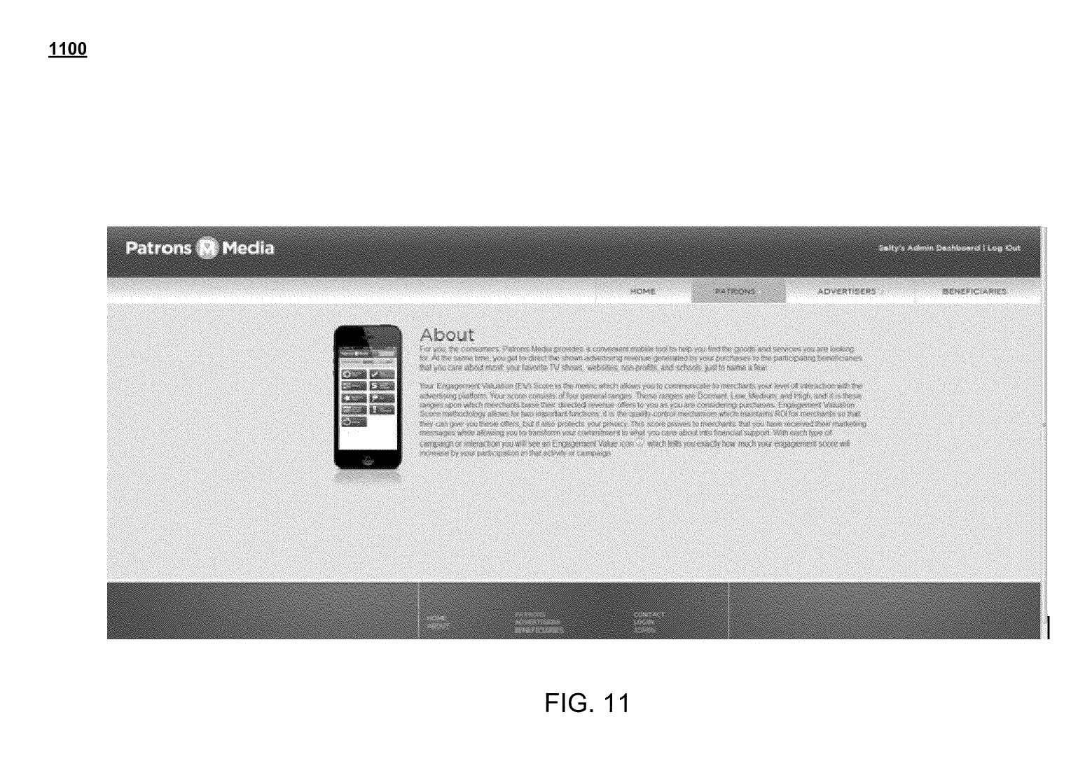

FIG. 12 is a schematic depicting aspects of the marketing process in accordance with an embodiment of the present disclosure;

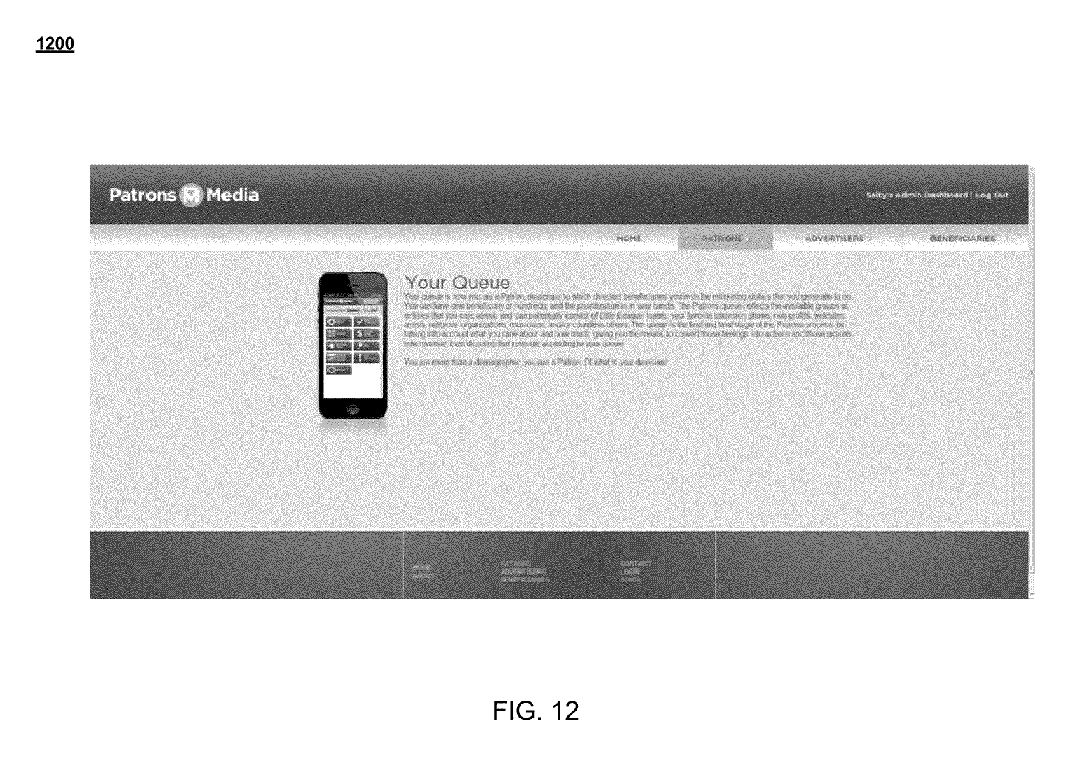

FIG. 13 is a schematic depicting aspects of the marketing process in accordance with an embodiment of the present disclosure;

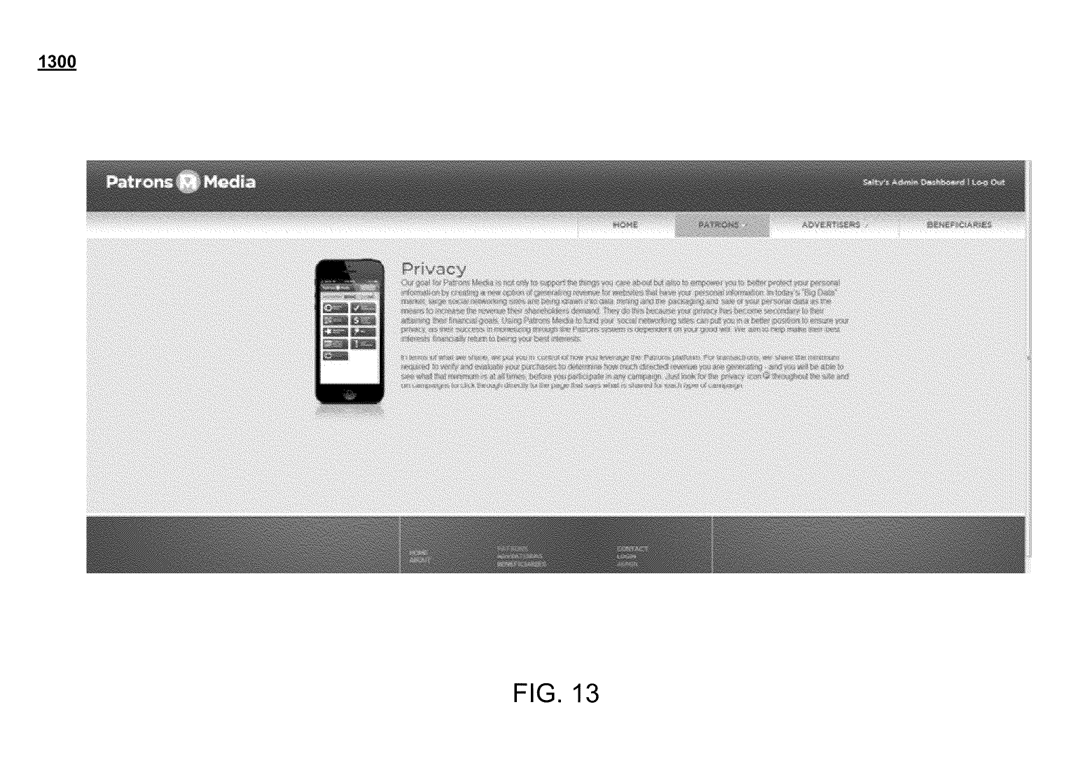

FIG. 14 is a schematic depicting aspects of the marketing process in accordance with an embodiment of the present disclosure;

FIG. 15 is a schematic depicting aspects of the marketing process in accordance with an embodiment of the present disclosure;

FIG. 16 is a schematic depicting aspects of the marketing process in accordance with an embodiment of the present disclosure;

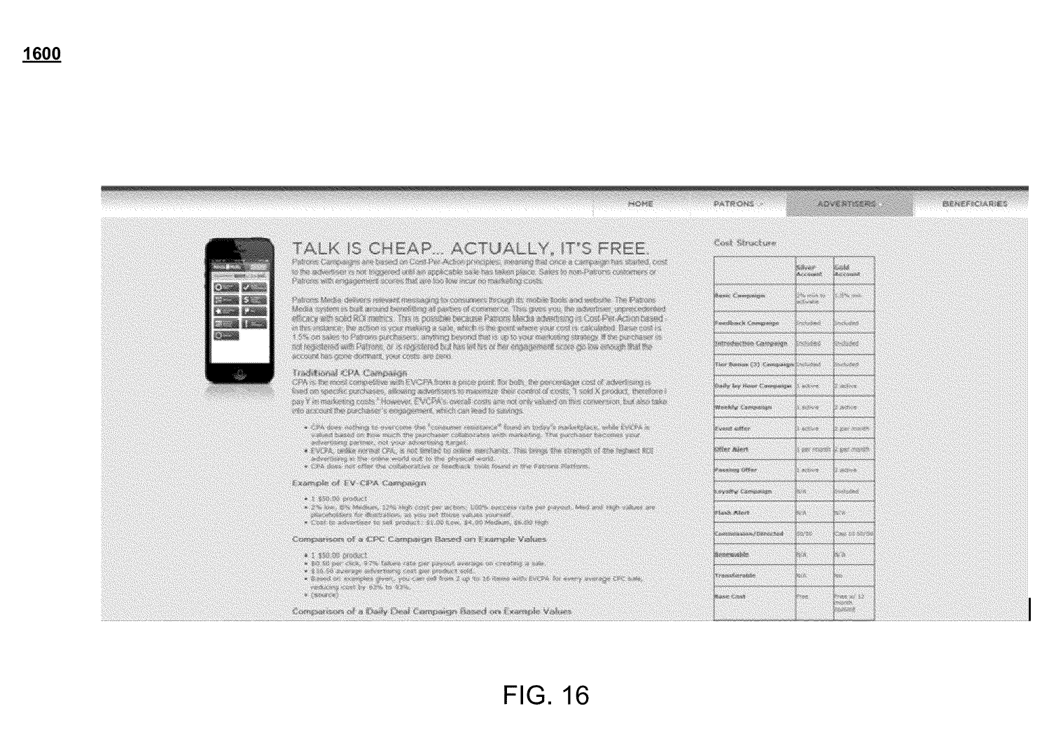

FIG. 17 is a schematic depicting aspects of the marketing process in accordance with an embodiment of the present disclosure;

FIG. 18 is a schematic depicting aspects of the marketing process in accordance with an embodiment of the present disclosure;

FIG. 19 is a schematic depicting aspects of the marketing process in accordance with an embodiment of the present disclosure;

FIG. 20 is a schematic depicting aspects of the marketing process in accordance with an embodiment of the present disclosure;

FIG. 21 is a schematic depicting aspects of the marketing process in accordance with an embodiment of the present disclosure;

FIG. 22 is a schematic depicting aspects of the marketing process in accordance with an embodiment of the present disclosure.

FIG. 23 is a schematic depicting aspects of the marketing process in accordance with an embodiment of the present disclosure;

FIG. 24 is a schematic depicting aspects of the marketing process in accordance with an embodiment of the present disclosure;

FIG. 25 is a schematic depicting aspects of the marketing process in accordance with an embodiment of the present disclosure;

FIG. 26 is a schematic depicting aspects of the marketing process in accordance with an embodiment of the present disclosure;

FIG. 27 is a schematic depicting aspects of the marketing process in accordance with an embodiment of the present disclosure;

FIG. 28 is a schematic depicting aspects of the marketing process in accordance with an embodiment of the present disclosure;

FIG. 29 is a schematic depicting aspects of the marketing process in accordance with an embodiment of the present disclosure;

FIG. 30 is a schematic depicting aspects of the marketing process in accordance with an embodiment of the present disclosure;

FIG. 31 is a schematic depicting aspects of the marketing process in accordance with an embodiment of the present disclosure;

FIG. 32 is a schematic depicting aspects of the marketing process in accordance with an embodiment of the present disclosure;

FIG. 33 is a schematic depicting aspects of the marketing process in accordance with an embodiment of the present disclosure;

FIG. 34 is a schematic depicting aspects of the marketing process in accordance with an embodiment of the present disclosure;

FIG. 35 is a schematic depicting aspects of the marketing process in accordance with an embodiment of the present disclosure;

FIG. 36 is a schematic depicting aspects of the marketing process in accordance with an embodiment of the present disclosure;

FIG. 37 is a schematic depicting aspects of the marketing process in accordance with an embodiment of the present disclosure;

FIG. 38 is a schematic depicting aspects of the marketing process in accordance with an embodiment of the present disclosure;

FIG. 39 is a schematic depicting aspects of the marketing process in accordance with an embodiment of the present disclosure;

FIG. 40 is a schematic depicting aspects of the marketing process in accordance with an embodiment of the present disclosure;

FIG. 41 is a schematic depicting aspects of the marketing process in accordance with an embodiment of the present disclosure;

FIG. 42 is a schematic depicting aspects of the marketing process in accordance with an embodiment of the present disclosure.

FIG. 43 is a schematic depicting aspects of the marketing process in accordance with an embodiment of the present disclosure;

FIG. 44 is a schematic depicting aspects of the marketing process in accordance with an embodiment of the present disclosure;

FIG. 45 is a schematic depicting aspects of the marketing process in accordance with an embodiment of the present disclosure;

FIG. 46 is a schematic depicting aspects of the marketing process in accordance with an embodiment of the present disclosure;

FIG. 47 is a schematic depicting aspects of the marketing process in accordance with an embodiment of the present disclosure;

FIG. 48 is a schematic depicting aspects of the marketing process in accordance with an embodiment of the present disclosure;

FIG. 49 is a schematic depicting aspects of the marketing process in accordance with an embodiment of the present disclosure;

FIG. 50 is a schematic depicting aspects of the marketing process in accordance with an embodiment of the present disclosure;

FIG. 51 is a schematic depicting aspects of the marketing process in accordance with an embodiment of the present disclosure;

FIG. 52 is a schematic depicting aspects of the marketing process in accordance with an embodiment of the present disclosure;

FIG. 53 is a schematic depicting aspects of the marketing process in accordance with an embodiment of the present disclosure;

FIG. 54 is a schematic depicting aspects of the marketing process in accordance with an embodiment of the present disclosure;

FIG. 55 is a schematic depicting hardware configured to implement the marketing process in accordance with an embodiment of the present disclosure;

FIG. 56 is a schematic depicting aspects of the marketing process in accordance with an embodiment of the present disclosure; and

FIG. 57 is a schematic depicting aspects of the marketing process in accordance with an embodiment of the present disclosure.

Like reference symbols in the various drawings may indicate like elements.

### DETAILED DESCRIPTION

Embodiments of the present disclosure are directed towards a computer-implemented marketing process 10. Accordingly, embodiments herein may assign an aggregate ongoing engagement value to a user account. In some embodiments, this may be based on the marketability of individual's interactions with various websites and technologies. In this way, marketing process 10 may follow trackable purchases to determine the cost per action value of the purchase events.

In some embodiments, marketing process 10 may offer 100% advertising cost efficacy as no campaign revenue may be charged without a specifically identified and viable sale having taken place. Marketing process 10 may allow for an adaptive marketing message to an individual household. In some embodiments, marketing process 10 may allow for free delivery of advertising to prospective customers that, absent a sale, may generate brand awareness at no cost. Marketing process 10 may also be configured to generate flexible campaigns that may be tailored to individual needs and may be used to influence desirable purchasing behaviors beyond obtaining a sale. Unlike traditional search engines with a web ranking focus, marketing process 10 may be used as a social commerce marketing tool that may operate effectively for both online and offline merchants.

In some embodiments, marketing process 10 may be used with a variety of computing devices and by a variety of different types of users. For example, the Advertising Partner (AP), the Purchasing Partner (PP), and the Directed Beneficiary (DB). The hybrid mechanism of marketing process 10 that creates the benefit to all parties is referred to as Engagement-Valued Cost Per Action (“EVCPA”) advertising. EVCPA may only incur cost if a specific action takes place, such as a purchase. This cost controlled structure is combined with a marketing productivity metric, referred to herein as engagement valuation.

Engagement Value is a metric through which marketing process 10 may measure Purchasing Partners' account interactions with the marketing campaigns that advertisers offer them through the system. The more they take advantage of the offerings through verifiable interactions, the higher their score. However, if Purchasing Partners allow their engagement score to drop below a prescribed amount, their activities no longer incur any cost to the Advertising Partner. The Engagement Value is how Purchasing Partners communicate their desire to work with advertisers and marketers by operating through an easily-scaled quality-control mechanism. Purchasing Partners then get to direct offered marketing revenue to the things they care about most (e.g., favorite TV shows, sports teams, websites, schools, churches, etc.), whatever motivates them to go the extra mile by becoming a Purchasing Partner.

In some embodiments, and from an Advertising Partner perspective, the advertisers set the offers, so the system automatically scales to the margins of the advertisers' industry, and is easy to fit into a budget because it is cost-per-action based. An additional advantage is that it can be used effectively by both large national companies, using EV-CPA as an ROI-based hedge in their national and international marketing campaign portfolios and thus bringing a more defined, metrics-based approach to the system, and smaller local companies who can use it to drive purchasing behaviors to their businesses even with limited marketing resources. Additionally and/or alternatively, because of the cost being calculated off of the final result (e.g., a purchase), the EV-CPA campaign can be designed not to conflict with other, more traditional offers.

In some embodiments, Purchasing Partners may be given a website and mobile tools to interact with the campaigns and events that are currently running on the Patrons Media website, allowing PPs to make traceable whichever interactions they desire. They also get to assign a multi-variable queue system to their list of directed beneficiaries (DBs), through which they express where they want the generated revenue to be directed. The management of the queue does not actually have an engagement value assigned to it; the engagement valuation may only be triggered by behaviors that are desirable to advertisers. For example, managing the queue does not increase engagement score; however, sharing a purchase on social media sites, confirming participation in specific events, viewing advertising, interacting with advertising, communicating with advertisers, making oneself more open to receiving highly “pushed” advertising messaging, etc. all would increase a PP engagement score. Examples of engagement calculations are provided below.

As used herein, the phrase “Directed Beneficiaries” may refer to the entities receiving the funds that have been directed by the users. For example, the user's favorite TV show, favorite artist, schools, sports team, churches, SuperPAC, etc. These organizations may also have access to many of the same social media tools provided to the Advertising Partners to help communicate with and mobilize their communities.

Reference will now be made in detail to the embodiments of the present disclosure, examples of which are illustrated in the accompanying drawings. The present disclosure may, however, be embodied in many different forms and should not be construed as being limited to the embodiments set forth herein. Rather, these embodiments are provided so that this disclosure will be thorough and complete, and will fully convey the concept of the disclosure to those skilled in the art.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer readable medium may be a computer readable signal medium or a computer readable storage medium. A computer-usable, or computer-readable, storage medium (including a storage device associated with a computing device or client electronic device) may be, for example, but not limited to, an electronic, magnetic, optical, electromagnetic, infrared, or semiconductor system, apparatus, or device, or any suitable combination of the foregoing. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device. In the context of this document, a computer-usable, or computer-readable, storage medium may be any tangible medium that can contain, or store a program for use by or in connection with the instruction execution system, apparatus, or device.

A computer readable signal medium may include a propagated data signal with computer readable program coded embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

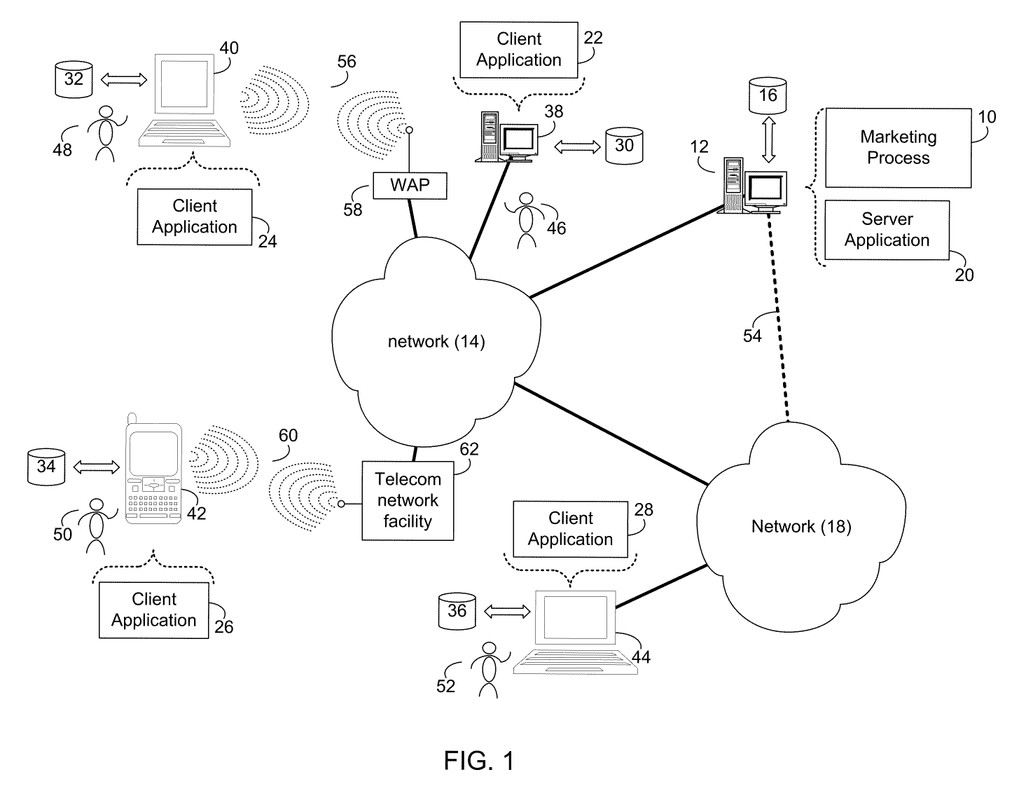

Referring to FIG. 1, there is shown a marketing process 10 that may reside on and may be executed by server computer 12, which may be connected to network 14 (e.g., the Internet or a local area network). Examples of server computer 12 may include, but are not limited to: a personal computer, a server computer, a series of server computers, a mini computer, and a mainframe computer. Server computer 12 may be a web server (or a series of servers) running a network operating system, examples of which may include but are not limited to: Microsoft® Windows® Server; Novell® NetWare®; or Red Hat® Linux®, for example. (Microsoft and Windows are registered trademarks of Microsoft Corporation in the United States, other countries or both; Novell and NetWare are registered trademarks of Novell Corporation in the United States, other countries or both; Red Hat is a registered trademark of Red Hat Corporation in the United States, other countries or both; and Linux is a registered trademark of Linus Torvalds in the United States, other countries or both.) Additionally/alternatively, the report generation process may reside on and be executed, in whole or in part, by a client electronic device, such as a personal computer, notebook computer, personal digital assistant, or the like.

The instruction sets and subroutines of marketing process 10, which may include one or more software modules, and which may be stored on storage device 16 coupled to server computer 12, may be executed by one or more processors (not shown) and one or more memory modules (not shown) incorporated into server computer 12. Storage device 16 may include but is not limited to: a hard disk drive; a solid state drive, a tape drive; an optical drive; a RAID array; a random access memory (RAM); and a read-only memory (ROM). Storage device 16 may include various types of files and file types.

Server computer 12 may execute a web server application, examples of which may include but are not limited to: Microsoft IIS, Novell Webserver™, or Apache® Webserver, that allows for HTTP (i.e., HyperText Transfer Protocol) access to server computer 12 via network 14 (Webserver is a trademark of Novell Corporation in the United States, other countries, or both; and Apache is a registered trademark of Apache Software Foundation in the United States, other countries, or both). Network 14 may be connected to one or more secondary networks (e.g., network 18), examples of which may include but are not limited to: a local area network; a wide area network; or an intranet, for example.

Marketing process 10 may be a stand alone application, or may be an applet/application/script that may interact with and/or be executed within server application 20. In addition/as an alternative to being a server-side process, the process may be a client-side process (not shown) that may reside on a client electronic device (described below) and may interact with a client application (e.g., one or more of client applications 22, 24, 26, 28). Further, marketing process 10 may be a hybrid server-side/client-side process that may interact with server application 20 and a client application (e.g., one or more of client applications 22, 24, 26, 28). As such, marketing process 10 may reside, in whole, or in part, on server computer 12 and/or one or more client electronic devices.

The instruction sets and subroutines of server application 20, which may be stored on storage device 16 coupled to server computer 12 may be executed by one or more processors (not shown) and one or more memory modules (not shown) incorporated into server computer 12.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory modules (not shown) incorporated into client electronic devices 38, 40, 42, 44 (respectively). Storage devices 30, 32, 34, 36 may include but are not limited to: hard disk drives; solid state drives, tape drives; optical drives; RAID arrays; random access memories (RAM); read-only memories (ROM), compact flash (CF) storage devices, secure digital (SD) storage devices, and a memory stick storage devices. Examples of client electronic devices 38, 40, 42, 44 may include, but are not limited to, personal computer 38, laptop computer 40, mobile computing device 42 (such as a smart phone, netbook, or the like), notebook computer 44, for example. Using client applications 22, 24, 26, 28, users 46, 48, 50, 52 may access EDA application 20 and may allow users to e.g., utilize marketing process 10.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (i.e., the computer that executes server application 20) may be connected to network 14 through secondary network 18, as illustrated with phantom link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 66 established between laptop computer 40 and wireless access point (i.e., WAP) 68, which is shown directly coupled to network 14. WAP 68 may be, for example, an IEEE 802.11a, 802.11b, 802.11g Wi-Fi, and/or Bluetooth device that is capable of establishing wireless communication channel 66 between laptop computer 40 and WAP 68. Mobile computing device 42 is shown wirelessly coupled to network 14 via wireless communication channel 70 established between mobile computing device 42 and cellular network/bridge 72, which is shown directly coupled to network 14.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows, Microsoft Windows CE®, Red Hat Linux, or other suitable operating system. (Windows CE is a registered trademark of Microsoft Corporation in the United States, other countries, or both.).

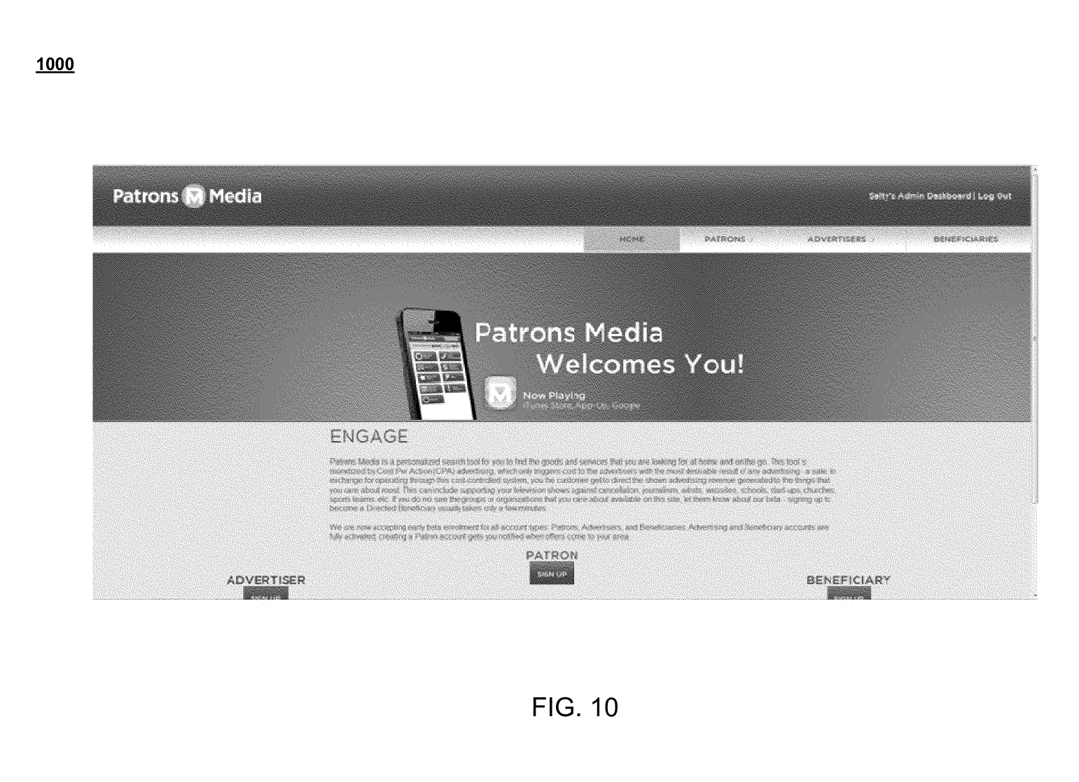

The term “user” as referred to herein, may indicate individual consumers, companies, non-profits, groups, etc. that may have a user account and may be able to utilize on or more portions of marketing process 10. The term “user” may also refer to patrons, advertisers, and beneficiaries, such as those shown in the user account of FIG. 10.

The term “purchase event” as referred to herein, may indicate any type of trackable transaction where the purchasing partner purchases a product or service in coordination with an advertising partner's advertising campaign, so that the purchasing partner's purchase incurs advertising cost on the part of the participating advertising partner.

In some embodiments, advertisers who wish to incentivize behavior short of a purchase event (i.e., a free consultation, a test drive, or attendance at a presentation, etc.) can offer users who participate in these activities a directed revenue coupon that contains a one-time-use coupon or QR code that delivers revenue to the user's beneficiary queue upon input of the coupon/QR code.

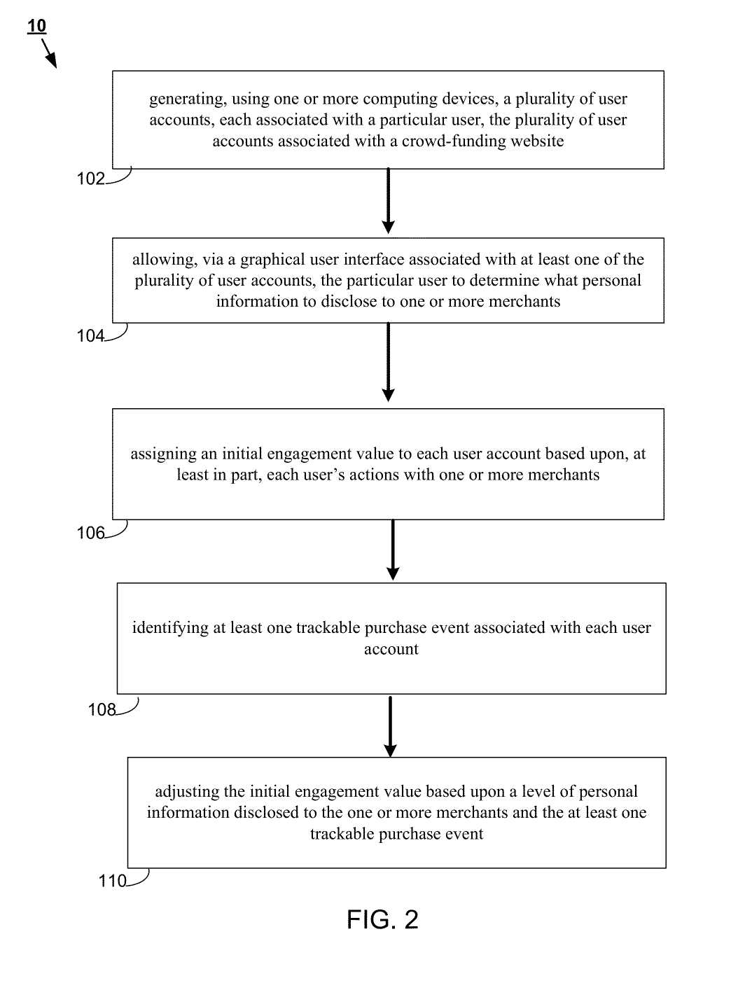

Referring now to FIG. 2 a flowchart depicting operations consistent with marketing process 10 is shown. Marketing process 10 may include generating a user account associated with a particular user and assigning an engagement value to the user account based upon, at least in part, the user's actions with one or more merchants. Marketing process 10 may further include identifying at least one trackable purchase event and an advertising campaign parameter and analyzing the engagement value of the user account, the at least one trackable purchase event, and the advertising campaign parameter to determine a cost per action associated with the purchase event.

In some embodiments, marketing process 10 may be configured to allow a user to receive a portion of generated marketing revenue using an online web-based account (e.g. via server application 20, client applications 22, 24, 26, 28). In this way, marketing process 10 may further allow for the assignment of an aggregate ongoing engagement value to a user account. In some embodiments, this engagement value may be based on marketability of a particular user's interactions with websites and various other technologies. In this way, marketing process 10 may follow trackable purchases to determine the cost per action value of the purchase events.

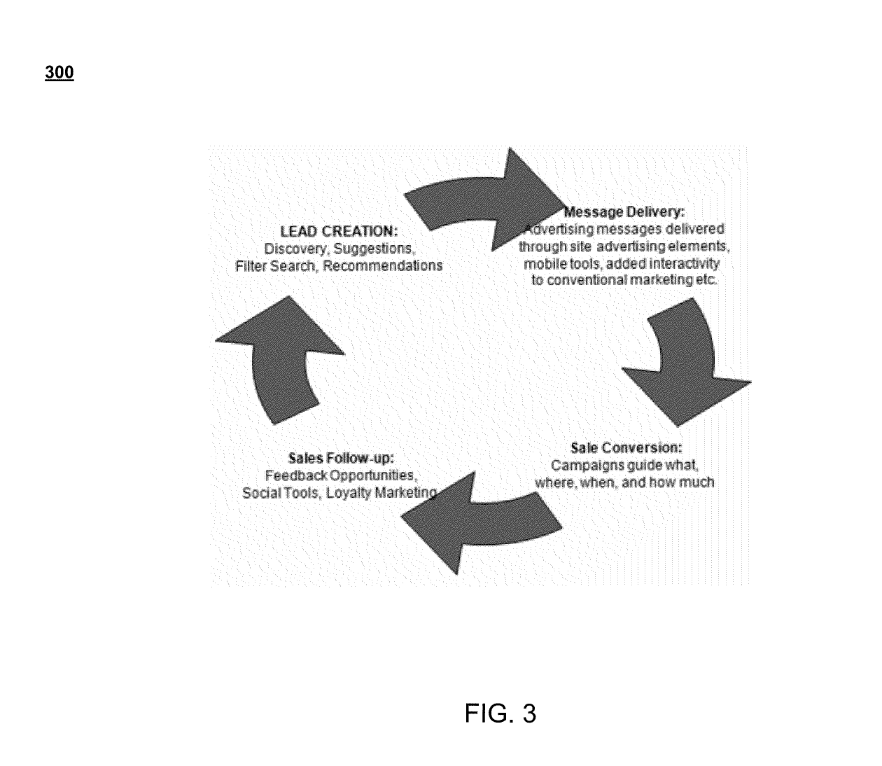

In some embodiments, marketing process 10 may assess the user's social media and technological behavioral interactions using a score and may determine the value from a marketing and advertising perspective. This engagement score may then be chronologically associated to actions such as purchases that may be tracked using a variety of different techniques. For example, through the account holders themselves, by tracking associated financial accounts activity, etc. In some embodiments, these transactions may then be cross referenced with the user's self-checkout software or point of sale inventory information for greater depth. The engagement score at the time of the purchase event and the resulting purchase data may then be cross-referenced with an advertiser's engagement based compensation offers to calculate the resulting cost per action marketing cost to the advertiser. A schematic depicting some operations consistent with marketing process 10 are shown in FIG. 3.

In some embodiments, marketing process 10 may allow a user or account holder (e.g. a consumer) to direct resulting advertising or incentive revenue which was spent to influence their shopping behavior. Accordingly, marketing process 10 may allow for the automated distribution of resulting funds based on the user's wishes. These funds may be dynamically distributed according to the goals and priorities expressed by the user in his or her user account settings.

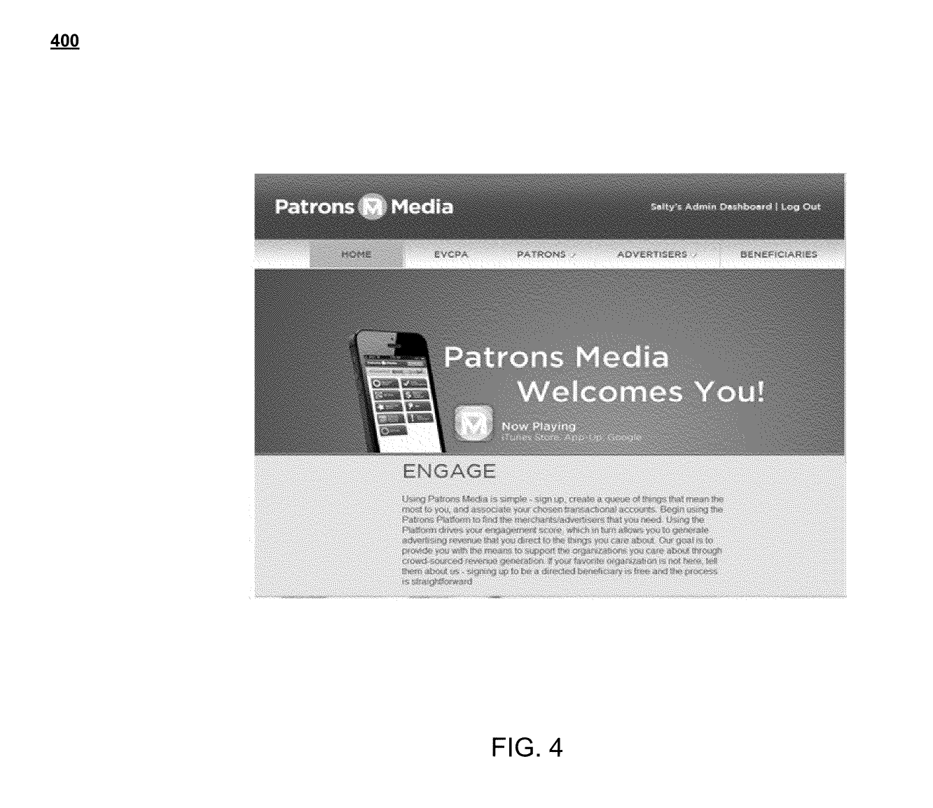

Referring now to FIG. 4, an example of an online user account 400, which may be rendered using a client application such as client application 22 is shown. As discussed above, marketing process 10 may include generating 102, using one or more computing devices, a user account 400 associated with a particular user. Marketing process 10 may assign an engagement value to the user account based upon, at least in part, the user's actions with one or more merchants.

In some embodiments, the user account may start with an initial engagement score of zero and the score may increase dependent upon the extent to which the user uses account 400. Once a user has created an account, they may create a queue of things that are of interest and may associate their chosen transactional accounts with user account 400. In some embodiments, user account 400 may allow the user to search and/or identify merchants and/or advertisers. The user's engagement score may increase corresponding to their use of account 400, thus generating revenue that the user may direct to one or more beneficiaries of their choosing (e.g. companies, non-profits, etc.). In this way, marketing process 10 may allow the user the ability to support the organizations or people that they care about using a crowd-sourced revenue generation process. Beneficiaries may be added at the request of the user at no charge.

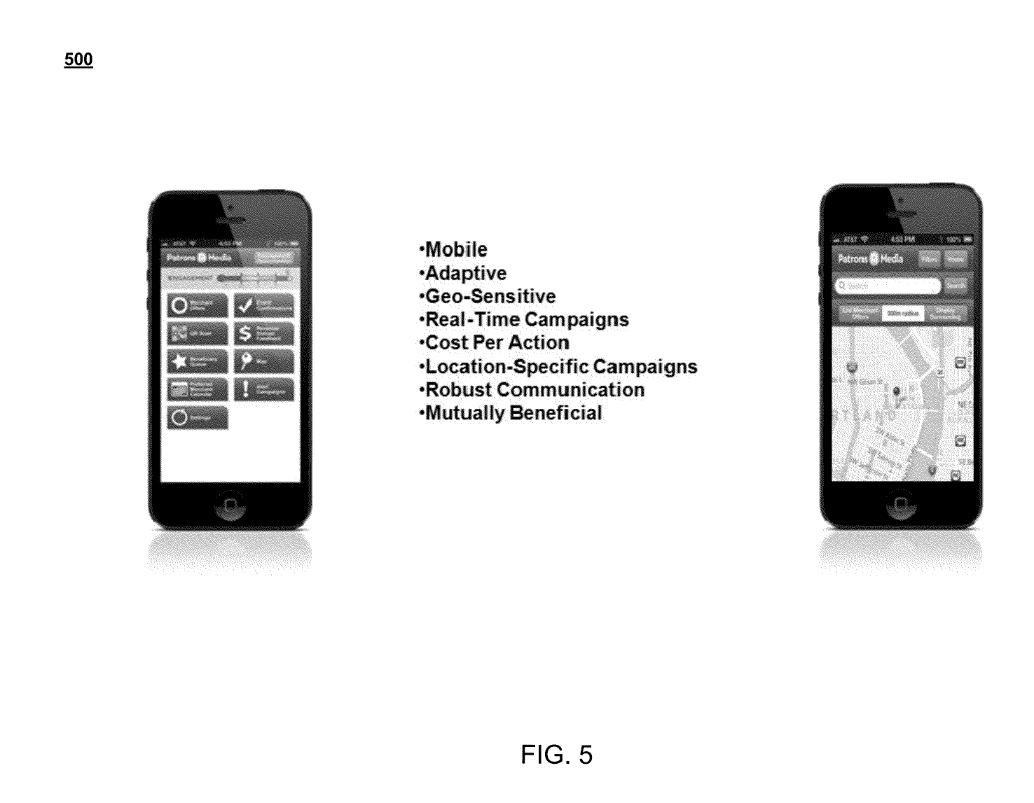

Referring now to FIG. 5, an embodiment depicting the use of marketing process 10 with a mobile device 500 is shown. In this way, it should be noted that any discussion of operations consistent with marketing process 10 may be associated with any suitable computing device.

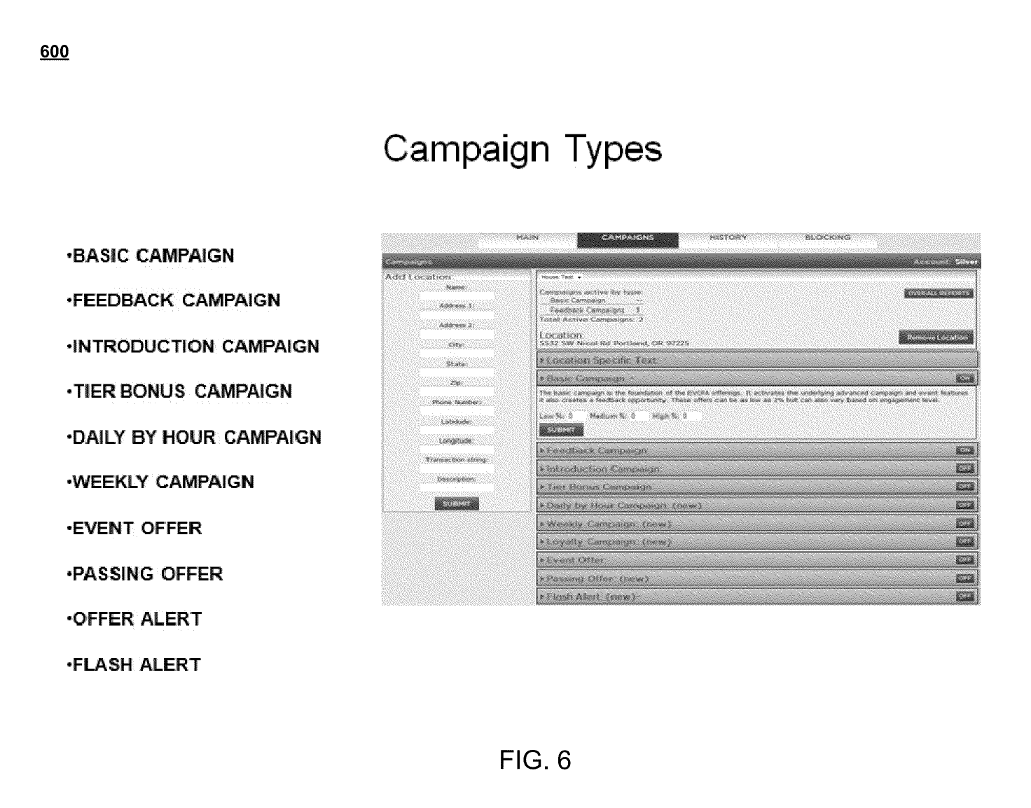

Referring now to FIG. 6, an embodiment depicting various advertising campaign types associated with user account 600 are shown. As shown in FIG. 6, some campaigns may include but are not limited to, basic campaigns, feedback campaigns, introduction campaigns, tier bonus campaigns, daily by hour campaigns, weekly campaigns, event offers, passing offers, offer alerts, and flash alerts. Numerous other campaigns may also be used without departing from the scope of the present disclosure. These campaigns are discussed in further detail below.

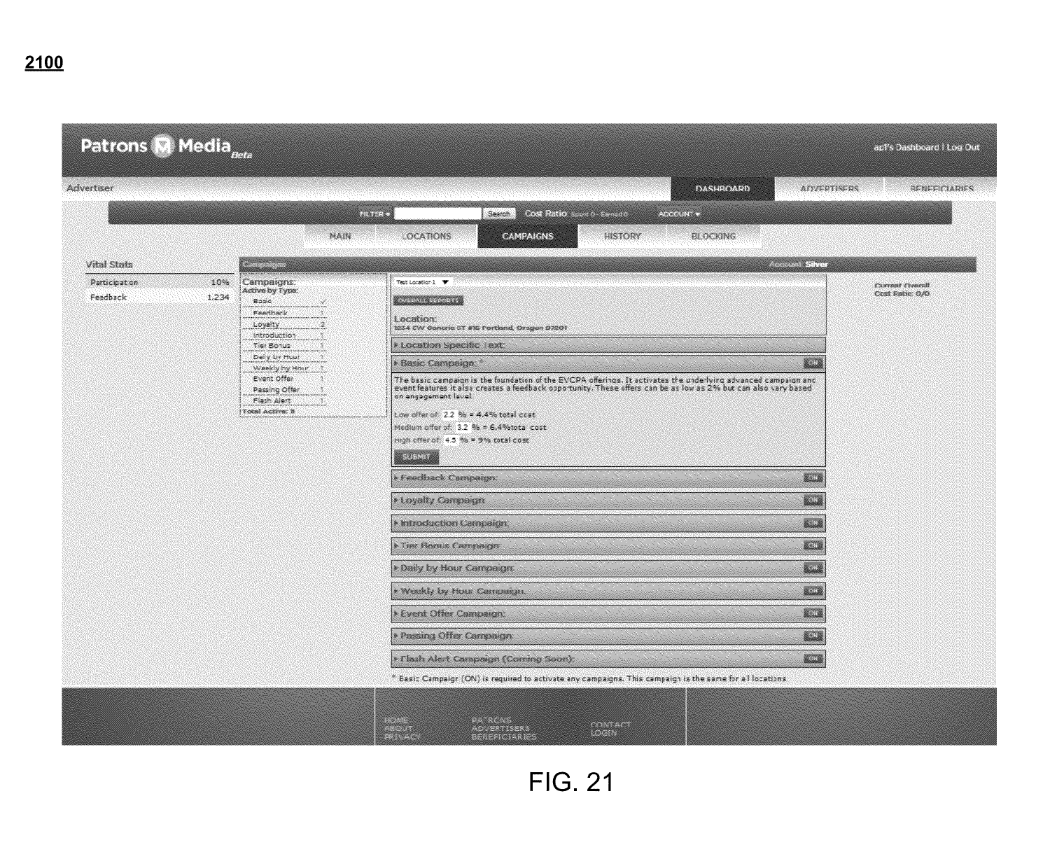

Referring also to FIG. 21, in some embodiments, the basic campaign may be associated with the user account and may set forth an example of an Engagement-Valued Cost Per Action (“EVCPA”) offering. Cost-Per-Action advertising is the highest-valued advertising in the online advertising marketplace for the advertiser. Using a cost-per-action approach, costs may be incurred only if a specific action takes place, such as a purchase.

As discussed above, the engagement value is a metric through which marketing process 10 may measure user account interactions with the various marketing campaigns offered by advertisers via the user account or advertiser account associated with the website. As users take advantage of offers through verifiable interactions, their engagement score increases. In this way, the engagement value allows for users to communicate their desire to work with advertisers by operating through an easily-scaled quality-control mechanism. In exchange, users get to direct the offered marketing revenue to the things they are most interested in, including, but not limited to, their favorite television programs, sports teams, websites, schools, churches, or any other beneficiary set forth by the user.

In some embodiments, marketing process 10 may assign a particular level of engagement to a user. For example, in one particular embodiment, four current levels of engagement may be assigned (e.g., Dormant: No Cost, Low: as low as 1.5%, Medium: as low as 1.5%, High: as low as 1.5%). These are merely provided by way of example. In some embodiments, beyond the minimums, the value may be set by the user.

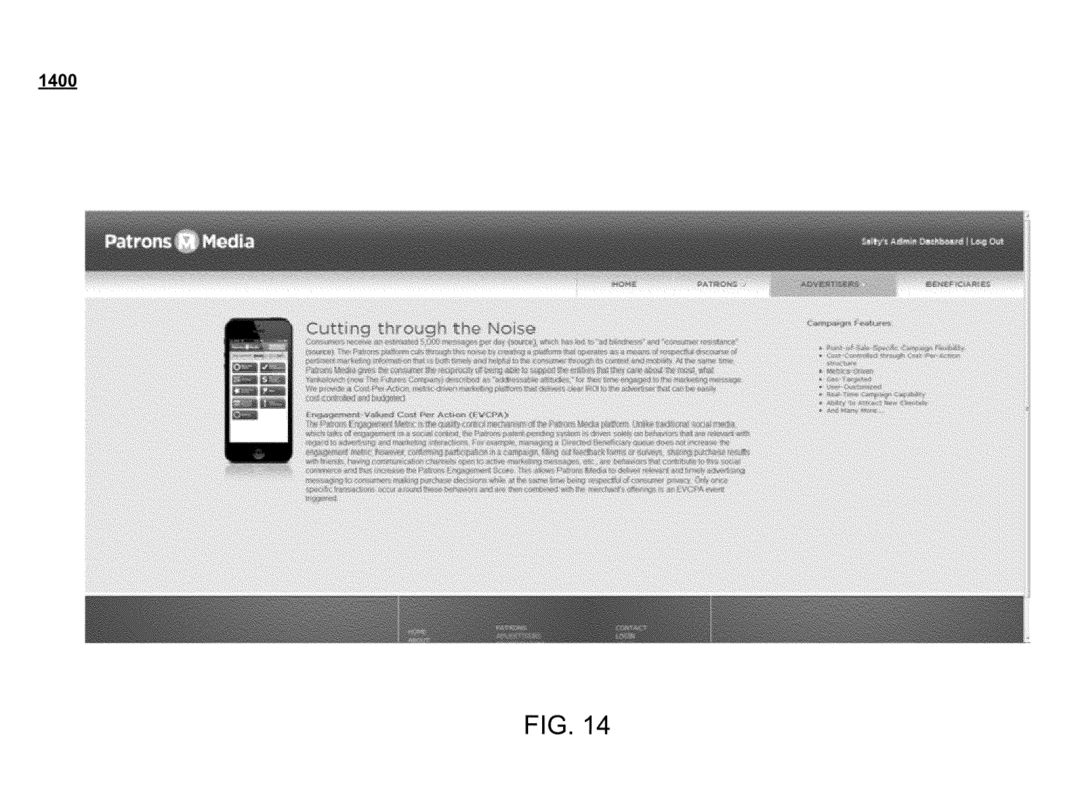

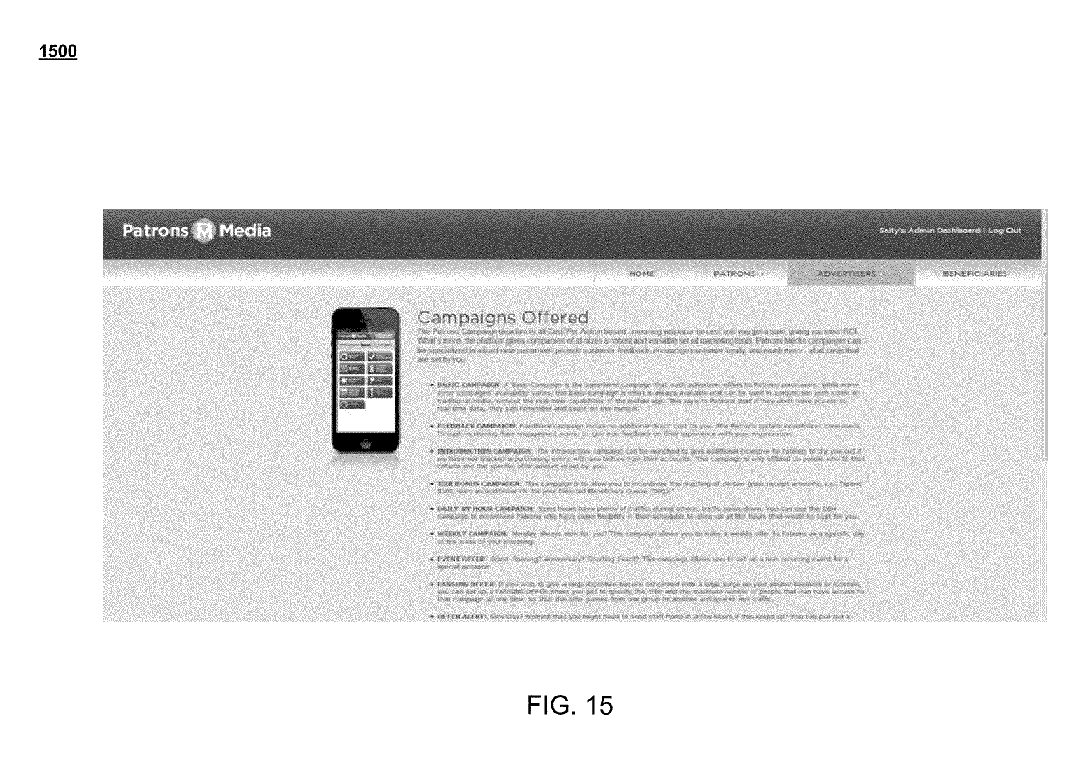

Referring now to FIG. 14, in some embodiments, EVCPA may allow an advertiser to let their customers know what types of campaigns are available. It activates the underlying advanced campaign and event features, including customer feedback. These offers can be as low as 1.5%, but can also vary based on engagement level depending on your preferences. Some campaigns may include, but are not limited to, those depicted in FIG. 15.

Accordingly, in some embodiments, marketing process 10 may be configured to identify at least one trackable purchase event and an advertising campaign parameter. Marketing process 10 also analyze the engagement value of the user account, the at least one trackable purchase event, and the advertising campaign parameter to determine a cost per action associated with the purchase event.

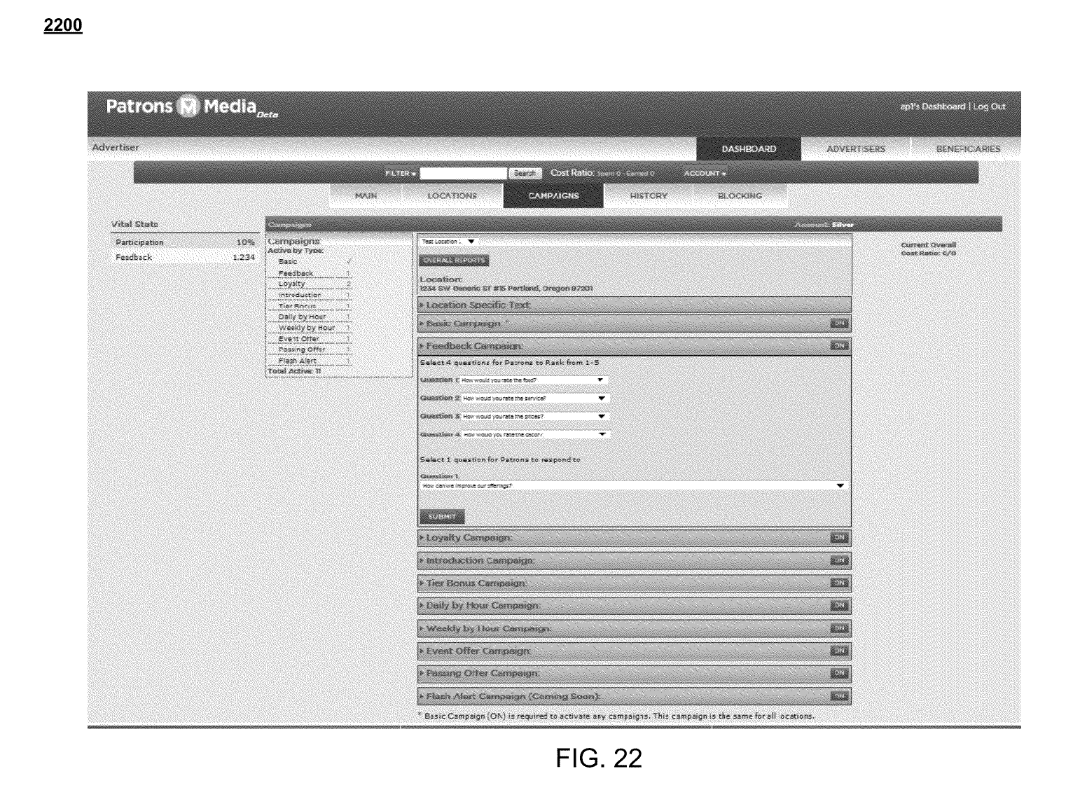

Referring also to FIG. 22, in some embodiments, a feedback campaign may be associated with the user account and may provide a free incentivized feedback opportunity. For example, most purchases may create an incentivized feedback opportunity tied into the engagement value system, where customers who have made a tracked purchase with a company may communicate some basic information (e.g. the company may select some number of questions) about their purchasing experience with that company or merchant.

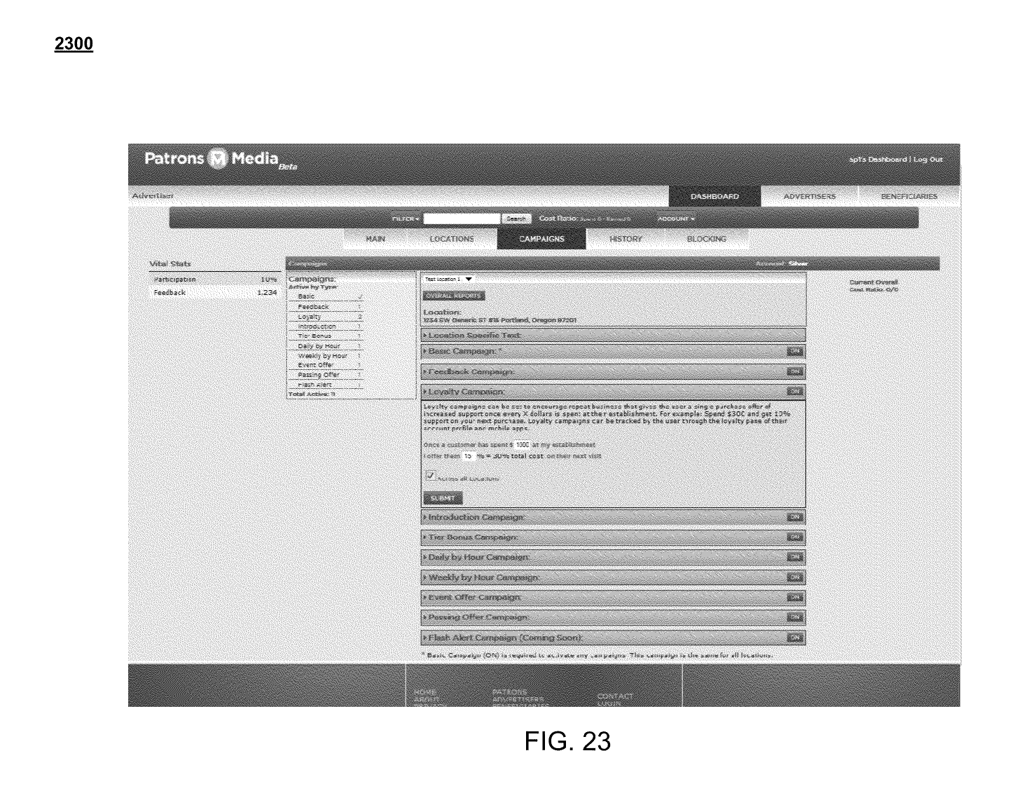

Referring also to FIG. 23, in some embodiments, a loyalty campaign may be associated with the user account and may encourage repeat business that gives the user a single purchase offer of increased support once every X dollars is spent at their establishment.

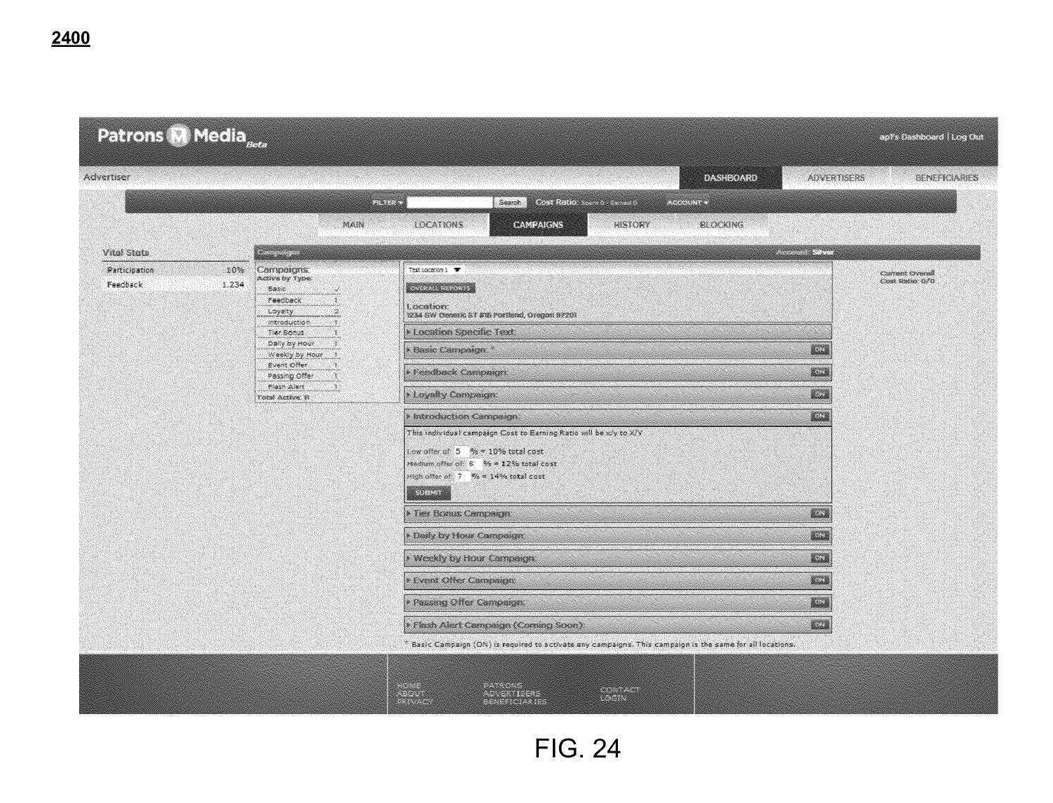

Referring also to FIG. 24, in some embodiments, an introduction campaign may be associated with the user account and may be designed to attract new customers in an affordable fashion. The introduction campaign may be offered to and only triggered by accounts who have never logged a purchase with you before.

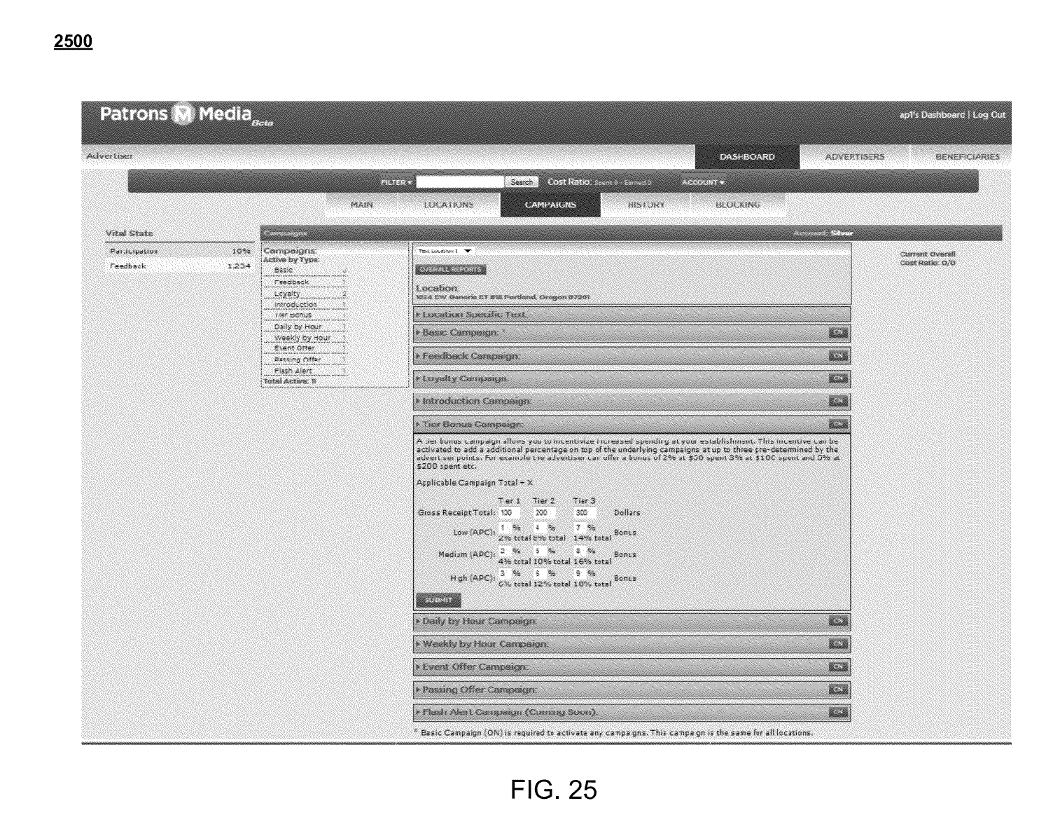

Referring also to FIG. 25, in some embodiments, a tier bonus campaign may be associated with the user account and may allow the user to incentivize increased spending at the merchant's business in a visit. Accordingly, this may add an additional percentage on top of the underlying campaign at up to three points, pre-determined by the advertiser. For example, a user may offer a bonus of 2% at $50 spent, 3% at $100 and 5% at $200, etc. The tier bonus campaign may be cumulative with another campaign.

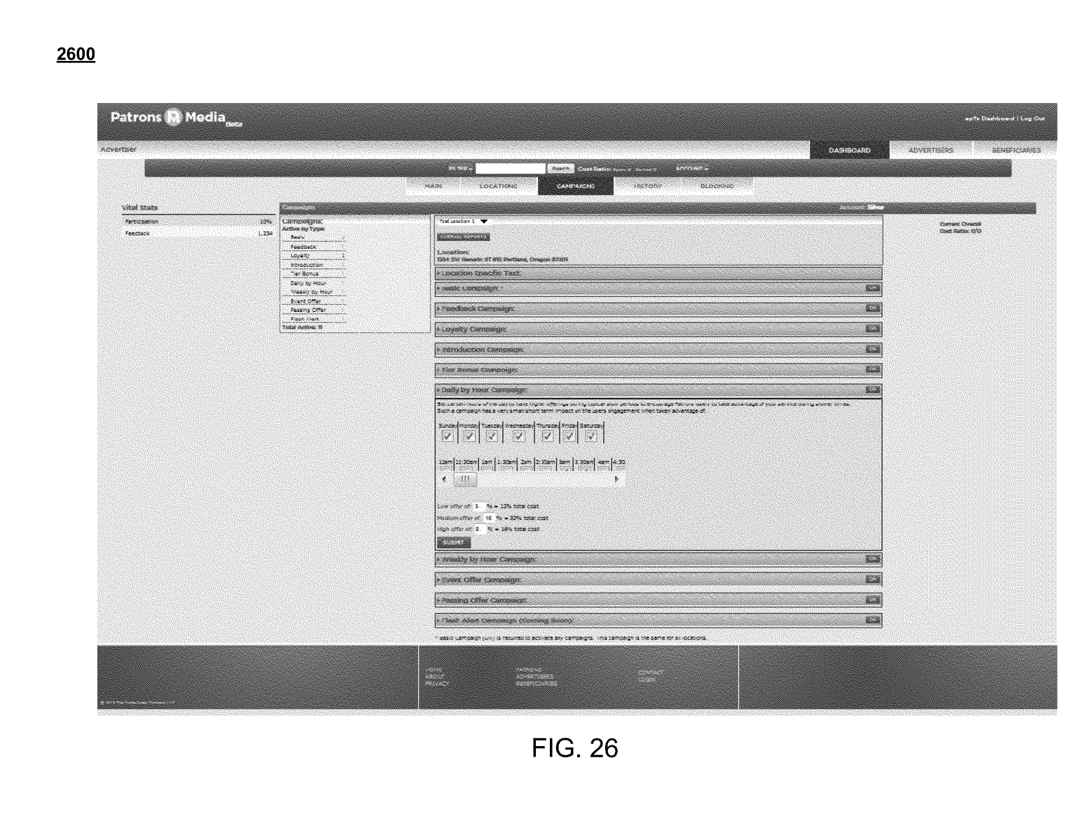

Referring also to FIG. 26, in some embodiments, a daily by hour campaign may be associated with the user account and may allow the user to set certain hours of the day to have higher offerings (e.g. during typical slow periods) to encourage customers to take advantage of the merchant's services when it's in the merchant's best interests.

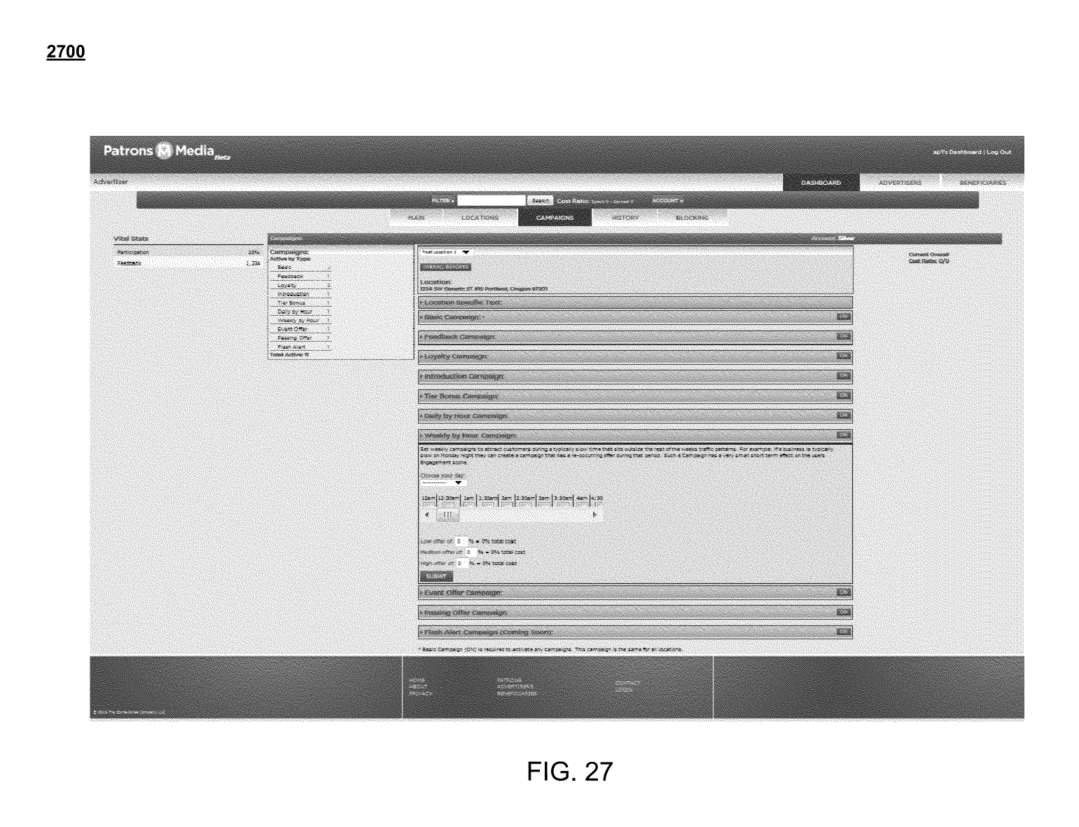

Referring also to FIG. 27, in some embodiments, a weekly campaign may be associated with the user account and may be designed to attract customers to the merchant's place of business, website, etc. on a recurring basis each week during its 30-day run (e.g., Mondays from 5-7 PM).

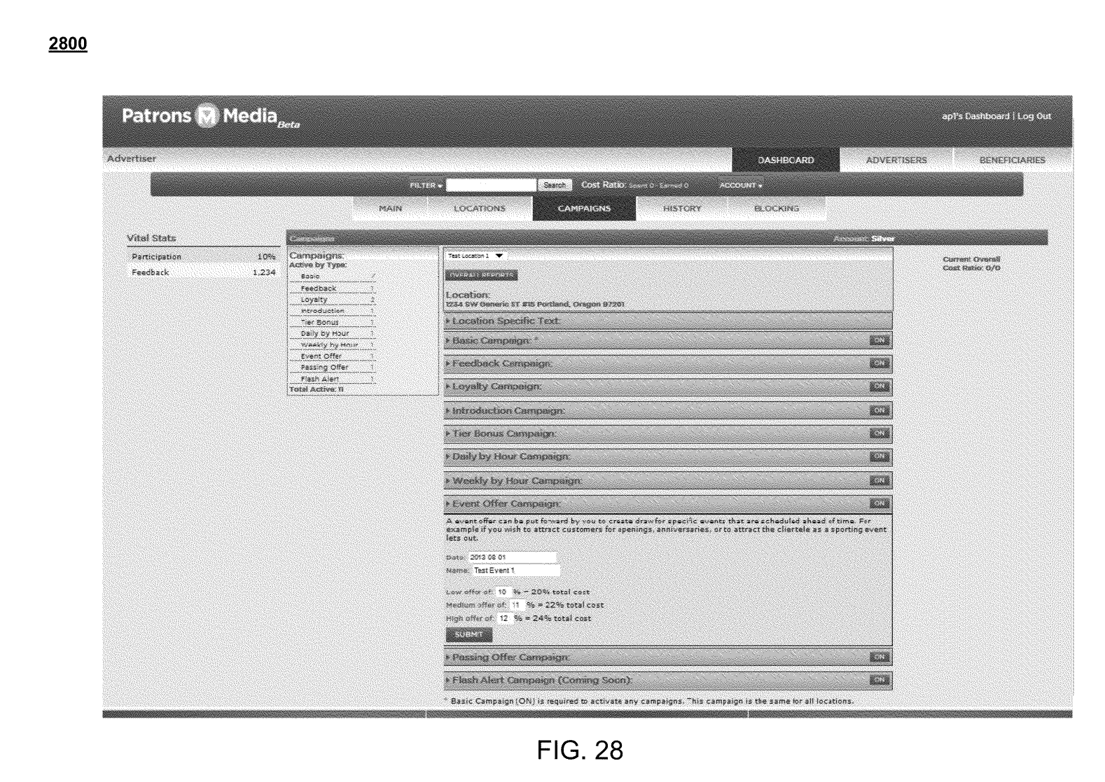

Referring also to FIG. 28, in some embodiments, an event offer may be associated with the user account and may be designed to attract customers to the merchant's place of business, website, etc. during a set of hours on a specific day, for events such as openings or celebrations.

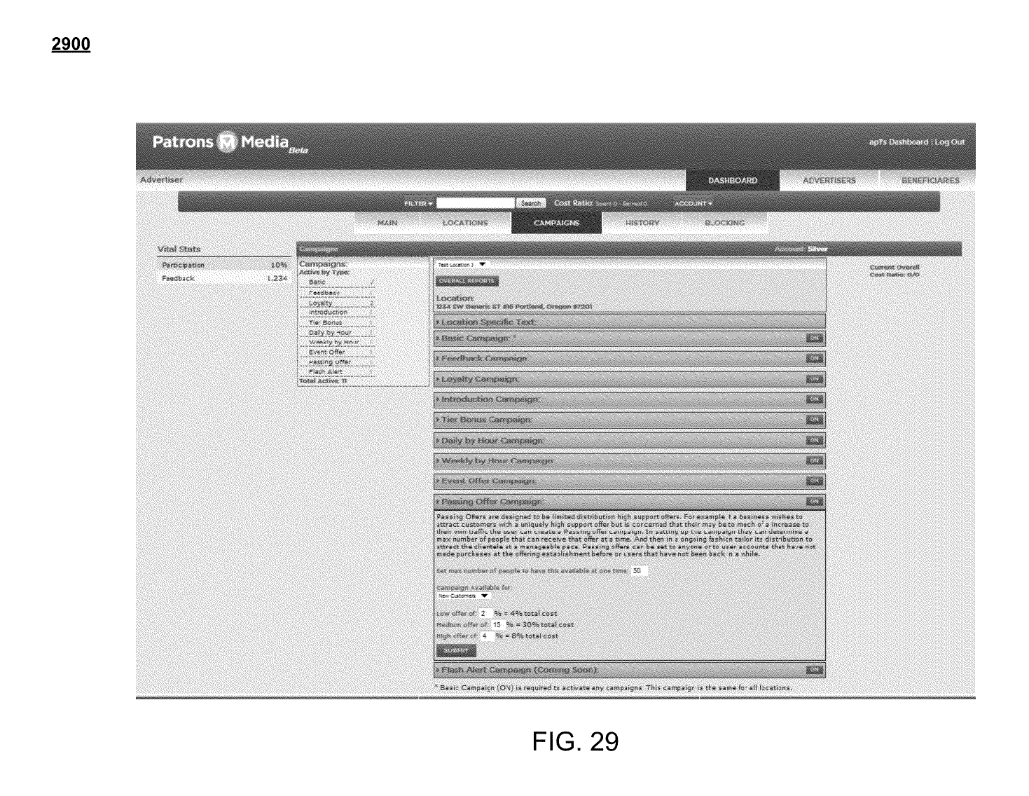

Referring also to FIG. 29, in some embodiments, a passing offer may be associated with the user account and may be designed as a limited distribution high support offer. For example, if a business wishes to attract customers with a uniquely high support offer but is concerned that there may be too much of an increase to their own traffic the user may create a passing offer campaign (e.g. setting a limit on the maximum number of people that may receive that offer at a time).

In some embodiments, an offer alert may be associated with the user account and may refer to an offer that may be designed to transmit quickly to attract customers to the merchant's place of business before the staff leaves for the day. This may be achieved using a variety of techniques, such as, by reaching out through the notification feeds specific to that purpose. In this way, marketing process 10 may allow for the generation of a real-time alert to users of the system. For example, using the mobile application to let users know of the merchant's special offer over the next few hours. This campaign may require the purchaser to have advanced campaign interaction through the mobile application in some situations.

In some embodiments, a beneficiary partner campaign may be associated with the user account and may allow the user to partner with a specific beneficiary in order to create a campaign that gives the beneficiary the opportunity to mobilize their supporting users to come to a particular merchant for a special event. This event, for the users who choose to participate, drives revenue directly to that beneficiary within those users' queues. This campaign may require mobile application participation in some cases.

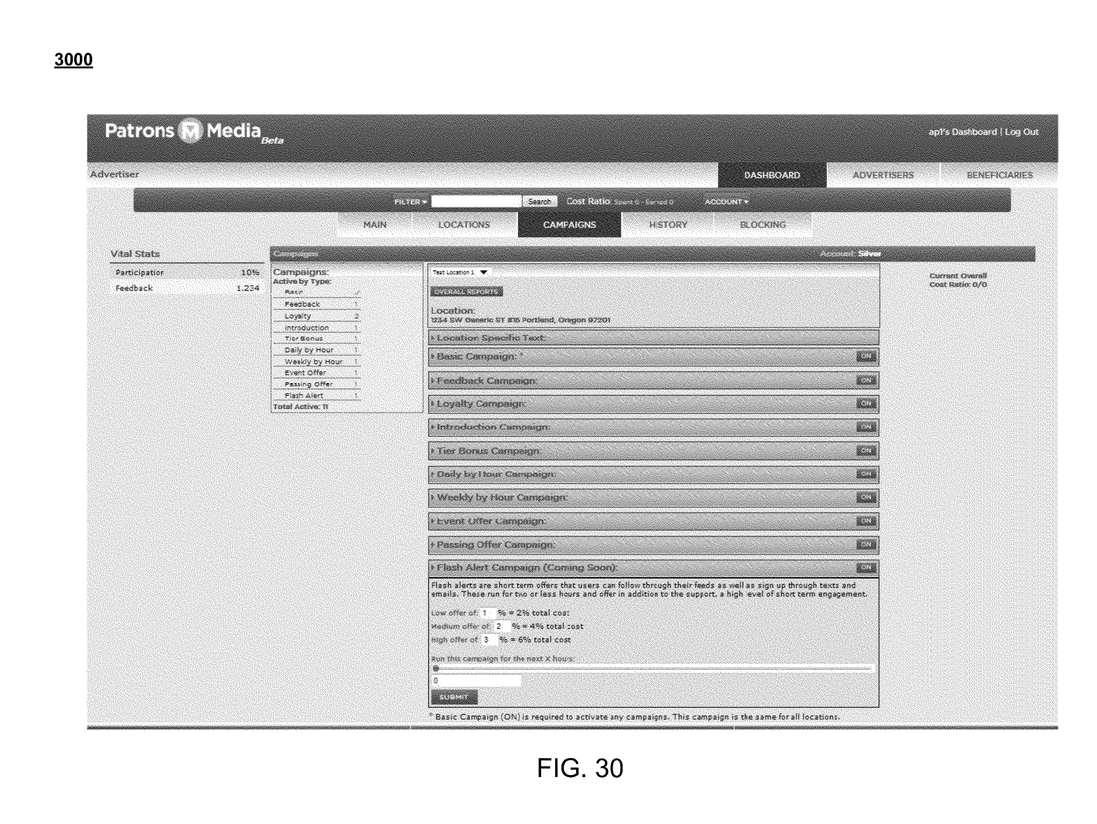

Referring also to FIG. 30, in some embodiments, a flash alert campaign may be associated with the user account and may involve transmitting a notification to mobile application users as well as to users who elect to receive text or email alerts.

In some embodiments, a recommendation campaign may be associated with the user account. In one example, an Advertising Partner may set an incentive campaign where a user can recommend an establishment or product to a friend through the platform. If the account who received a recommendation makes a purchase from that advertiser within an allotted amount of time, the recommendation campaign may award the recommender the incentive amount on their next purchase from that advertiser. This is to incentivize viral behavior towards the advertiser's brand within their purchasing community.

In some embodiments, a Partnered Beneficiary campaign may be associated with the user account. In one example, this may involve a joint organized campaign accomplished between a beneficiary and an advertiser. The beneficiary's supporters may activate a purchase ping indicating participation so the visit may temporarily override the normal operation of the queue element and activate an offer that may be specifically targeted to that beneficiary regardless of its current position in the queue.

In some embodiments, a Counter Offer Campaign may be associated with the user account. In one example, the system may allow consumers to send a message to an advertiser saying that they will come in to make a purchase within an allotted time if the advertiser agrees to a special offer rate specific to the corresponding event. In this way, the “Counter-offer campaign” may allow the consumer to put a directed revenue percentage forward to be accepted by potential advertisers.

In some embodiments, a Picture Post Campaign may be associated with the user account. In one example, this may include an offer to consumers for an increased directed revenue offer on the next purchase in exchange for an image of the consumer posted to their page, etc.

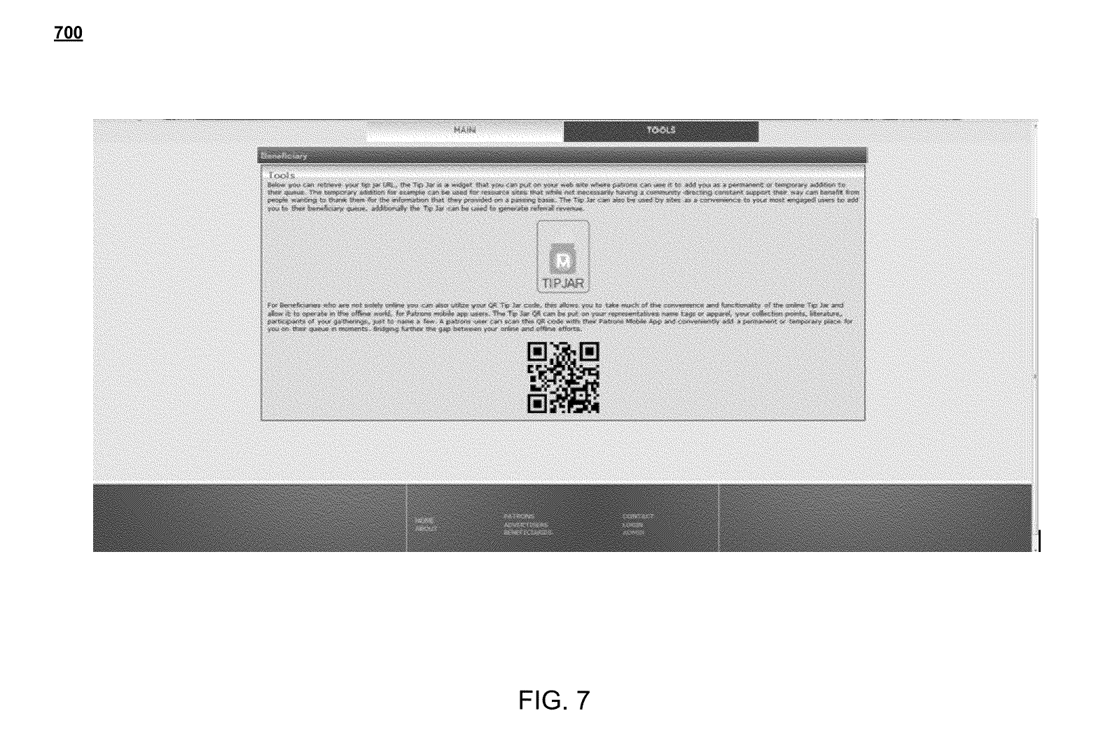

Referring now to FIGS. 7-9, an embodiment 700 depicting the concept of a tip jar that may be associated with marketing process 10 is provided. Accordingly, marketing process 10 may allow a user to retrieve a tip jar URL. The tip jar may be associated with any suitable application, such as a widget. In operation, a user may place the tip jar widget on their website where patrons may use it to add that website to their queue. For example, the tip jar may allow users to direct some amount of support to a website on a temporary basis in recognition of the site's assistance. This widget is something that a user would be able to click on to “tip” a website in exchange for its services. For example, the tip action may move a 10 cent placeholder to the top of the queue that, once the revenue generated, would be removed permanently, unlike the regular queue elements that can return at the beginning of a new cycle. This tool allows users to lightly support a website that has given them a passing, not sustained value. The queue may also have indicators of how far down the list the user will likely make it in the allotted time (such as per month) based on previous results.

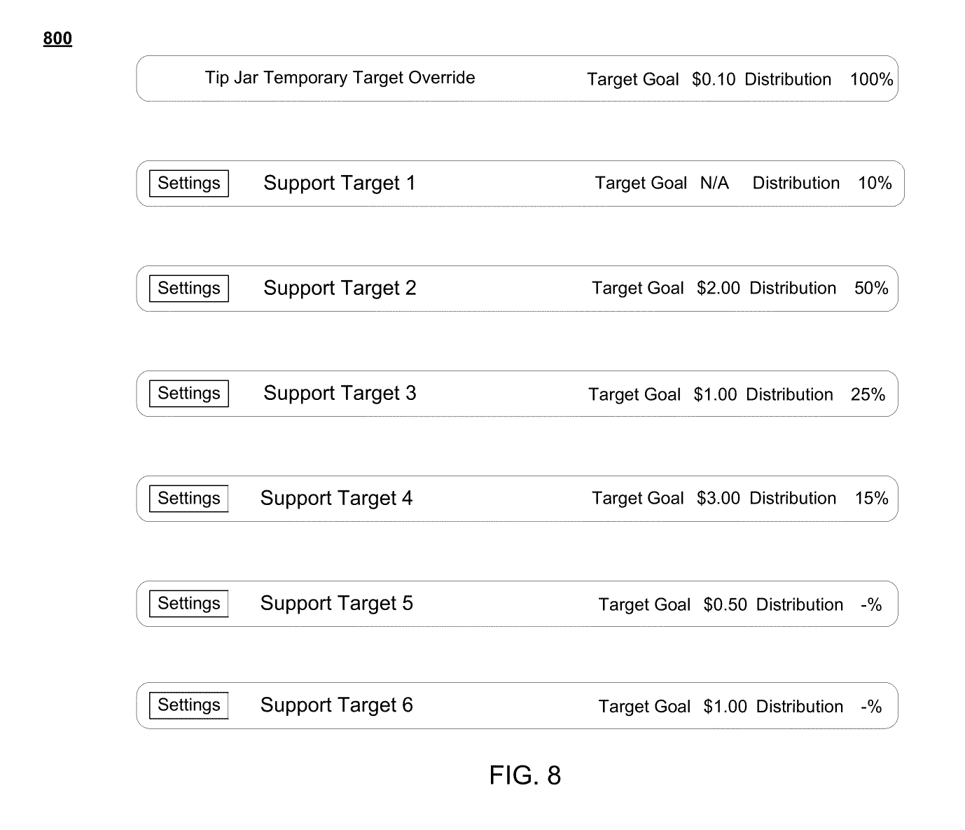

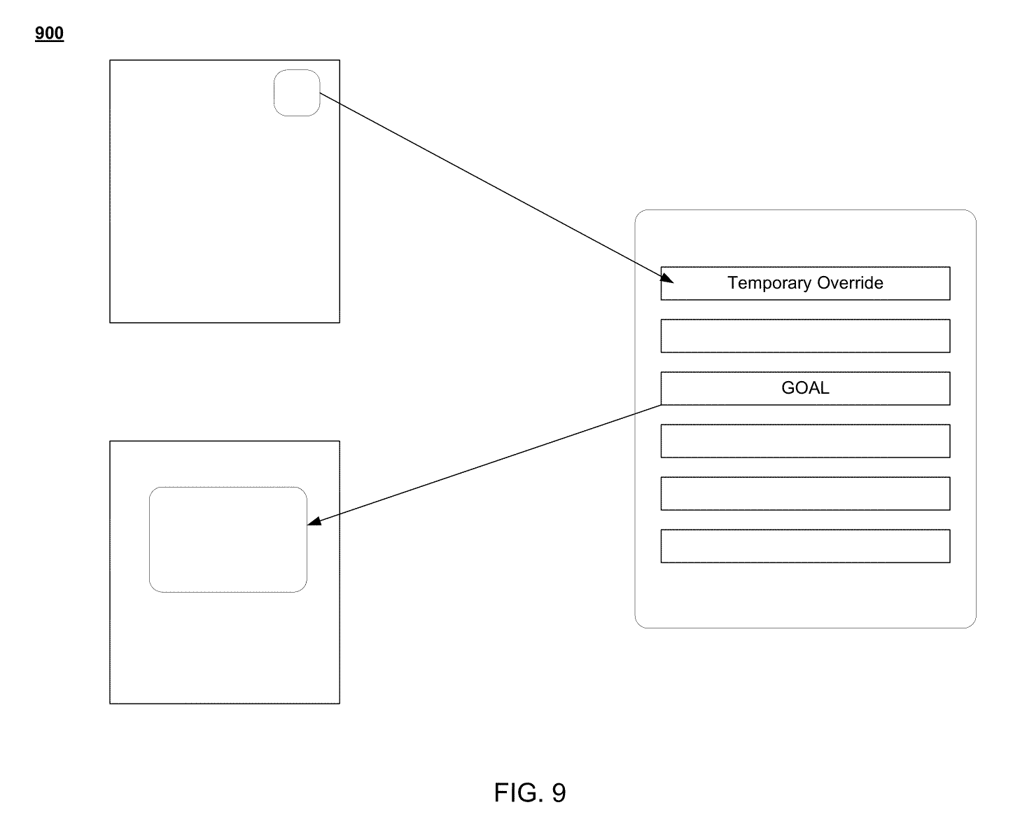

As shown in FIGS. 8-9, marketing process 10 may include temporary override functionality, which may be associated with the tip jar. In this way, a user account may include a target goal as well as a percentage of the total distribution towards that particular target. FIG. 9 demonstrates how a widget, such as the tip jar, on a separate website, can place a temporary override upon the beneficiary queue of the user. The reaching of a target goal can then trigger a notification to an outside website that instructs that website to “unlock” features for the user's benefit.

In some embodiments, marketing process 10 may include quick response (“QR”) code functionality that may allow for both beneficiaries and merchants to bridge the gap from the digital to the material worlds, through contextually appropriate use of QR-code integration that may enhance a user's experience. In this way, marketing process 10 may allow a user to quickly pull campaign offers, add beneficiaries, obtain information about surroundings, increase the user's engagement valuation metric, etc.

In some embodiments, marketing process 10 include one or more QR virtual item games, which may be accessible through the system and may be tailored to make client advertising more engaging through interaction. For example, a QR virtual item game would be monetized by advertisers though the QR system. As such, if a client wishes to have high engagement on their posters and stands, users would be able to scan the advertisement's QR code to have the opportunity to get a variable digital game item. In some cases, for example, upon the scan of a client's QR code not only would the user's engagement score increase but the server would decide what the user receives (e.g., it would have a small chance of getting a purple item, a hundred percent chance of getting the blue client-sponsored item or, if they already have the client-sponsored item, they would get to choose from short stacks of consumables). To prevent someone from just keeping a QR code in their pocket, a lockout may be used on particular campaigns. Other Potential QR strategies may include, but are not limited to, Blue Consumable QR code cards that a client could deliver with their product. These codes would have shorter reset times but the branded card could be carried by the user and shared with friends they are playing against until it expires in 30 days from first use. In some cases, the items retrieved may be branded in the inventory or actual products. Any suitable game may be employed without departing from the scope of the present disclosure. The system associated with marketing process 10 may provide the platform through which these games are distributed. This would be one of many ways that the users' interactions with advertisers would become not only more collaborative but fun in exchange for their time and attention.

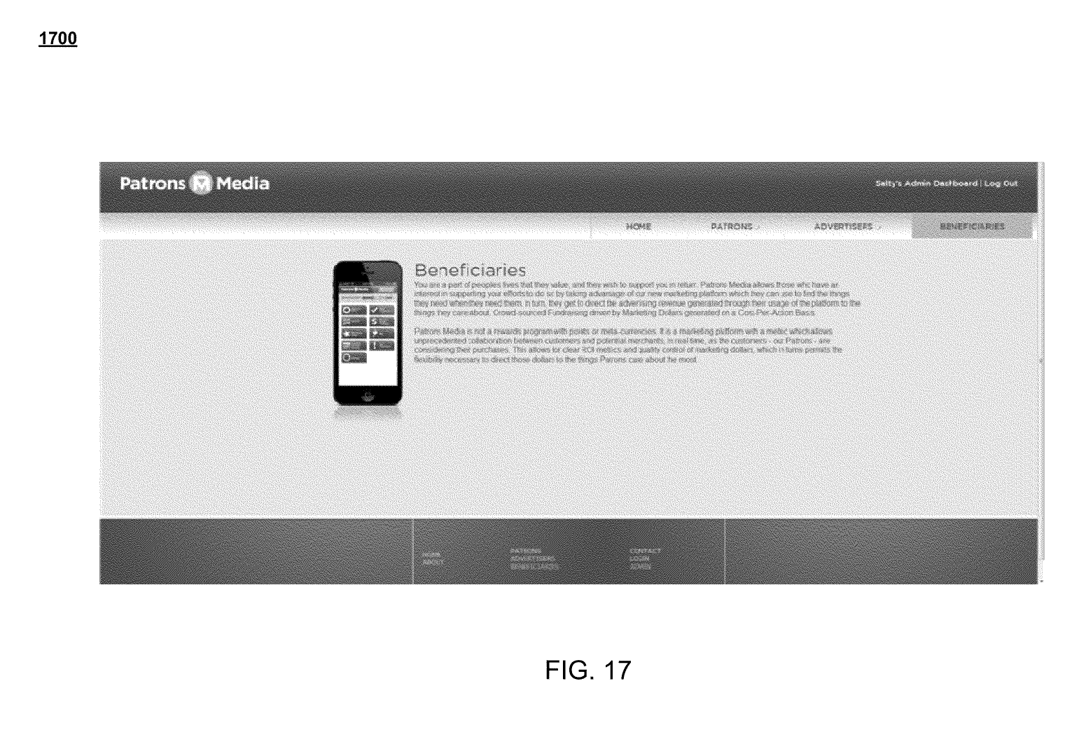

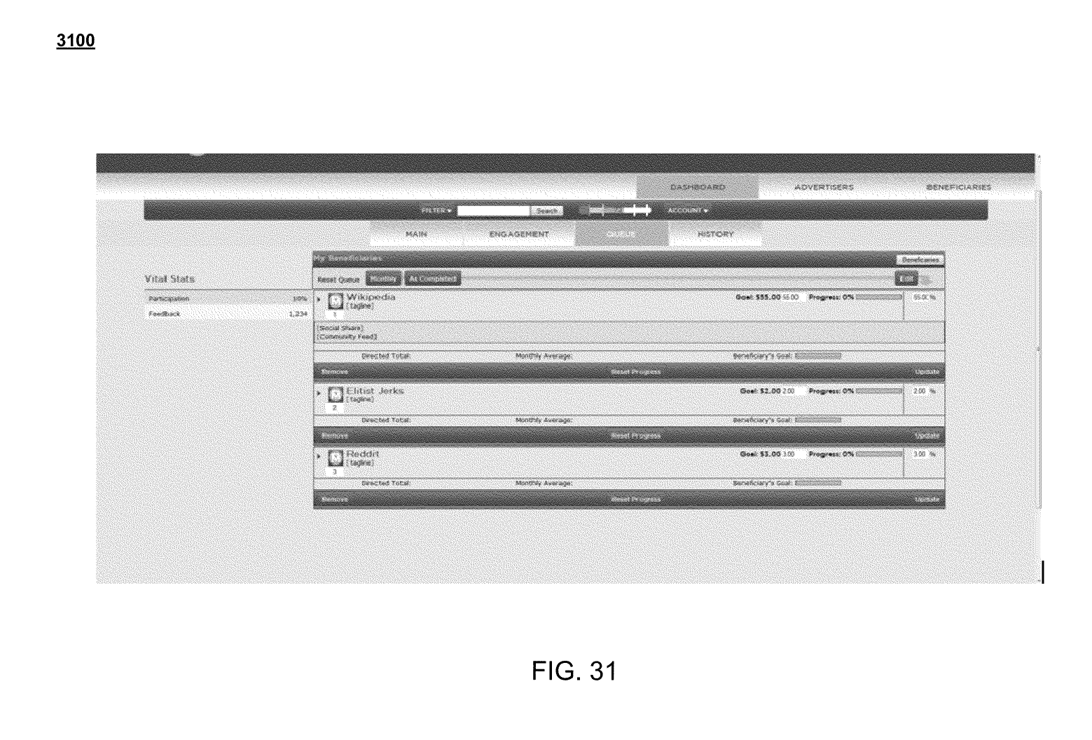

In some embodiments, and referring also to FIGS. 17 and 31, marketing process 10 may be configured to store a list of user-selected beneficiaries corresponding to the user account. Accordingly, the beneficiary designated by the user, through the user account, may be a for-profit entity and/or a non-profit entity and may utilize a mobile application such as that shown in FIG. 1. The embodiment depicted in FIG. 31 shows an example of a queue.

In some embodiments, the tip jar application and/or QR code may allow the user to conveniently add permanent or temporary placements to their beneficiary queue as is shown in further detail in FIGS. 8-9. In some embodiments, the widget may serve as a mechanism to generate referral revenue from new accounts that may be created by that beneficiary's supporters. In some cases, the QR code may be worn by the beneficiary's supporters on their apparel or name tags, may be posted at collection points and events, and may placed on marketing materials and signage, etc.

In some embodiments, marketing process 10 may include a community page, which may be used to put a particular value proposition before the Patrons community and to facilitate communication between the user and the user's supporters, for example, to form a greater sense of community and to achieve shared goals.

In some embodiments, marketing process 10 may include one or more messaging systems. For example, Patrons supporters may be able to sign up to receive notifications from their beneficiaries through settings in their support management pages.

In some embodiments, marketing process 10 act as an adaptive, individual and community-based, crowd-sourced, online fundraising tool for both for-profit and non-profit purposes, through a marketplace of potential transactions where the sellers bid a degree of support to variable third parties designated by the buyer in order to attract the buyer's activity for purchases both online and off. Tracking may be accomplished through creating associations from the buyer's online social media account to internet-accessible banking resources, for example, credit card transaction information, checking, savings or credit accounts, Google wallet, PayPal, other forms of digital wallets and currency, as well as self checkout software, then cross-referencing this information stream with a user's variable support preferences as outlined in the user's profile tools, for the delivery of the advertiser's marketing dollars to that user's beneficiaries.

In some embodiments, marketing process 10 may be further enhanced through business-to-business development allowing access to the point-of-sales inventory system, enabling manufacturers to incentivize their specific items in addition to the gross-receipt-level advertising by the point of sale if they are separate parties.

In some embodiments, in addition to the tracking and associating of users' purchasing histories and their support beneficiaries, marketing process 10 may utilize a website that may allow users to search for merchants and products offering bids according to what the users are in the market to buy. Marketing process 10 may also cross-reference geographical and support-bid data, so that the information may be included in their decision-making process. Also, a user may search through the questionnaire marketplace where interested parties may offer support to the users' beneficiaries in exchange for users' personal (demographic) information. Users may also be able to set their privacy settings to automatically share specific pieces of information if a bid comes in high enough to meet the users' requirements.

In some embodiments, users may be able to set a cardinality of how their generated marketing revenue is distributed to their for-profit and non-profit beneficiaries. For example, this may be done by percentage among one variable target or multiple variable targets, a queue that cycles as goals are reached, back to themselves as a rebate, or combinations thereof. These tools may allow users to create an automated system that can also be later changed by users as they wish. Users would also be able to see how much support they have raised and for what, view pending support values, transfer marketing, etc.

Referring again to FIG. 31, in some embodiments, marketing process 10 may be configured to display, at a graphical user interface associated with the user account, the list of user-selected beneficiaries in a queue. The queue may be updated based upon, at least in part, at least one of an online widget and a QR code. Revenue may be transferred based upon a position of the at least one beneficiary in a queue. In some embodiments, the queue may auto-reset each month or a recurring beginning-to-end cycle, or using any other suitable approach. Also, each beneficiary may have its own unique goal.

In some embodiments, marketing process 10 may allow a user to transfer revenue from the user account to at least one beneficiary based upon, at least in part, a pre-defined user-selected metric. In this way, marketing process 10 may allow a user the ability to set goals and the cycle pattern for directed revenue. Marketing process 10 may also allow the user to set a target goal for a particular timeframe, where the target goal corresponds to an amount of revenue to be directed to each of the at least one beneficiary. Marketing process 10 may also allow for the display, at a graphical user interface, of a progress indicator configured to display a level of progress towards the target goal. In some embodiments, the progress indicator may indicate progress through queue, tips on how to reach goals, distribution wizard, etc.

In addition to the tracking and associating of users' purchasing histories and their support beneficiaries, the website associated with marketing process 10 may allow users to search for merchants, campaigns, and products offering bids according to what the users are in the market to buy and cross-reference geographical and support-bid data, so that the information can be included in their decision-making process. Marketing process 10 also allow users to socially interact with their fellow users, create auto-feed associations to outside social media sites and set the frequency and type of updates. Users may also search through the questionnaire marketplace where interested parties may offer support to the users' beneficiaries in exchange for users' more specific personal (demographic) information that is not generally collected. Marketing process 10 may also allow users to set their privacy settings to automatically share specific pieces of information for better targeting of advertising leading up to checkout. The target list shows what they are engaged to while a combination of their queue/threshold information. Marketing process 10 may also allow for the creation of a preferred merchant list.

In some embodiments, users may associate their accounts to their computer technologies such as, computer applications, tablets, smart phones, and augmented reality apparatus. Marketing process 10 may also provide purchase ping functionality. Accordingly, a user may activate a notification on a mobile device or internet site in concert with a traceable purchase event in order to increase the reward from that purchase event. For example, a purchase ping may be accomplished through a mobile device that includes geographic verification through GPS or Merchant QR Placement. These pertinent values may comprise the account user's engagement score. The actions and interactions selected may be specifically chosen to reflect those that have relevance to marketing and its respective value in that context to create a marketing productivity metric. In this way, a user may navigate to a seller's offer and click a button within an allotted time before or after a measurable purchase event for an added amount of support from the transaction. In some embodiments, purchase ping validation may include that the consumer may be told to manually enter a receipt total, etc.

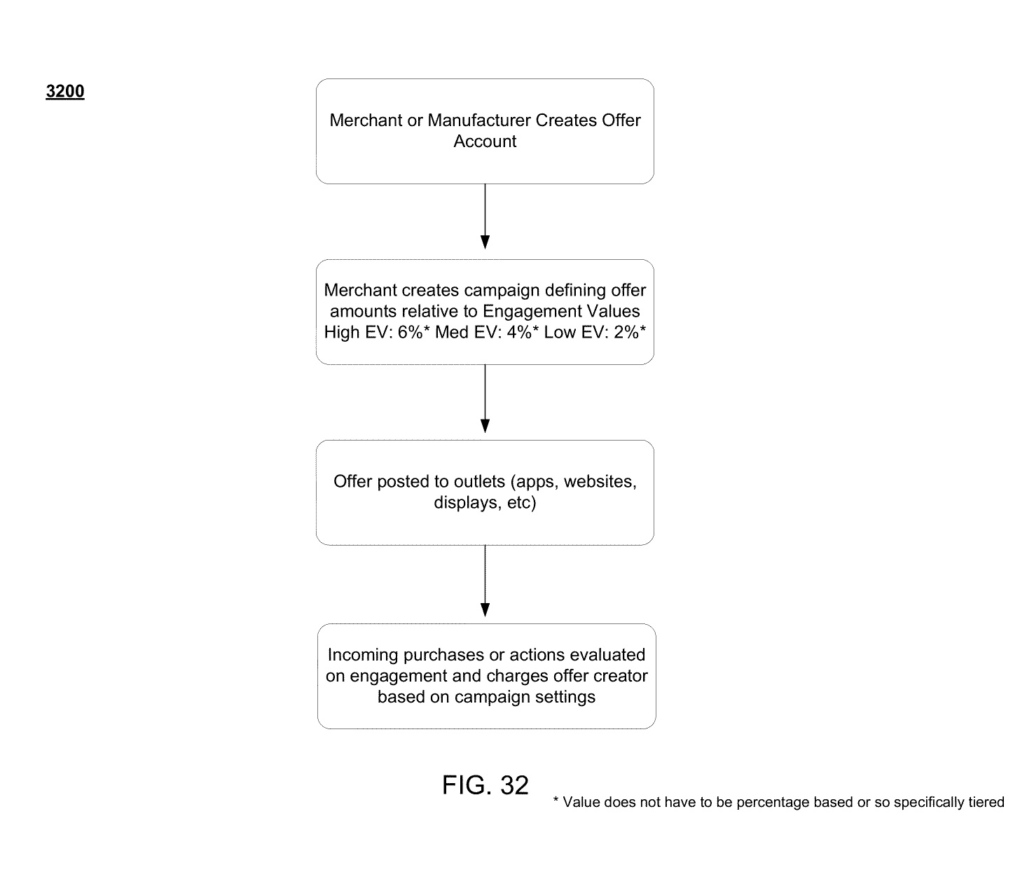

In some embodiments, and referring also to FIG. 32, marketing process 10 may assign engagement scores to particular accounts. These may include, but are not limited to, Dormant 0-24, Low 25-49, Medium 49-125, High 125+, etc. Some examples of campaigns and engagement values are provided below for purposes of example only:
Basic Campaign:
EV 0
Fill out Feedback opportunity:
EV 25/7d no cap
Introduction Campaign:
EV 20/14d no cap
Tier Bonus Campaign:
EV 0
Daily By Hour Campaign (with geo Ping):
EV 15/7d Cap 75
Weekly Campaign (with geo ping):
EV 15/7d Cap 75
Passing Offer (With Campaign Hold):
EV 15-20/7-14d Cap 75 (Bottom for regular passing offer, top if “intro/passing” offer.)
Offer Alert (with geo Ping):
EV 20/7d no cap
Non-Campaign based engagement opportunities
Daily Twitter Push:
EV 5/1d
Weekly Facebook Push:
EV 5/7d
Mobile App active:
EV 5 while active cap 5
Notification Settings:
Set to receive 2 hours a day max applicable filter 5% or 10%
EV 2-5 for days active
Allow 2 alerts/hour additional EV 2-5
Allow 3 alerts/hour additional
EV 5-10
Allow 4 alerts/hour additional
EV 10-20
Set to Receive Hourly alert notification to mobile set to at least 4 hours a day with a maximum applicable filter of 5%-10%.
EV 5-10 for days active
Allow 2 alerts/hour gives additional
EV 5-10 on days active
Allow 3 alerts/hour gives additional
EV 10-20 on days active
Allow 4 alerts/hour gives additional
EV 15-30
Max total EV 40

In some embodiments, marketing process 10 may be used to create a marketing productivity metric (e.g. engagement valuation) upon which advertisers may create scaling offers to consumers based off their historical and ongoing interactions with the marketing platform. Accordingly, marketing process 10 may include generating, using one or more computing devices, a user account associated with a particular user and assigning an initial engagement value to the user account based upon, at least in part, the user's actions with one or more merchants. Marketing process 10 may also include identifying at least one trackable purchase event and an advertising campaign parameter and adjusting the engagement value of the user account, based upon, at least in part, the at least one trackable purchase event. Marketing process 10 may further include receiving an offer from an advertiser based upon, at least in part, the adjusted engagement value. In some embodiments, receiving an offer from an advertiser may be based upon, at least in part, an advertising campaign parameter.

In some embodiments, the adjusted engagement value may be based upon, at least in part, a measurement of the user's marketing interactions associated with the user account. For example, the engagement value may be affected by a consumer's demonstration of desirable marketing behaviors on an ongoing basis. Accordingly, marketing process 10 may dynamically update the engagement value of the user account based upon, at least in part, the user's marketing interactions. As such, a user's engagement score may change over time (e.g., desirable marketing behaviors increase score for a limited amount of time, requiring continuing consumer activity over time). The engagement value may be updated based upon at least one of global positioning data and QR code data. In some embodiments, adjusting an engagement value may be based upon at least one of confirming participation in a campaign at the user account, receiving feedback forms or surveys associated with the user account, purchase results shared with friends via the user account, and communication channels that the user account has open to active marketing messages.

Marketing process 10 may also be configured to identify a minimum level of engagement associated with the user account. For example, a quality-control mechanism may turn off any cost to advertisers when a consumer's engagement score drops below minimum level (e.g. a dormant account). In some embodiments, marketing process 10 may be configured to disable at least one aspect of the user account upon determining that the minimum level of engagement has not occurred.

In operation, a user such as those shown in FIG. 1, may utilize marketing process 10 by signing up and creating a queue of things that are important to them, and associate the user's chosen transactional accounts. The user may search the system, for example using the website, to find the merchants/advertisers that are needed. Using the Platform drives the user's engagement score, which in turn allows the user to generate advertising revenue that may be directed to wherever the user desires. Beneficiaries may be added to the system at no cost to the user.

In some embodiments, the engagement metric of marketing process 10 may be driven solely on behaviors that are relevant with regard to advertising and marketing interactions. For example, managing a Directed Beneficiary Queue may not increase the engagement metric; however, confirming participation in a campaign, filling out feedback forms or surveys, sharing purchase results with friends, having communication channels open to active marketing messages, etc., are behaviors that contribute to this social commerce and thus increase the Patrons Engagement Score. This allows marketing process 10 to deliver relevant and timely advertising messaging to consumers making purchase decisions while at the same time being respectful of consumer privacy. Once specific transactions occur around these behaviors and are then combined with the merchant's offerings, an EVCPA event is triggered.

Marketing process 10 may provide consumers with a convenient mobile tool to help the consumer find the goods and services that they are looking for. At the same time, the consumer may be able to direct the shown advertising revenue generated by their purchases to the participating beneficiaries that consumers care about most, for example, the user's favorite TV shows, websites, non-profits, and schools, etc.

In some embodiments, the amount of revenue generated may be directly linked to that person's usage of the system and/or website. Through the engagement valuation system, the user may communicate his/her active and ongoing participation in the platform. That participation may be reflected in the user's engagement score; the more the individual uses the system, the higher their engagement and the higher that user's offers may be.

In some embodiments, users may also associate their accounts to their computer technologies such as, computer applications, tablets, smart phones, and augmented reality apparatus through an application associated with marketing process 10, allowing for the optimization of their purchases in accordance to their user priorities and the utilization of itemized shopping lists at inventory-integrated merchants. Further, users may scan codes on advertising material (e.g., Bar codes, QR codes, RFID codes, etc.) and/or manually input the code to increase their engagement score through their electronic devices. These codes could be not only tied to increasing engagement but also to in-game items for social games as well.

In some embodiments, the engagement score may determine the range and magnitude of offers to users in exchange for their purchasing activity. If activity within the social media aspects of the site drops below a prescribed level, the account may be flagged as dormant, meaning that the account no longer incurs cost to the advertiser, maintaining a well-defined quality to the advertiser at all times from an ROI standpoint and ultimately allowing the social media not only to enhance the user experience, but also to operate as a quality-control mechanism for the advertiser.

In some embodiments, purchasing partners may be given a website and mobile tools to interact with the campaigns and events that are currently running on a website associated with marketing process 10. Accordingly, marketing process 10 may allow purchasing partners to make traceable whichever interactions they desire. Marketing process 10 may also allow a user to assign a multi-variable queue system to their list of directed beneficiaries (DBs), through which they express where they want the generated revenue to be directed. In some embodiments, the management of the queue may not actually have an engagement value assigned to it; the engagement valuation may only be triggered by behaviors that are desirable to advertisers. For example, managing the queue does not increase engagement score; however, sharing a purchase on social media sites, confirming participation in specific events, viewing advertising, interacting with advertising, communicating with advertisers, making oneself more open to receiving highly “pushed” advertising messaging, etc. all would increase a purchasing partner engagement score.

In some embodiments, campaigns associated with marketing process 10 may be based on Cost-Per-Action principles, meaning that once a campaign has started, cost to the advertiser may not be triggered until an applicable sale has taken place. Sales to non-Patrons customers or Patrons with engagement scores that are too low may incur no marketing costs.

In some embodiments, marketing process 10 may be configured to deliver relevant messaging to consumers through its mobile tools and website. The system may be built around benefitting all parties of commerce. This provides the advertiser unprecedented efficacy with solid ROI metrics. In some embodiments, the base cost is 1.5% on sales to Patrons purchasers; anything beyond that is up to the advertiser's marketing strategy. If the purchaser is not registered with Patrons, or is registered but has let his or her engagement score go low enough that the account has gone dormant, advertiser costs associated to that purchase are zero.

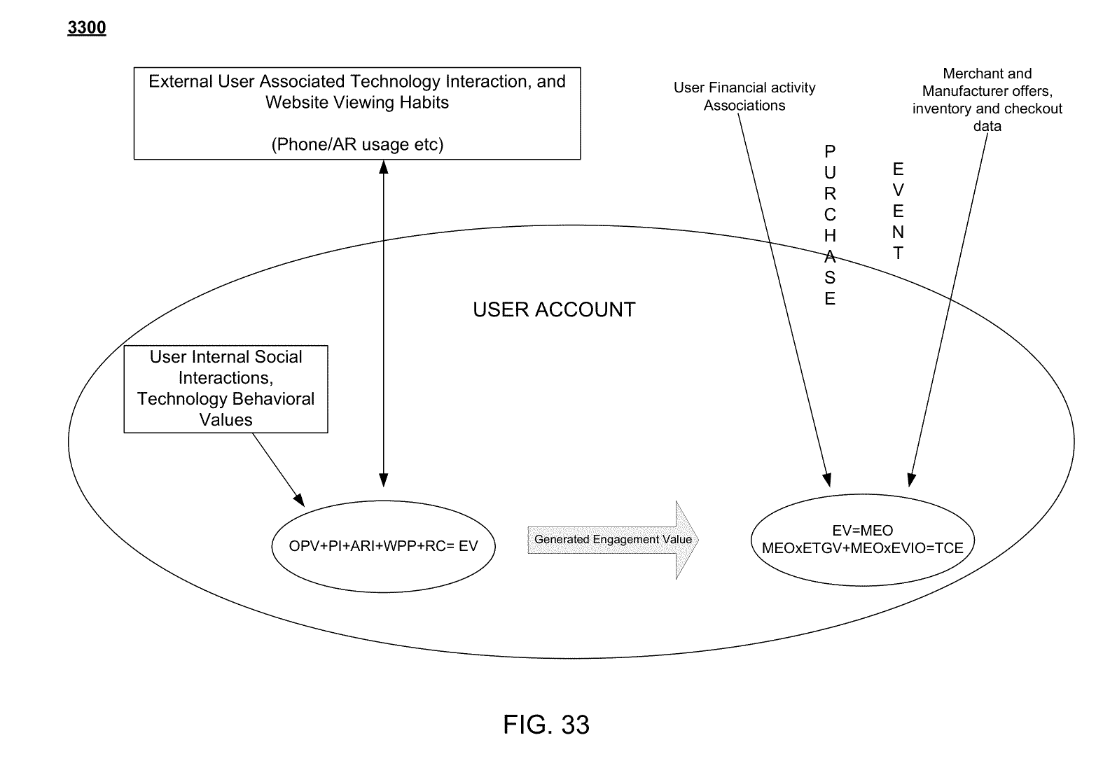

Referring also to FIG. 33, an embodiment depicting an example of calculating engagement valuation is provided. In this particular example, the following variables may be used:

V#=Action engagement Value

ED1-30=Duration of time in days that a action is still considered relevant to engagement value

DL=Duration Locked—the effect of having a activated feature providing ongoing marketing value while on.

CV#=Capped Value—the max value that can be derived from a single type of action

TD=Time Duration—How long a user does a specific action.

ET=Event time—Time of event

ETGV=Event Transaction Gross Value—determined by financial Data and/or checkout data

ETIV=Event Transaction Item Value—determined by inventory and or checkout data

EVIO=Event Value by Item Offer.

MEO=Merchant Engagement Offer—The result of the total current engagement value determines which merchant offer applies to the purchase event (Low, Medium or High) offer.

TCE=Total Cost of Event to advertising or marketing party.

*BOE and OA both have a small engagement value by being active as a feature on the user's devices in addition to the purchase engagement value.

Some examples of user behavioral value calculations are provided below. The value of OPV may be calculated according the frequency of users' viewing offers and time spent (e.g., determined by numbers of pages viewed and duration of views) doing so. The minimum value, V1, may be defined as viewing one page every 29 days. An example OPV calculation: (V1)×(5 MMP)=OPV value (5). This value expires after 29 days (ED29). The next 10 MMP may be evaluated on an ED14 basis with a V-value of 2: (V2)×(1-10MMP)=OPV value of 2-20. This value expires after 14 days (ED14). The next ten pages are determined at a V-value of 5: (V5)×(1-10 MMP)=OPV value of 5-50, expiring after one day (ED1). The maximum OPV value is therefore (5)+(20)+(50), or (75). If the user views at least 3 pages per day, the ED does not diminish; in other words, users who view 3 pages every day would maintain the same ED levels. On days where users view 5 pages, the ED29 and ED14 values fully refresh.

In some embodiments, the Phone Integration (PI) Value may be based on the number of features (including, but not limited to, lock-out screen with offers, home screen offers widget, home screen offers widget with geolocation, integrated shopping list, merchant event notification, etc.) activated or used and their value to advertisers. Some of these features may have locked values while active and thus may not be subject to value expiration while active, such as having event notifications activated, while other actions such as interactions with digital, such as QR, Bar codes, and RFID, or the manual entry of codes from marketing materials, would have a high through passing value.

In some embodiments, and similar to the PI value discussed above, the Augmented Reality Integration (ARI) value may be based on the number of features activated and their value, some values not subject to value expiration. For example, a user may be able to bring up a merchant offer overlay where the system references their GPS location to pull the merchants in the surrounding area and create an overlay of the offers according to the user's Engagement Value (EV). The ARI may be calculated based on the amount of time that the overlay is active as long as the user has moved in the last 10 minutes to prevent a user leaving their device with the feature active to artificially bolster their score. ARI metrics are V1 per minute up to a score of 100. Specifically, V1xTD ED7 CV100.

In some embodiments, marketing process 10 may incorporate user social interactions. For example, sample Facebook variables may be incorporated where the post features may be set to prioritize (or be limited to) purchases that happen through merchants on the user's “Preferred Merchant List”.

In some embodiments, the Wall Purchase Post (WPP) may consist of detailing what you raised (e.g. money), where you raised it (e.g. merchant), and where it went (e.g. beneficiaries). An example value of a WPP: (V50)×(WPP)=WPP value of 50, with an ED30 (expires after 30 days). There may be a Capped Value (CV) for WPP of 100 per month; the WPP button on the Patrons Media website would become inactive after 2 uses, and become available again after 30 days. In some embodiments, marketing process 10 may also include Support Post and Rally Call functionality where SP=Support Post (What you raised and toward what V30 ED30 CV60) and RC=Rally Call (post to raise awareness on need to raise for target. V10 ED20 CV30) Friends>10.

In some embodiments, marketing process 10 may work in conjunction with Twitter, some examples provided below. For example, DRT=Daily Recap Tweet V10 ED1 for total support directed, refreshed if left on, accumulates to CV40 plus max “total support directed” Value of WRT and MRT when left on for 7 and 30 days respectively, totaling a CV60. V10 ED7 CV70 for support plus merchants' names Value of WRT and MRT when left of for 7 and 30 days respectively, totaling a CV100. Additionally and/or alternatively, WRT=Weekly Recap Tweet-WRT V10 ED7 CV10 for total support directed plus max value of MRT “support directed” when left on for 30 days totaling CV15. WRT V20 ED7 CV 20 for support plus merchant names. Plus max value of MRT support plus merchant names if left on for 30 days. An MRT=Monthly Recap Tweet-MRT V5 ED30 CV5 total support directed. MRT V10 ED30 CV10 followers>5.

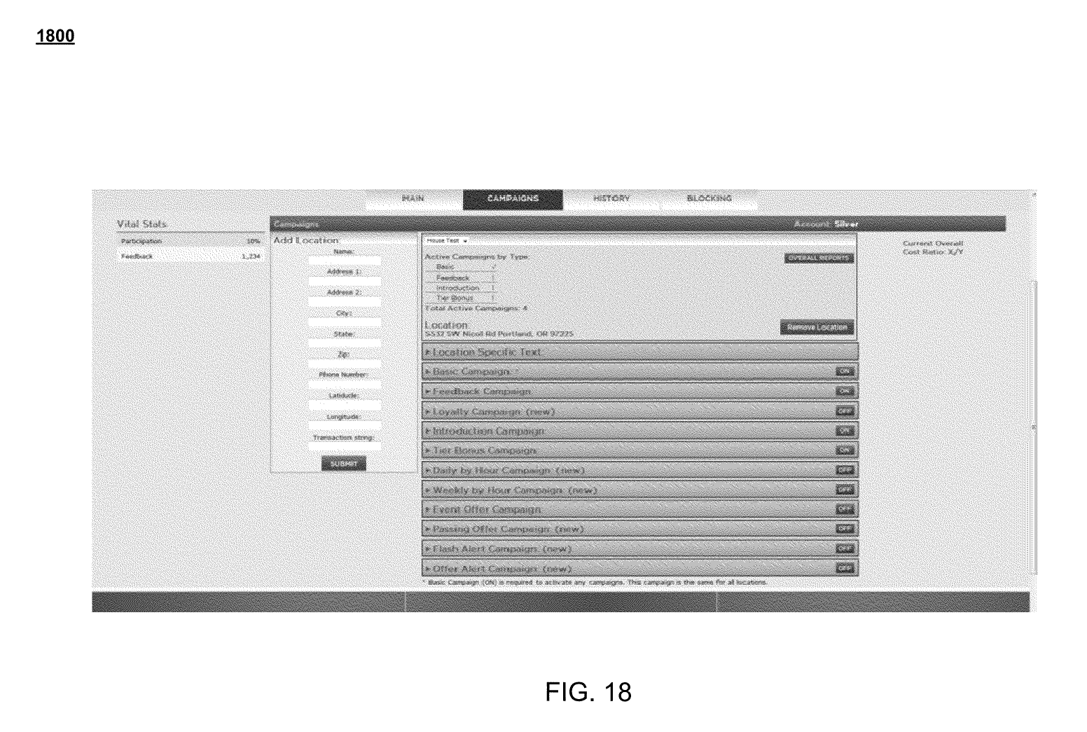

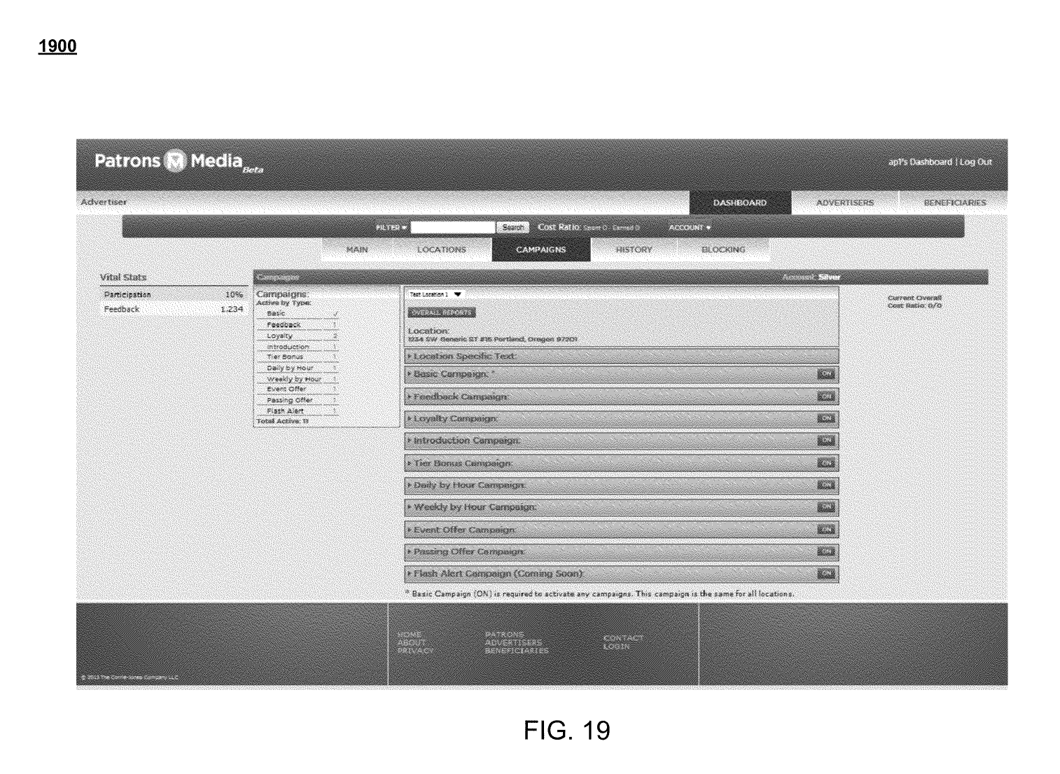

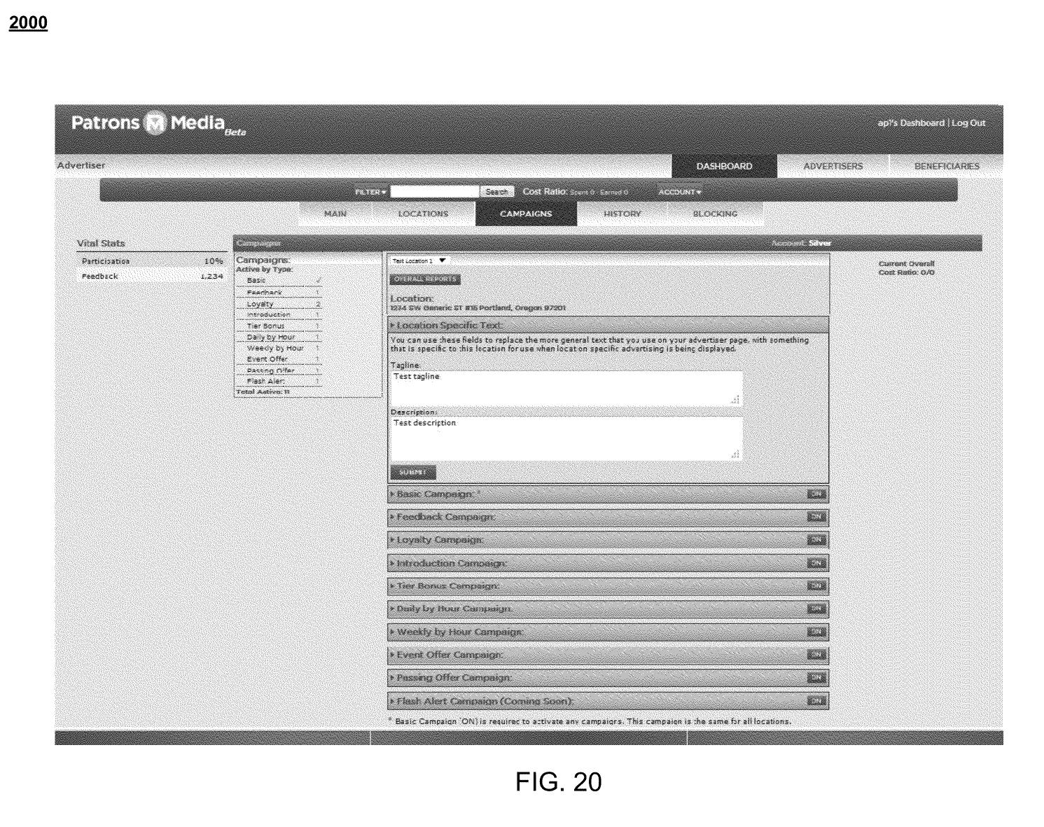

Referring again to FIGS. 18-30, examples showing the calculation of various campaign values are provided below. In some embodiments, for Engagement Values to apply the user may “confirm” the engagement events through a computing device within 24 hours of the purchase event being logged. Otherwise only the support element applies, except for a Basic Campaign that may be based on the feedback system alone, while Engagement events can have a confirmation and feedback element.

The basic campaign is the foundation of the EV-CPA offerings. It activates the underlying advanced campaign and event features; it also creates a feedback opportunity. These offers can be as low as 2% but can also vary based on engagement level. A user taking advantage of a Basic campaign gets to direct revenue generated but the activity does not effect their engagement level unless the user utilizes the feedback opportunity. Advertisers can further incentivize feedback if they wish (e.g. CF=V10 ED14 per event CV200).

A Tier Bonus Campaign may allow the advertiser to incentivize increased spending at their establishment. This incentive may be activated to add an additional percentage on top of the underlying campaign at up to three points at minimum intervals. For example, the advertiser may offer a bonus of 1% at $50 spent, 2% at $100 spent and 3% at $200 spent, etc. A very small amount of short-term engagement may be awarded to the user to supplement the offering (e.g., TBC=V10 ED14 per tier in event CV300).

In a daily by hour campaign, the advertiser may set certain hours of the day to have higher offerings during their typical slow periods to encourage Patrons users to take advantage of their service during their slower times. Such a campaign has a very small short-term impact on the user's engagement when taken advantage of (e.g., DBH=V5-V10 ED14 per event CV100).

In a weekly campaign, an advertiser may set weekly campaigns to attract customers during a typically slow time that sits outside the rest of the week's traffic patterns. For example, if a business is typically slow on Monday night, they can create a campaign that has a recurring offer during that period. Such a Campaign has a very small short-term effect on the user's Engagement score (e.g., WC=V10 per event ED14 CV 100).

In an event offer campaign, an event offer may be put forward by an advertiser to create draw for specific events that are scheduled ahead of time; for example, if a merchant wishes to attract customers for openings, anniversaries, or to attract the clientele as a sporting event lets out. These offers have a small amount of short-term engagement awarded to the user (e.g., EO=V10 per event ED14 CV100).

In some embodiments, an offer alert may be implemented when a merchant is having a slow period and wishes to attract a bump in business before sending staff home. Not only do they offer an increased amount of support but the users are further incentivized by a medium short-term bump to their engagement level. These events can be set at as little as three hours and the advertiser can set them to or extend them as they wish up to 12 hours. These offers are sent to the users through their offer alert feeds on their computers and mobile devices (e.g., OA=V20 per event ED14 CV200).

In some embodiments, flash alerts are short-term offers that users can follow through their feeds as well as sign up through texts and emails. These run for two or fewer hours and offer, in addition to the support, a high level of short-term engagement (e.g., FA=V40 per event ED21 CV300).

In some embodiments, passing offers are designed to be limited distribution high support offers. For example, if a business wishes to attract customers with a uniquely high support offer but is concerned that there may be too much of an increase to their own traffic, the user can create a Passing offer campaign. In setting up the campaign they can determine a maximum number of people that can receive that offer at a time, then in a ongoing fashion tailor its distribution to attract the clientele at a manageable pace. Passing offers may be set to anyone or to user accounts that have not made purchases at the offering establishment before or users that have not been back in a while (e.g., PO=V10 per event ED14 CV100).

In some embodiments, loyalty campaigns may be set to encourage repeat business that gives the user a single purchase offer of increased support once every X dollars is spent at their establishment; for example, spend $300 over time and get 10% support on your next purchase. Loyalty campaigns may be tracked by the user through the loyalty pane of their account profile and mobile apps (e.g., LC=V20 ED30 CV 100).

Referring again to FIG. 33, an example of an applied engagement-valued cost-per-action calculation applying pertinent values to a user weighing the engagement value to evaluate a particular 1-item transaction with cart or inventory integration is provided:

OPV+PI+ARI+WPP+RC=EV

EV=MEO

MEOxETGV+MEOxEVIO=TCE

In some embodiments, marketing process 10 may include generating, using one or more computing devices, a user account associated with a particular user. Marketing process 10 may further include assigning an initial engagement value to the user account based upon, at least in part, the user's actions with one or more merchants and identifying at least one trackable purchase event associated with the user account. Marketing process 10 may also include providing at least one advertising campaign parameter to the user account, wherein a portion of the revenue generated from the at least one trackable purchase event is directed to a beneficiary of the user account.

In some embodiments, the portion of revenue may vary depending upon a particular campaign parameter. For example, offers may vary according to a type of desirable behavior. In this way, some campaign parameters may include, but are not limited to, introductory offers (e.g. bringing in new customers), loyalty offers, tier bonus offers (e.g. increased directed revenue with larger purchases) and alerts (e.g. consumer consents to receive alerts for special offers from advertisers).

In some embodiments, an amount of revenue offered may be related to an amount of participation associated with the user account. In this way, desirable behaviors that demand more time and participation from consumers may be matched with higher directed revenue offers.

In some embodiments, providing at least one advertising campaign parameter may include providing at least one campaign parameter from an advertiser. Accordingly, the advertiser may control the parameters of offers based upon advertising budgets, margins of industry, desirability of particular consumer behaviors, etc. In some cases, offers may vary according to type of desirable behavior, including introductory offers (e.g., bringing in new customers), loyalty offers, tier bonus offers (e.g., increased directed revenue with larger purchases) and alerts (e.g., consumer consents to receive alerts for special offers from advertisers).

In some embodiments, marketing process 10 may include generating, using one or more computing devices, a plurality of user accounts, each associated with a particular user and assigning an initial engagement value to each user account based upon, at least in part, each user's actions with one or more merchants. Marketing process 10 may further include identifying at least one trackable purchase event associated with each user account and adjusting the initial engagement value based upon an advertising parameter set by an advertiser. Marketing process 10 may also include allowing each of the plurality of user accounts to direct at least one portion of the revenue generated from the at least one trackable purchase event to at least one beneficiary of the user account. In some embodiments, the at least one beneficiary may include one or more entities selected by the particular user associated with each of the plurality of user accounts.

In some embodiments, marketing process 10 may include receiving, from the advertiser, revenue in accordance with an advertising campaign. For example, in exchange for engaging in consumer behaviors desirable to advertisers, consumers may direct revenue, provided by advertisers via the system's advertising campaign structure, to a queue of beneficiaries. As discussed above, beneficiaries may include individuals, businesses, corporations, for-profit, non-profit or any entity that registers with the website associated with marketing process 10.

In some embodiments, marketing process 10 may include requesting that the user agree to the terms of service associated with the user account. For example, beneficiaries may receive funds according to the parameters of the website's Terms of Service and agree to website's end user license agreement (“EULA”).

In some embodiments, at least one of the revenue and an advertising cost associated with marketing process 10 may be based upon, at least in part, one or more of transactional data, a user engagement score and an advertising campaign parameters. In this way, directed revenue and cost to the advertiser may be determined by a calculation derived from transactional data, the consumer's engagement score and the advertiser's campaign parameters. In exchange for engaging in consumer behavior desirable to advertisers, consumers may direct revenue, provided by advertisers via platform's advertising campaign structure, to a queue of beneficiaries.

In some embodiments, marketing process 10 may allow users to associate their accounts to their smartphones through an application, allowing for the optimization of their shopping errands in accordance to their user priorities and the utilization of itemized shopping lists at inventory-integrated merchants. In this way, marketing process 10 may allow for an advanced security dial or pad on their phone, as described below, through the phone integration system, and may use the smartphone camera to scan bar codes to search for competing-product target-support bids.

In some embodiments, users may also be able to set enhanced security features for the profile, notably the advanced security dial/pad, the Passcode Randomizer. Accordingly, users may be able to compose passwords for their accounts using a dial or pad of numbers or images (including user-uploaded images) that shifts within a field, eliminating security threats by key loggers (for computers) or theft (for smartphones, where frequently-pressed touchscreen keypads can reveal the owner's password via fingerprints). As such, the Passcode Randomizer may work along with more traditional advanced account-security features.

In some embodiments, the passcode solution may allow the user to set an image substitution of letters and/or numbers that is specific to her and allow the user to select her passcode. Then, when the images or numbers are displayed to allow for the unlocking of the device, every time the code is used the letters or images shift in their relative position to each other, according to the users' settings. Accordingly, unless intruders have a clear view of the screen when the passcode is entered, they would not likely have enough information to discern the passcode, thus rendering finger smudges, wear and tear, or even many keyloggers of little use. In some embodiments, the passcode could be made variable by a contextual word or phrase that the user sets based on images specific to his life. For example, the user could set a phrase to “1” and the images are all of sports; the user would know the sequence in which he started doing certain sports even if he has not done them in decades, but if the word is “2” the passcode sequence could be the order your second child tried their sports from the images shown. In operation, the system may shift the digital keys in relation to each other, allowing the user to set the variables through substitution of images and/or may allow the user to go so far as to the changing of the actual code according to a “challenge and response” system defined by them.

In some embodiments, marketing process 10 may allow merchants to create accounts, manage their campaigns by setting the percentage and/or threshold offers of support, the duration of those offers, and default offers. Merchants may also use the system to make payments, track their campaign performance, current and historical; retrieve API codes for use with digital signage that can show their running offers, and block certain targets from receiving their marketing funds from the target list. All of their campaigns may also be tied to the user's “Engagement metric.” For example, if User 1 has recently viewed advertiser offers while logged in to a browser or a mobile app within the last 7 days, broadcasted through her social media accounts a supporting purchase event, done activity maintaining her account and used a Patrons support signature widget on a website, he/she may qualify as a highly engaged user. In contrast, if User 2 has only logged in and viewed offers a week ago then he/she may have a reduced engagement metric and the advertiser can offer less accordingly. If User 3 has not logged in for 30 days, this may result in his/her account being flagged as dormant (e.g., no longer incurring cost to advertisers) until she performs an action that triggers an increase in her engagement metric.

In some embodiments, beneficiaries may be able to track their support and pending support amounts, view their support history and high-level supporter numbers (such as number of supporters and average amount of support generated), retrieve advertising codes for their websites, view the number of Patrons account referrals that they have generated, interact with their supporters through their Patrons home page, send out correspondence to their supporters, manage their links to their home page, retrieve support widget codes for display on their home page, and retrieve a “digital Tip Jar” widget code to put on their website.

In some embodiments, social engagement may be calculated by assigning to the many behaviors demonstrated in social media and associated applications a value based on their pertinence delivering value to an advertiser on an ongoing basis. This allows social media to provide context around the actual purchase event, tracked through online financial systems associated to that social media account, which may provide information on the likelihood and/or degree of how the online behaviors shaped online or offline purchases.

In some embodiments, the user's social media profile may allow users to define through their social media profile the for-profit and non-profit beneficiary or beneficiaries (e.g. private websites, webisodes, television shows, and blogs, etc.) to which the marketing money advertisers spend to influence users' shopping behavior is delivered. The advertiser may bid a variable amount to attract users' purchasing activity, tailoring the offers based upon factors such as gross receipts, individual items, geography, and engagement metric, which may constitute a “consumer-out” approach to marketing, as opposed to the traditional “advertiser-out” approach. In this particular example, “Consumer-out” may indicate that the individual consumer dictates the recipient of the marketing dollars used to influence their buying behavior. Engagement may be calculated by assigning the many behaviors demonstrated in social media and associated applications a value based on their relevance in delivering value to an advertiser, on an ongoing basis over time.

In some embodiments, marketing process 10 may include generating, using one or more computing devices, a plurality of user accounts, each associated with a particular user, the plurality of user accounts associated with a crowd-funding website. Marketing process 10 may also allow, via a graphical user interface associated with at least one of the plurality of user accounts, the particular user to determine what personal information to disclose to one or more merchants. An initial engagement value may be assigned to each user account based upon, at least in part, each user's actions with one or more merchants. Marketing process 10 may also identify at least one trackable purchase event associated with each user account and adjust the initial engagement value based upon a level of personal information disclosed to the one or more merchants and the at least one trackable purchase event.

In some embodiments, marketing process 10 may allow, via the plurality of user accounts, at least one financial contribution to a beneficiary. In some cases, this may involve allowing a plurality of contributions to a plurality of beneficiaries. The plurality of user accounts may each include a security randomizer. For example, a touch screen randomizer that may include a dial or button numeric display using numbers or symbols that may be configured to shuffle the numeric positions relative to each other for added security on electronic devices.

In some embodiments, marketing process 10 may include a full channel crowd-funding site that may allow prospective people and entities to complete the process of being funded as well as a turn-key process under the same website community infrastructure for sustaining revenue to monetize the project as a going concern through a marketing community directed marketing platform. In some embodiments, the crowd-funding aspects of marketing process 10 may involve a number of phases. For example, an ignition phase may be built of a more traditional crowd-funding structure where the community can contribute funds in exchange for anything from products, experiences, credit, stock, notes, goods, services, or nothing if they so choose. Additionally and/or alternatively, an achievement phase may consist of the creation of the stated project or achievement of the stated goals. This may include status updates through the social infrastructure for the supporters who wish to monitor progress if it is being shown. A Sustain phase may refer to a situation where once the project is completed the initial backers and the community may then use the built-in marketing infrastructure to support the project as a going concern, thus supporting it through advertising revenue rather than personally contributed revenue as in the conventional first stage.

In accordance with marketing process 10, one possible example of how the engagement metric may work is provided below. In this particular example, four degrees of engagement are shown; however, any number may be used without departing from the scope of the present disclosure. Dormant: Account has not done anything to engage with advertisers in the past 30 days (this level may not generate any revenue). First degree of engagement: Account has recently demonstrated the behavior of seeking out of advertiser offerings through viewing merchant offers by some means (this level may generate low revenue). Second Degree of Engagement: Frequently demonstrates active integrating behavior by utilizing apps or the website on at least a weekly or daily basis to view merchant offers (this level may generate medium revenue). Third Degree of Engagement: Frequently demonstrates active integrating behavior by utilizing apps or the website on a weekly or daily basis to view merchant offers while also demonstrating “influencer” behaviors such as regularly posting their Patrons activity through external social media sites, bringing Patrons offerings to the attention of their personal social network (this level may generate high revenue).

In some embodiments, users may set their accounts to receive correspondence from their support targets, view the overall support page of their targets and receive notifications when merchants place one of their targets on their “blocked” list.

In some embodiments, the account-holding consumer may be allowed to search and browse from a target list of beneficiaries of their generated marketing revenue, adding them to their beneficiary queue and then setting goals. This beneficiary queue may then be assigned distribution priorities by sequence and/or percentage. For example, a user can set a distribution of generated revenue across the top four positions by a ratio of 10%, 50%, 25%, and 15%. In the first position, the user has set the goal to “open-ended,” meaning that the beneficiary may hold that 10% position continuously, while the 50%, 25% and 15% have goals of $2.00 per month, $1.00 per month, and $3.00 per month respectively. As the goals are met the queue scrolls upward, distributing revenue according to the user's parameters and moving new beneficiaries into recipient positions in the queue on an automated basis. If the user has a website as a beneficiary, that website can create additional feature offers tied to a certain level of user-directed purchasing support; the user in turn can set a goal for that amount and under that target's settings associate his account on the website to his support account so the website can be automatically notified when the goal is reached. As discussed above, websites may also be able to place a “tip jar” widget on their website. This widget is something that a user would be able to click on to “tip” a website in exchange for its services. The tip action moves a 10-cent to $1.00 placeholder to the top of the queue that, once the revenue was generated, would be removed permanently, unlike the regular queue elements that can return at the beginning of a new cycle. This tool may allow users to give a small amount of support to a website that has given them a passing, not sustained, value.

In some embodiments, marketing process 10 may allow for geographical search refinement, new customer lead generation, recurring customer loyalty, incentivizing purchases of a certain size, crowd flow management, etc.

In some embodiments, marketing process 10 may allow for a user to create associations between their user account and one or more financial accounts. In order to associate the user's financial accounts, they may need to enter an OFX (Open Financial Exchange) login and password. The user may cancel his/her account at any time. If the user chooses to stop but does not want to cancel his/her account, they may also just change your OFX password, which breaks the association created here.

In some embodiments, marketing process 10 may utilize verification data for a transaction event. This may consist of the user's unique engagement score on the day of the transaction, the transaction ID, the date of the transaction being valued, and finally the applicable campaign offer to the number of visits tracked. For advanced campaigns, the time and location of the participation confirmation through GPS or QR scan for the applicable campaign event may also be utilized. All of this allows users the ability to verify the transaction against their own records. Marketing process 10 may also share any feedback that the users decides to send them about their visiting experience. This allows them context around the purchase event while still protecting the user's privacy, while providing very meaningful ROI metrics through a platform of mutual benefit.

In some embodiments, marketing process 10 may allow for the sharing of data while designating a “preferred merchant”. For example, that merchant may be able to see their total number of Patrons that grant them preferred status. The merchant may also be able to see other non-specific gross data metrics such as average total visits from your preferred community.

In some embodiments, marketing process 10 may allow for an automatic feed functionality. For example, if the user has auto-feed enabled, that information may be shared in accordance to the user's settings based off of their preferred merchant list. The Preferred merchant may, for example, be notified of how many feeds they show up in but users may not be specifically identified unless social activity or settings determines otherwise. The user may, however, see the feed come up through the applicable social media site, in accordance with the nature of social media.

In some embodiments, marketing process 10 may allow for the sharing of data while designating a “beneficiary”. In this way, users may be able to view a beneficiary's total number of Patrons, the total raised by their supporters, and basic Gross level metrics such as average amount of support per active Patron, average support generated per month, etc. If the user desires to share more and engage further with beneficiaries, they may include beneficiary-specific privacy settings in their beneficiary management pages.

In some embodiments, marketing process 10 may allow for the sharing of data connected with participation in social features; however, only what is necessary in order to provide the user with the ability to operate that feature. For example, to post to a discussion, marketing process 10 may disclose what the user said and the user's posting identity; what is shared beyond that is determined by the user's privacy settings.

In some embodiments, marketing process 10 may include one or more privacy settings (e.g. privacy icon, etc.). If a user is concerned regarding a particular action that they wish to take through the system, they may be able to reference the Patrons Privacy icon found by that activity's interface. In this way, marketing process 10 may provide various levels of privacy protection that may be user-configurable.

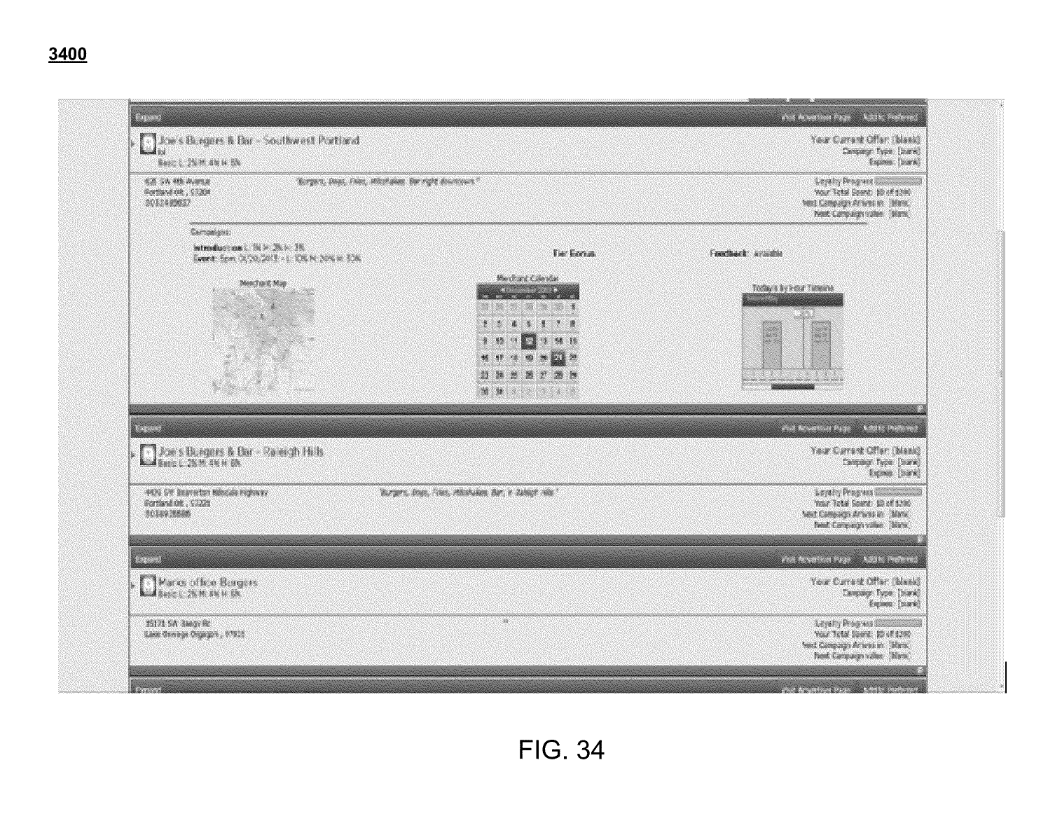

Referring now to FIG. 34, an example of a graphical user interface 3400 generated in accordance with the marketing process 10 is provided. In this particular example, merchant information is provided, which may include the name, address, campaign type, geolocation of merchant, the user's current offers with that merchant, etc. Numerous other types of information may be provided without departing from the scope of the present disclosure.

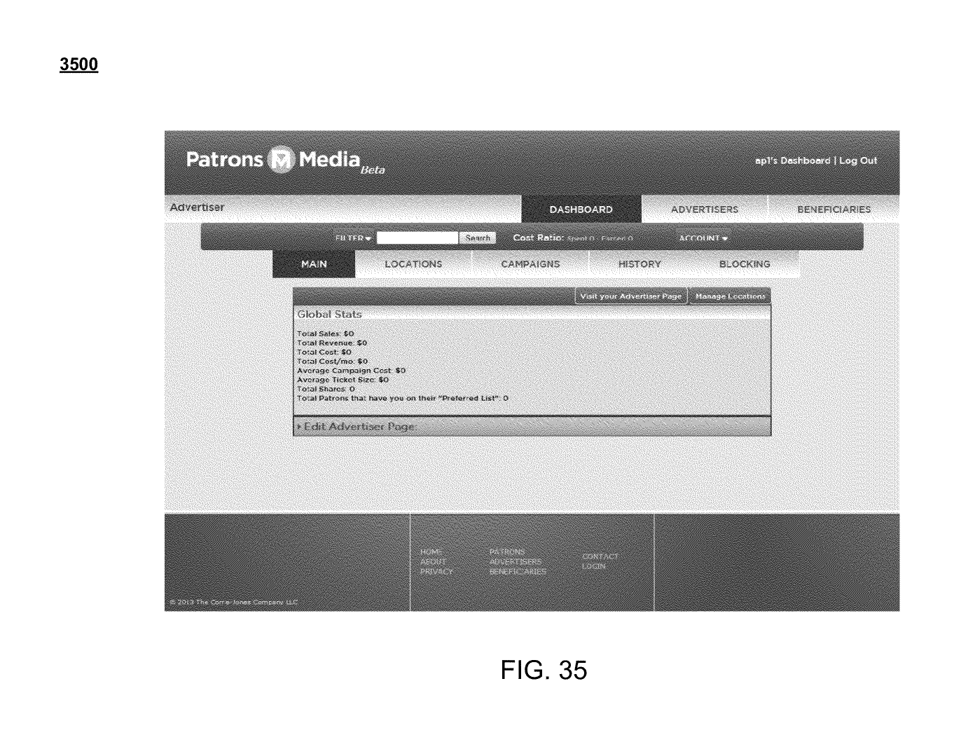

Referring now to FIG. 35, an example of a graphical user interface 3500 generated in accordance with the marketing process 10 is provided. In this particular example, an advertiser's dashboard is shown. The main page of the dashboard may include various information types including, but not limited to, total sales, total revenue, total cost, total cost/month, average campaign cost, average ticket size, total shares, total Patrons that have that advertiser on their “preferred list”, etc. Numerous other types of information may be provided without departing from the scope of the present disclosure.

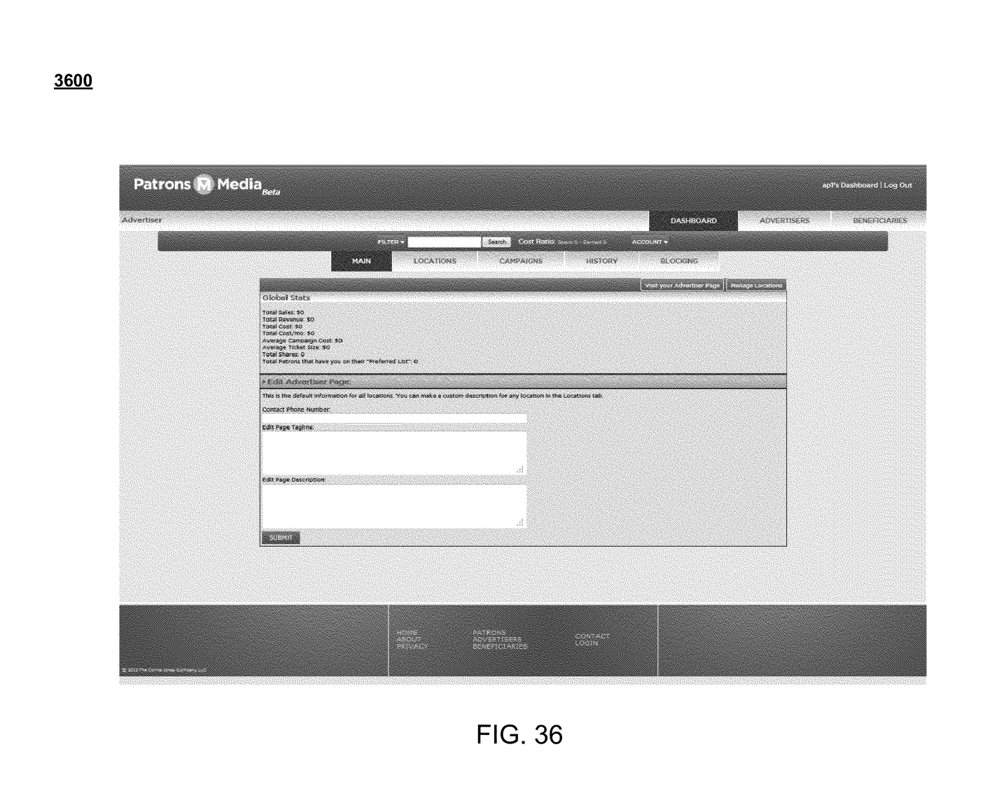

Referring now to FIG. 36, an example of a graphical user interface 3600 generated in accordance with the marketing process 10 is provided. In this particular example, an advertiser's dashboard is shown. This GUI may allow the user to edit various types of information that may be displayed on the advertiser page.

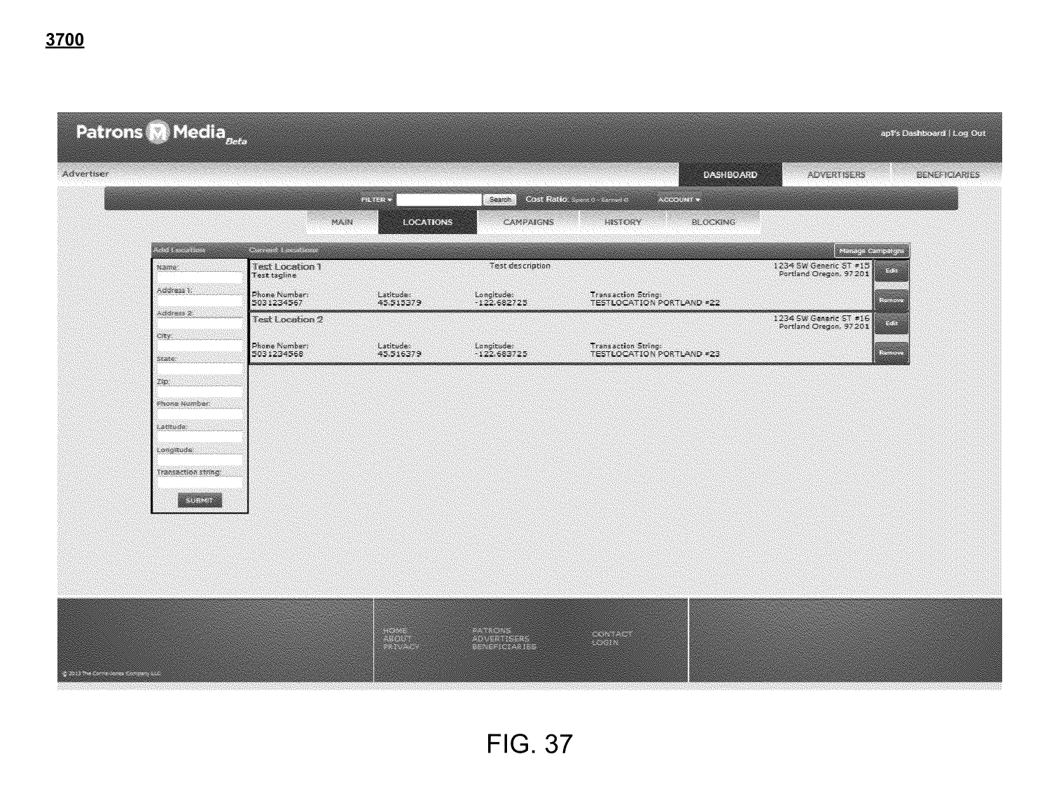

Referring now to FIG. 37, an example of a graphical user interface 3700 generated in accordance with the marketing process 10 is provided. In this particular example, various locations associated with the advertiser are shown. The user may add and/or remove locations if necessary.

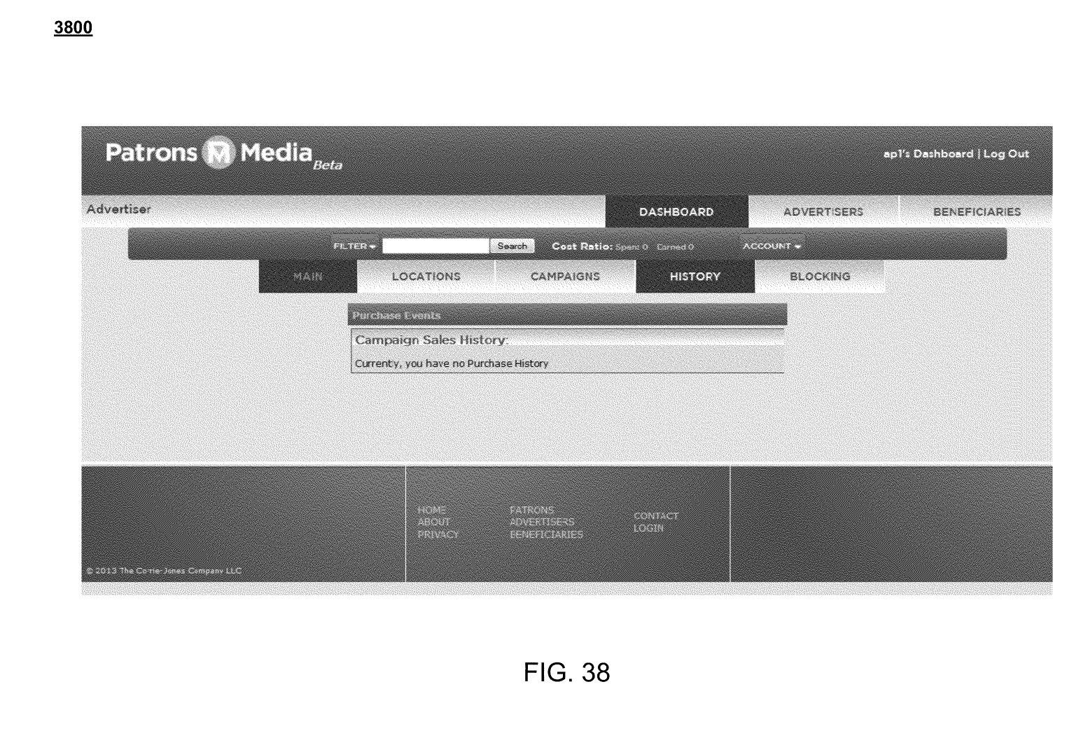

Referring now to FIG. 38, an example of a graphical user interface 3800 generated in accordance with the marketing process 10 is provided. In this particular example, the advertiser's campaign sales history may be provided.

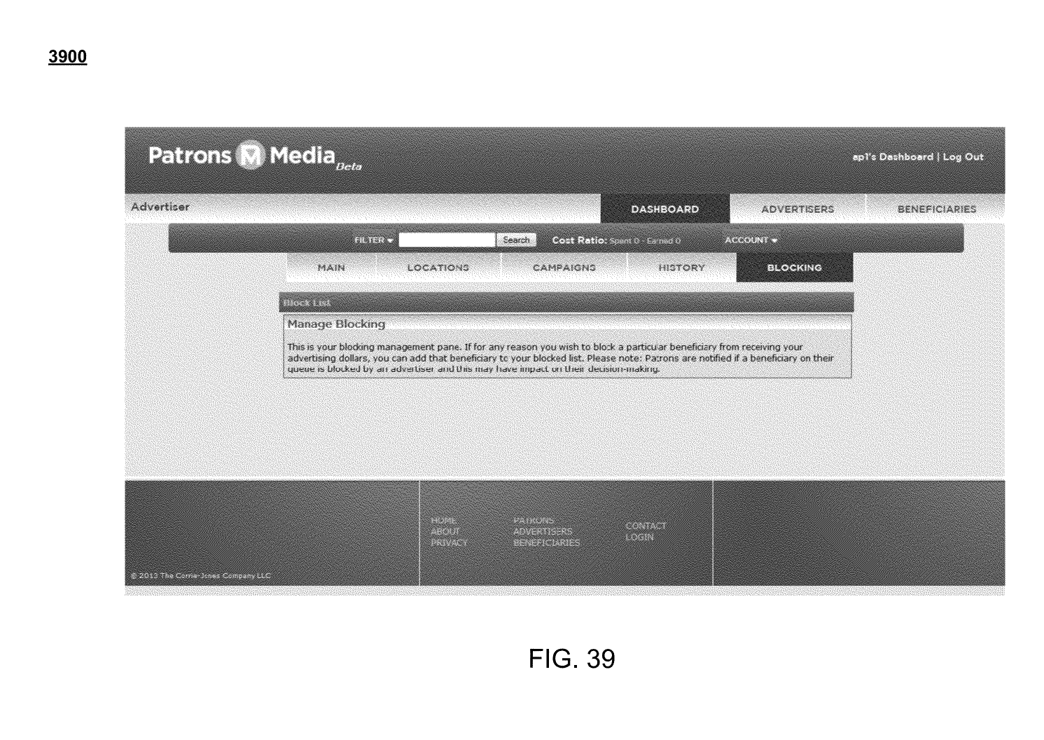

Referring now to FIG. 39, an example of a graphical user interface 3900 generated in accordance with the marketing process 10 is provided. In this particular example, marketing process 10 may allow a user to block particular beneficiaries from receiving advertising dollars.

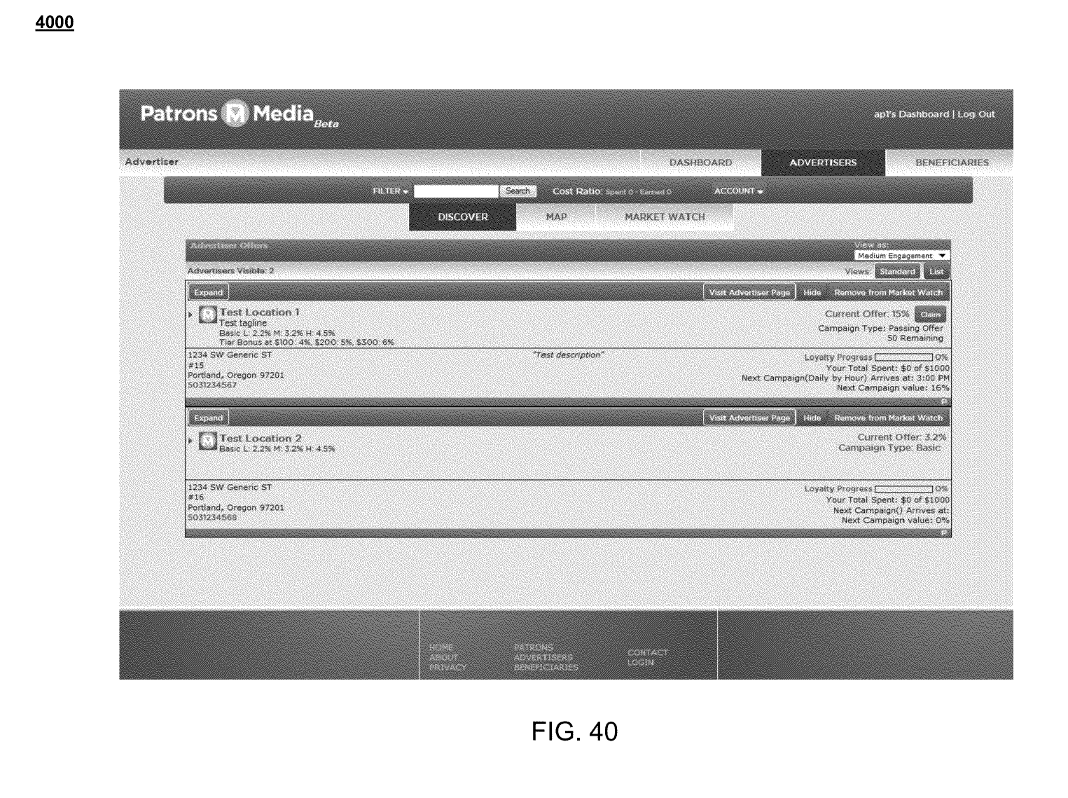

Referring now to FIG. 40, an example of a graphical user interface 4000 generated in accordance with the marketing process 10 is provided. In this particular example, users may be able to discover current offers, current advertisers, campaign types, etc. GUI 4000 may also allow a user to search based upon an engagement level (e.g. medium engagement). Information relating to the timing of the offer, the next campaign values, loyalty progress, etc. may also be provided.

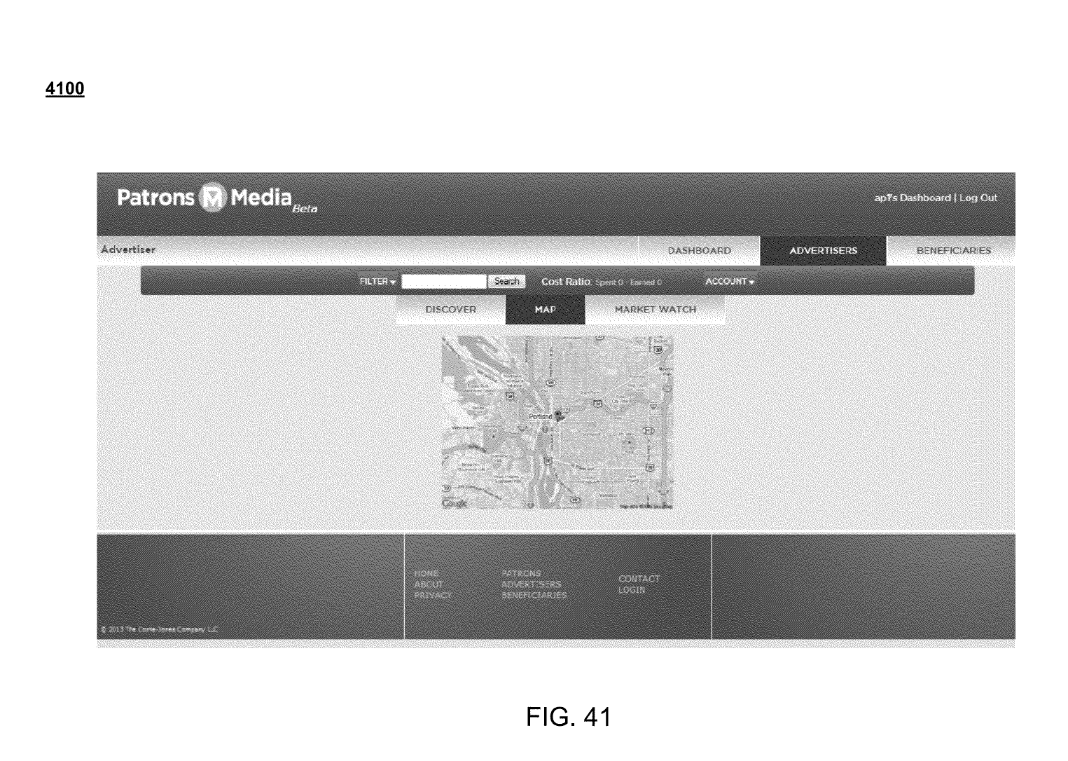

Referring now to FIG. 41, an example of a graphical user interface 4100 generated in accordance with the marketing process 10 is provided. In this particular example, a user may utilize marketing process 10 in order to view a map relating to a particular merchant or advertiser.

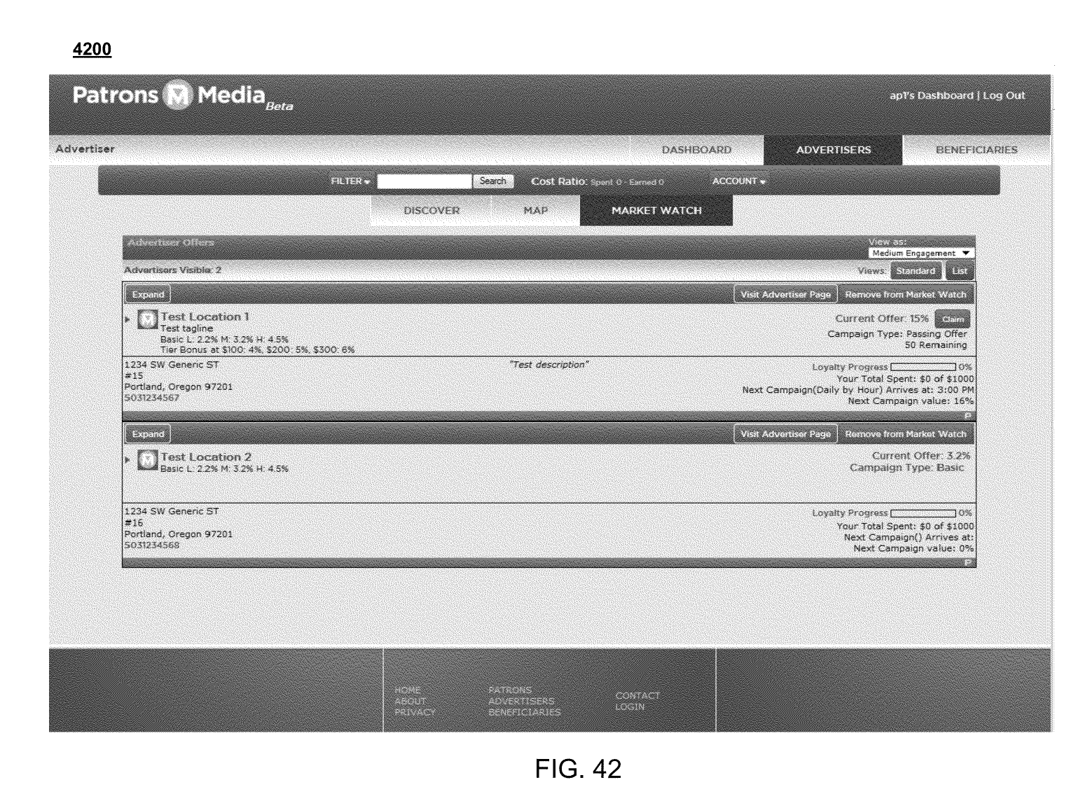

Referring now to FIG. 42, an example of a graphical user interface 4200 generated in accordance with the marketing process 10 is provided. In this particular example, marketing process 10 may generate a market watch page.

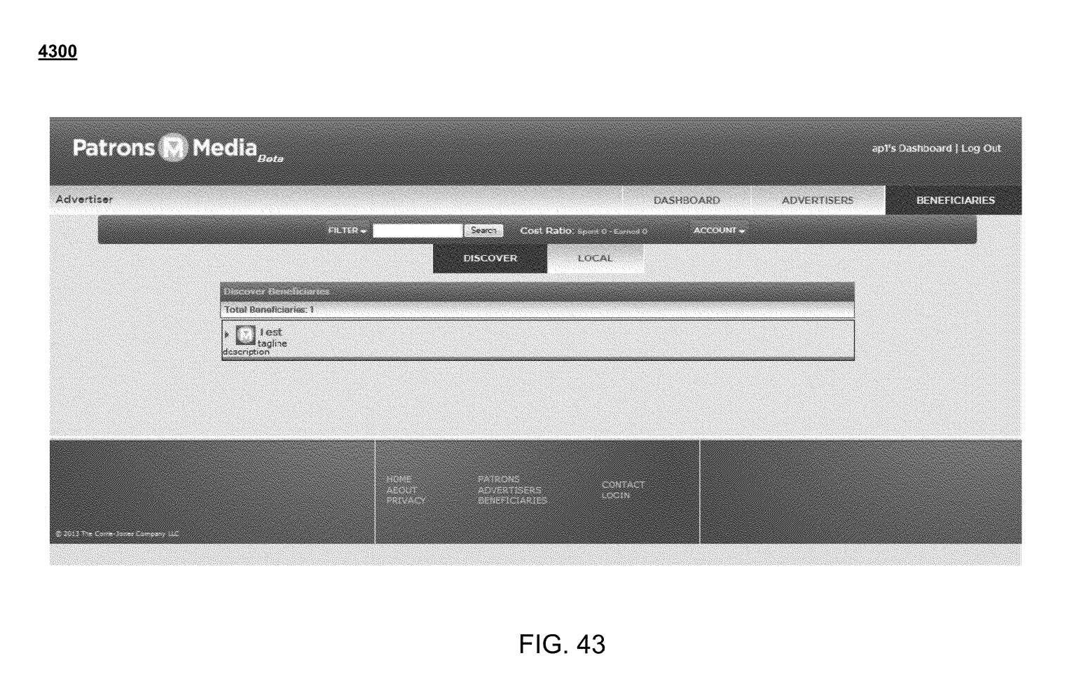

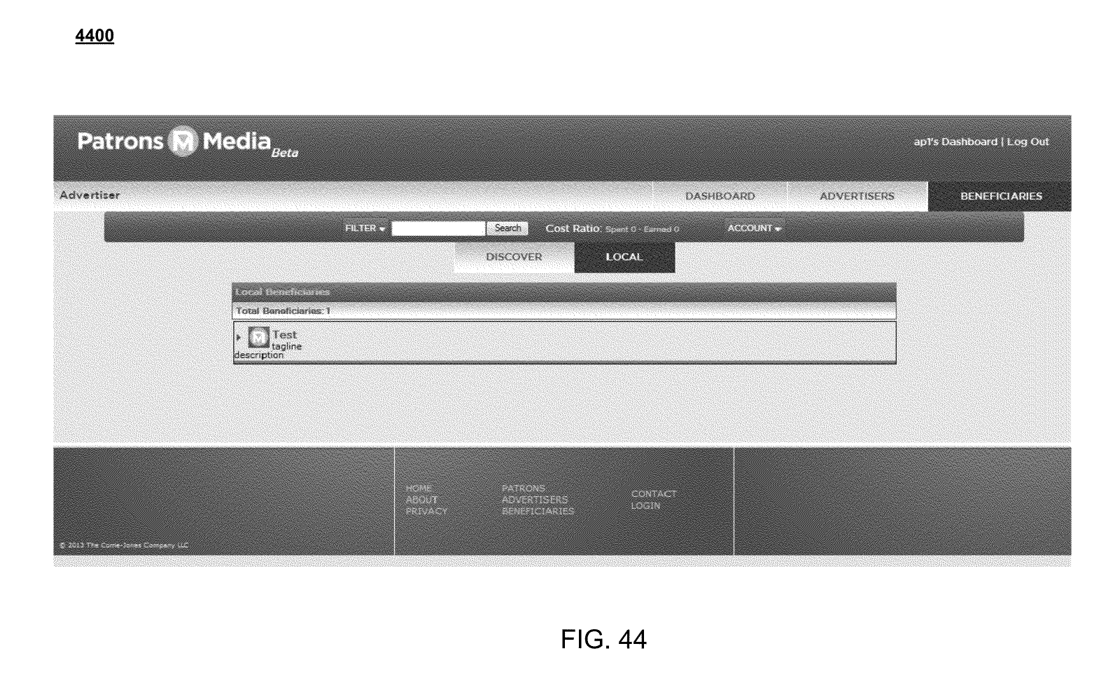

Referring now to FIGS. 43-44, examples of a graphical user interface 4300/4400 generated in accordance with the marketing process 10 is provided. In this particular example, marketing process 10 may allow a user to discover beneficiaries associated with the system. Local beneficiaries may also be provided via GUI 4400.

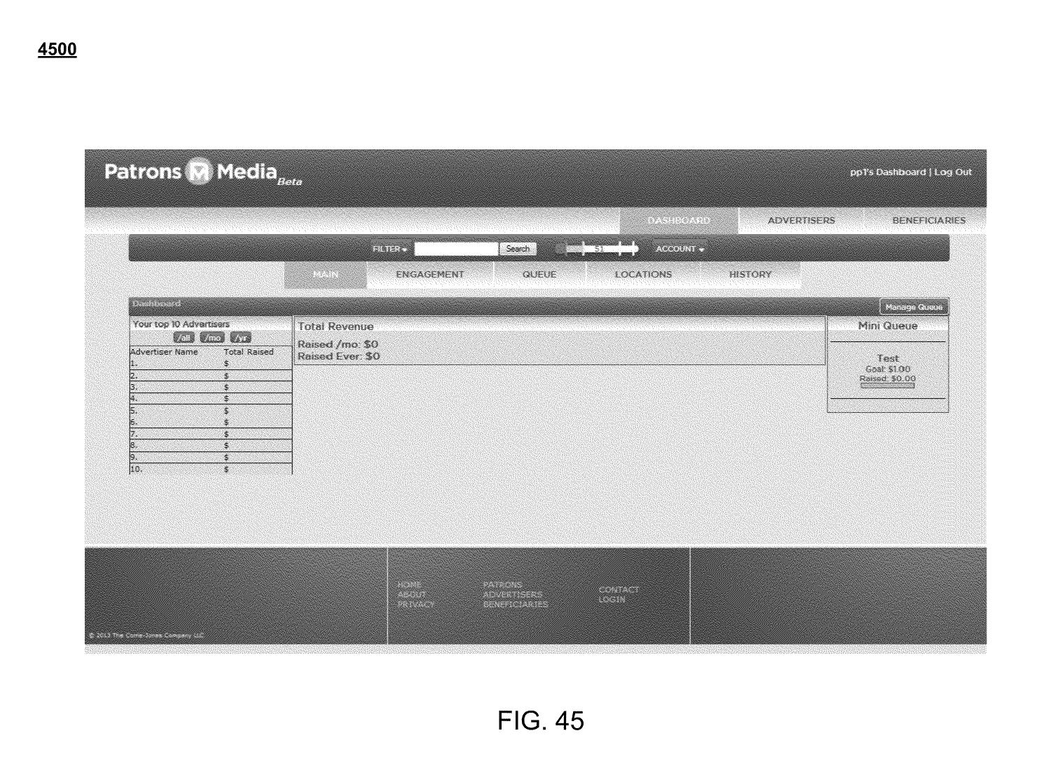

Referring now to FIG. 45, an example of a graphical user interface 4500 generated in accordance with the marketing process 10 is provided. In this particular example, a purchasing partner may be able to view his/her top advertisers. The total amount of revenue raised per/month, per/year, and/or in total may also be provided. Information relating to the target goals and amount raised may also be provided.

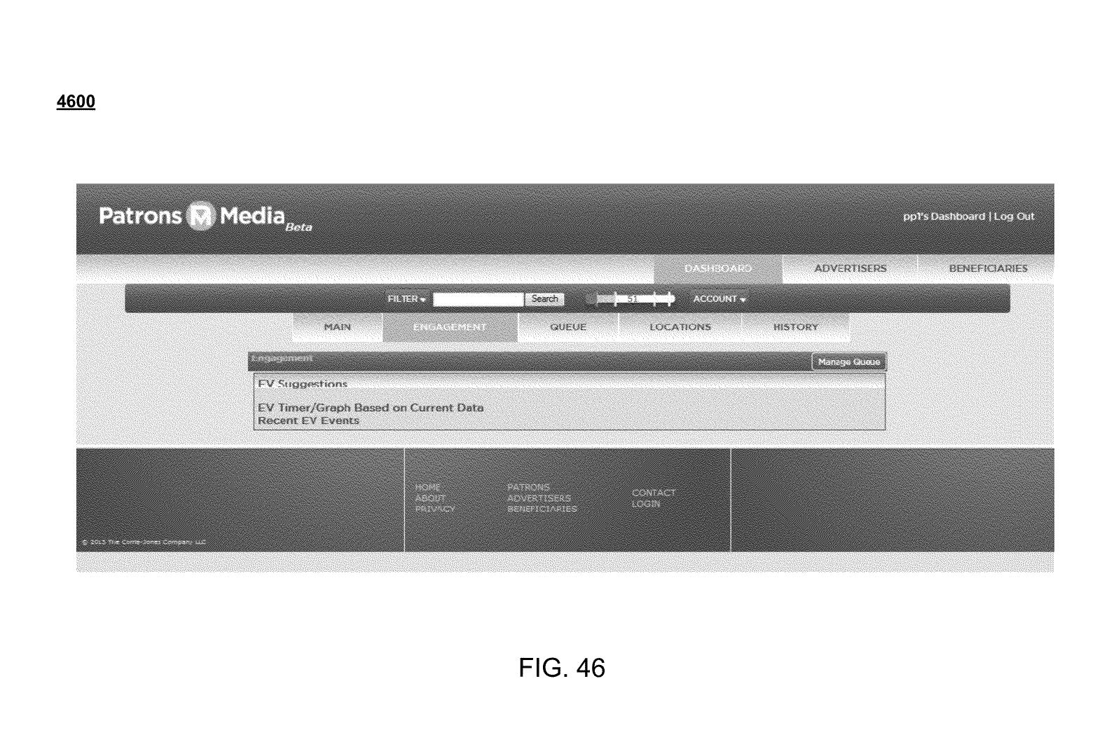

Referring now to FIG. 46, an example of a graphical user interface 4600 generated in accordance with the marketing process 10 is provided. In this particular example, information related to engagement valuation may be displayed. Engagement value suggestions such as recent EV events and EV graphs related to current data may also be provided.

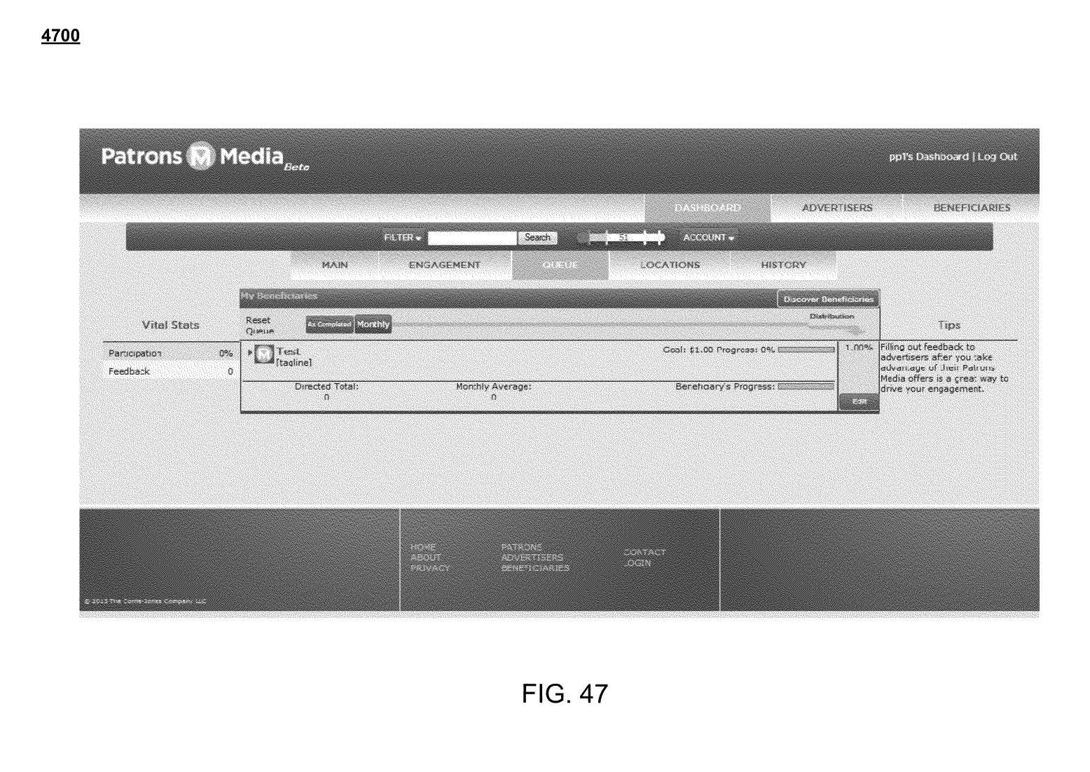

Referring now to FIG. 47, an example of a graphical user interface 4700 generated in accordance with the marketing process 10 is provided. In this particular example, a GUI depicting a queue associated with the user account is provided. The queue may include that user's beneficiaries as well as goal, progress, and numerous other types of information as is shown in FIG. 47.

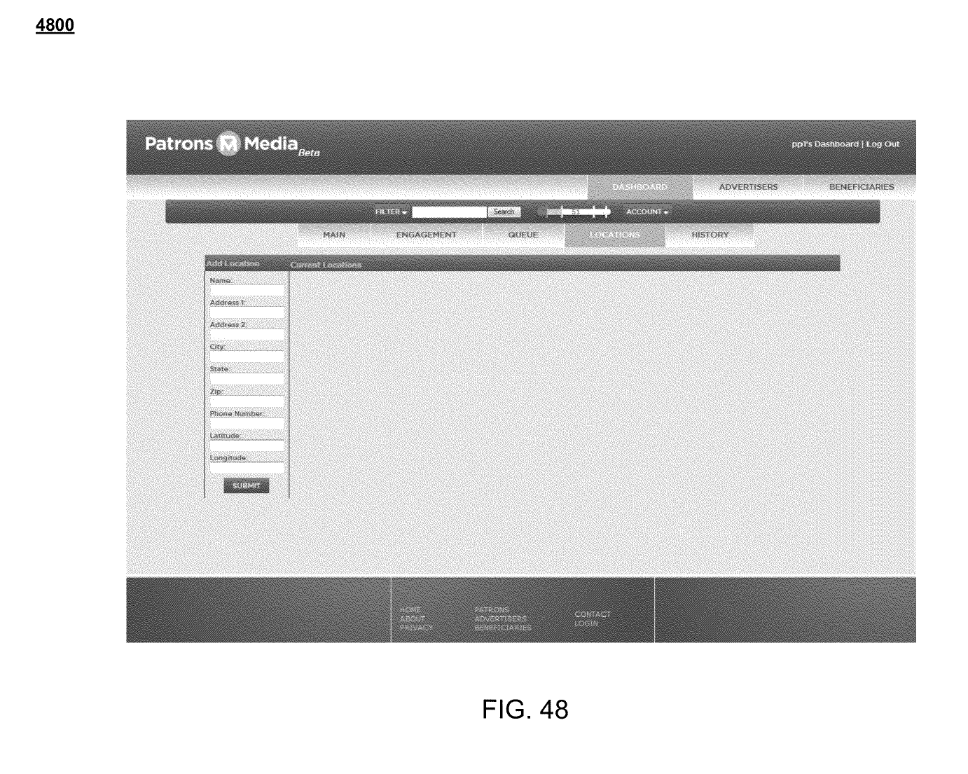

Referring now to FIG. 48, an example of a graphical user interface 4800 generated in accordance with the marketing process 10 is provided. In this particular example, a purchasing partner or user may view current locations as well as add/remove locations to the GUI.

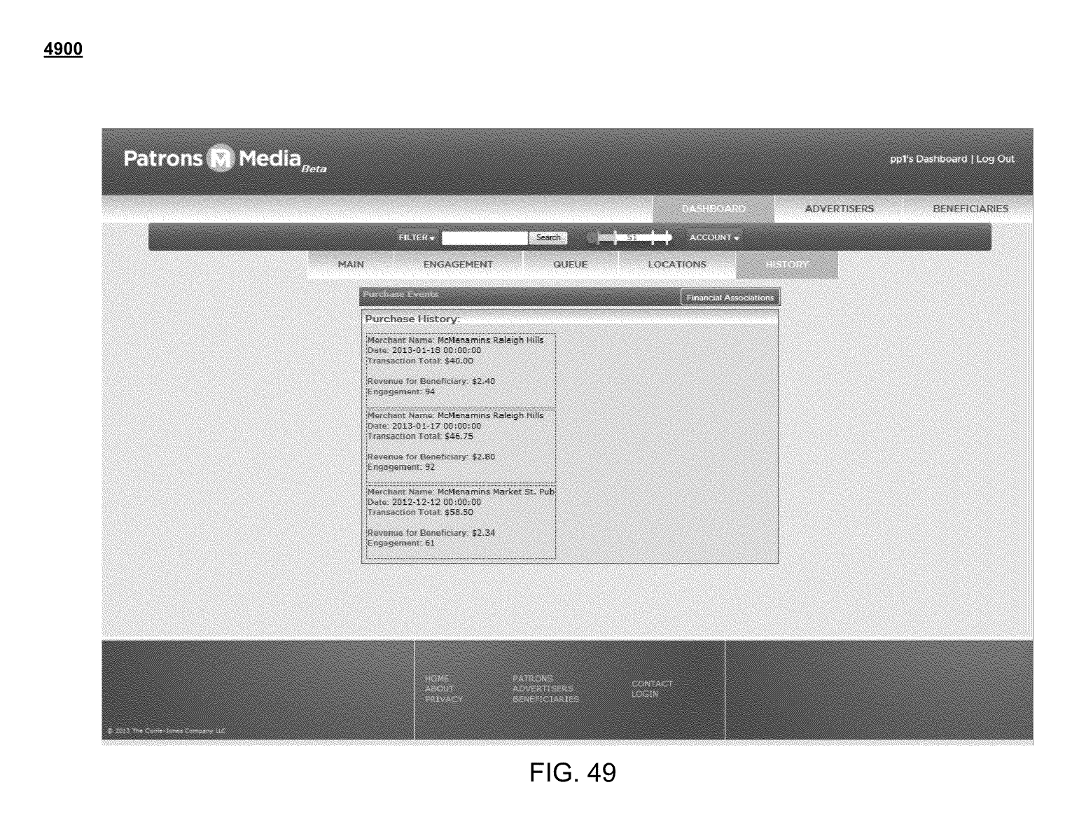

Referring now to FIG. 49, an example of a graphical user interface 4900 generated in accordance with the marketing process 10 is provided. In this particular example, GUI 4900 may allow the user to view his/her purchase history, which may include the engagement value, revenue, merchant name, transaction-specific information, etc.

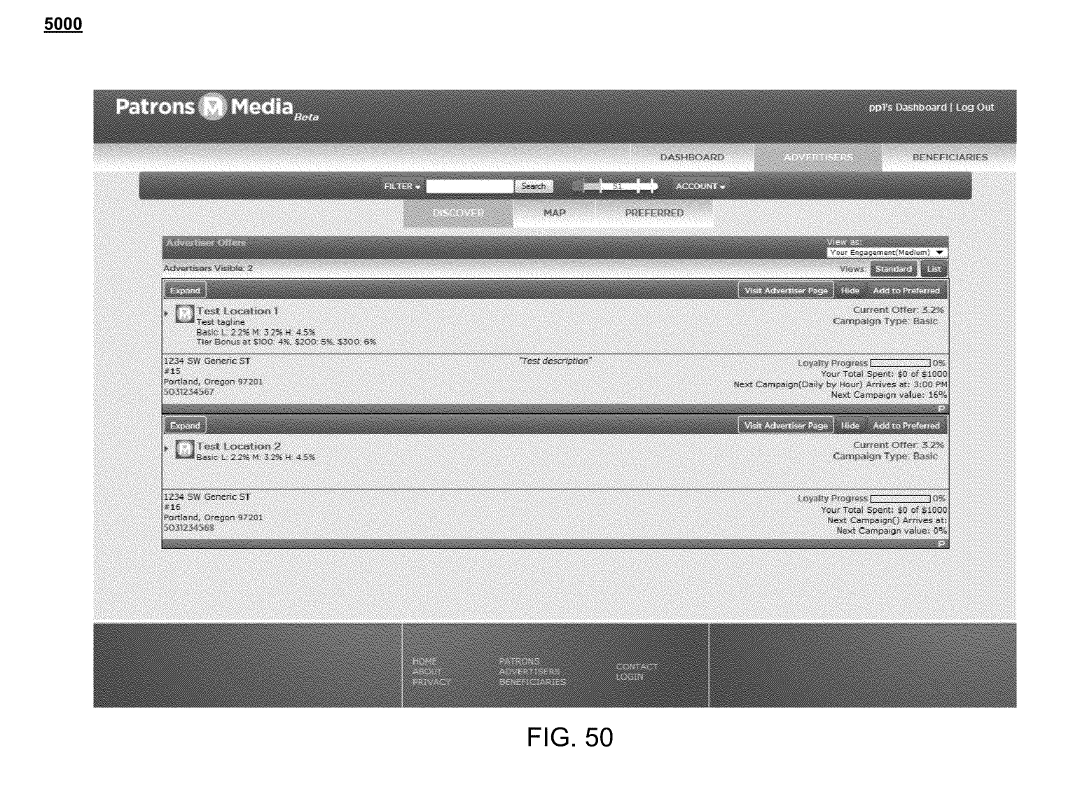

Referring now to FIG. 50, an example of a graphical user interface 5000 generated in accordance with the marketing process 10 is provided. In this particular example, a purchasing partner or user may discover advertisers associated with marketing process 10.

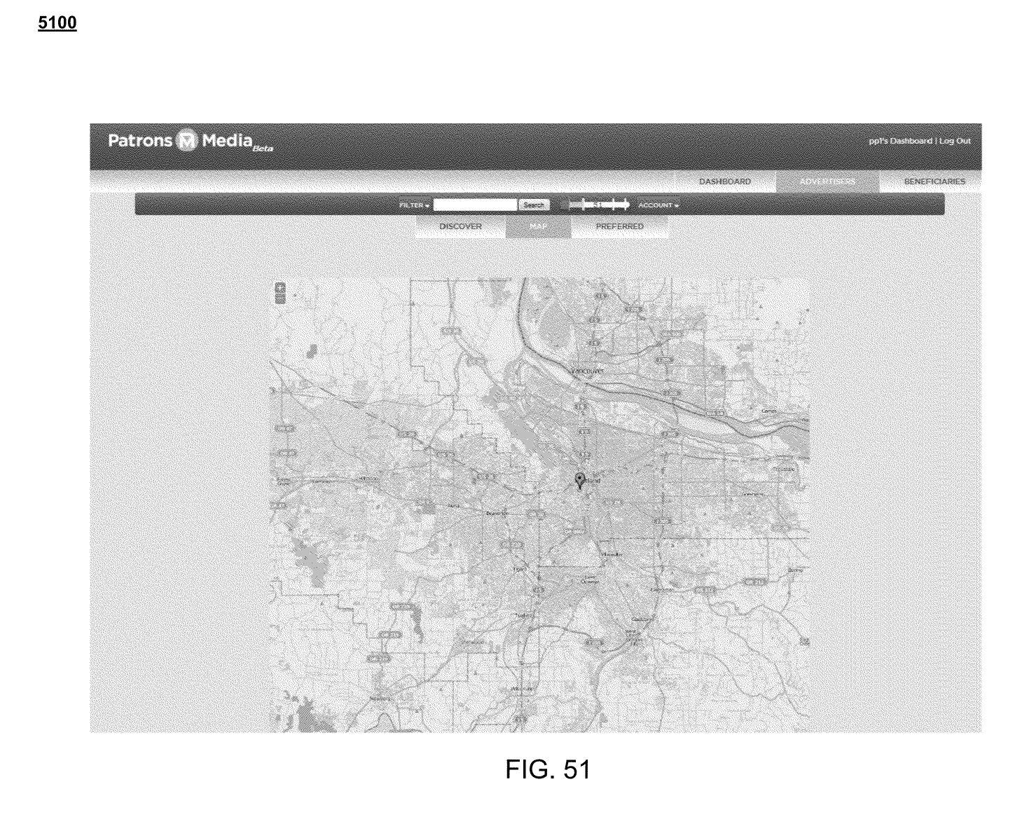

Referring now to FIG. 51, an example of a graphical user interface 5100 generated in accordance with the marketing process 10 is provided. In this particular example, a purchasing partner may view a map associated with a particular advertiser's location or place of business.

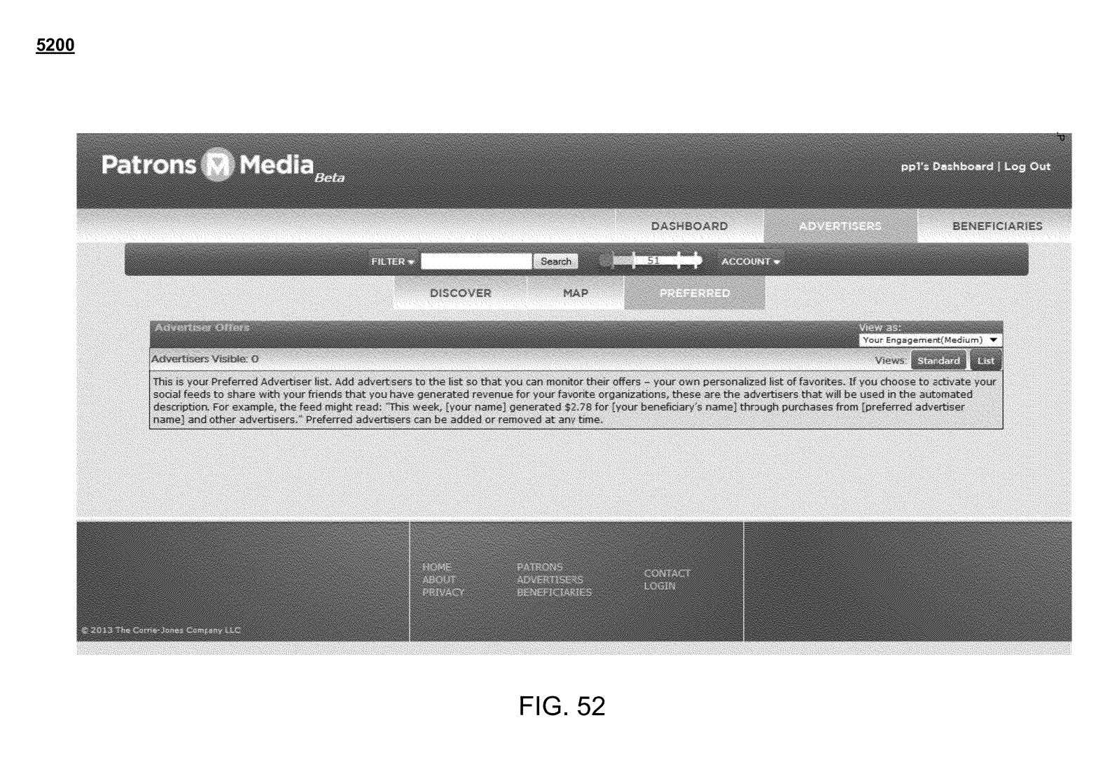

Referring now to FIG. 52, an example of a graphical user interface 5200 generated in accordance with the marketing process 10 is provided. In this particular example, a purchasing partner or user may view his/her preferred advertiser list. The preferred advertiser list may be edited as necessary by the user. In some embodiments, auto feed functionality may be enabled in order to transmit information related to the user's history to their identified social networks.

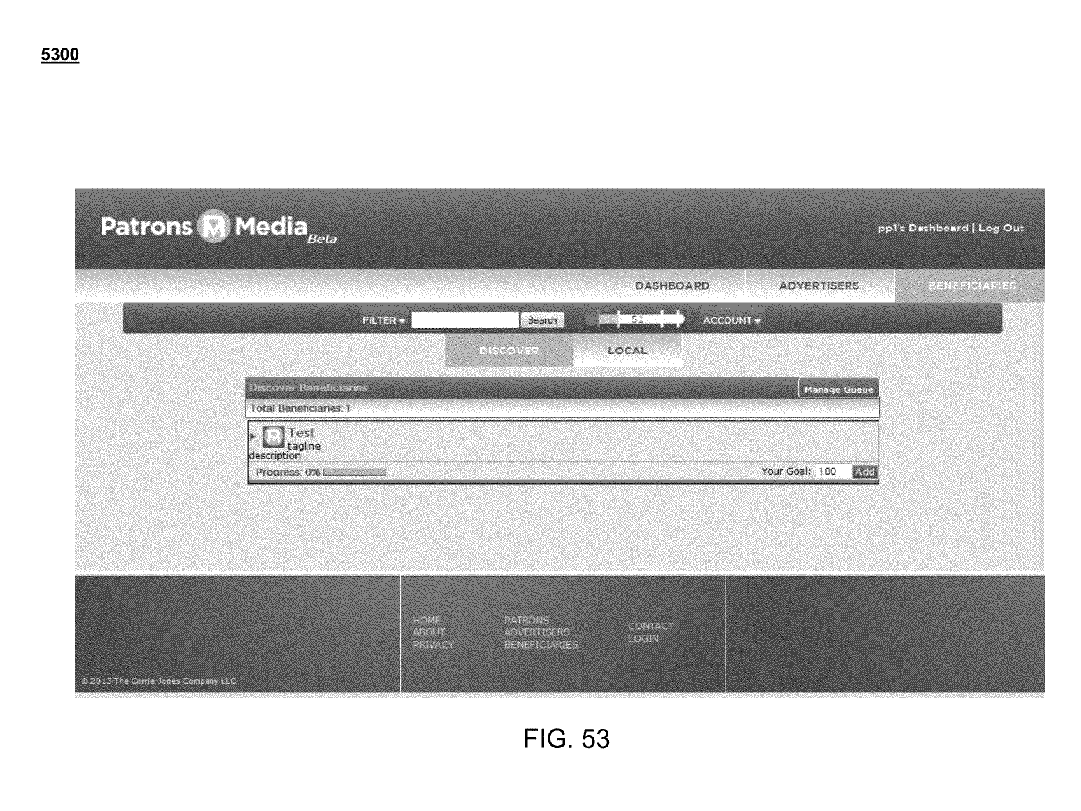

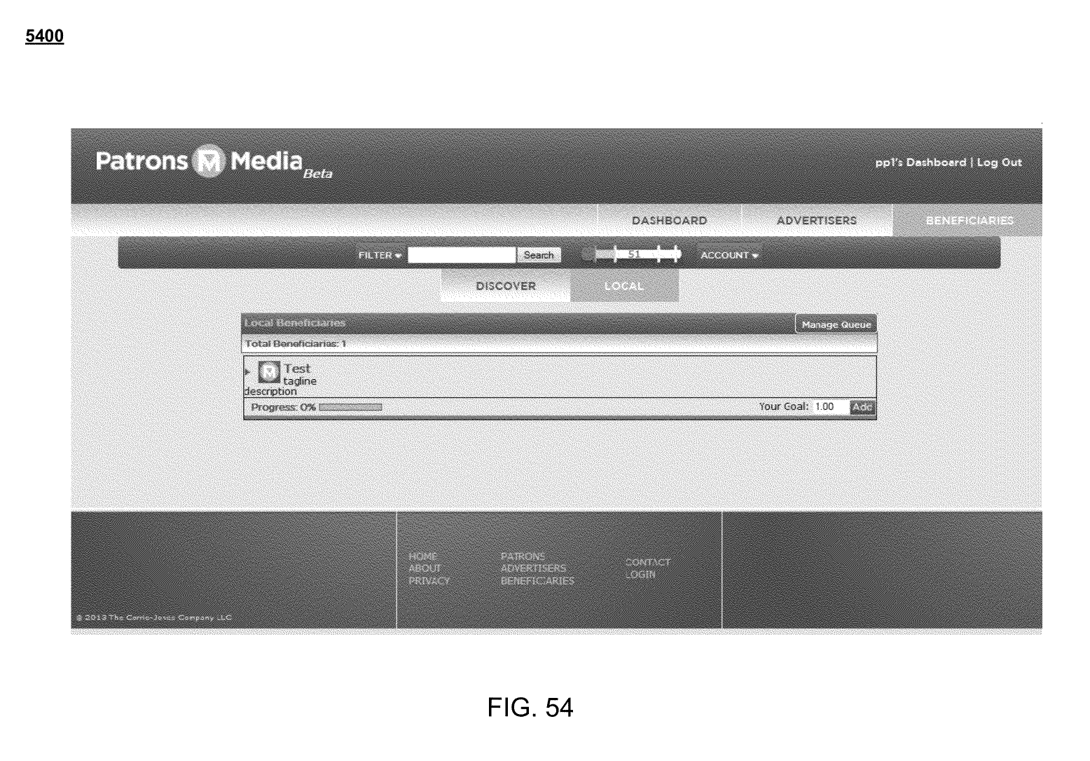

Referring now to FIGS. 53-54, examples of graphical user interfaces 5300/5400 generated in accordance with the marketing process 10 is provided. In this example, a user may discover beneficiaries and search based upon those that are local in nature.

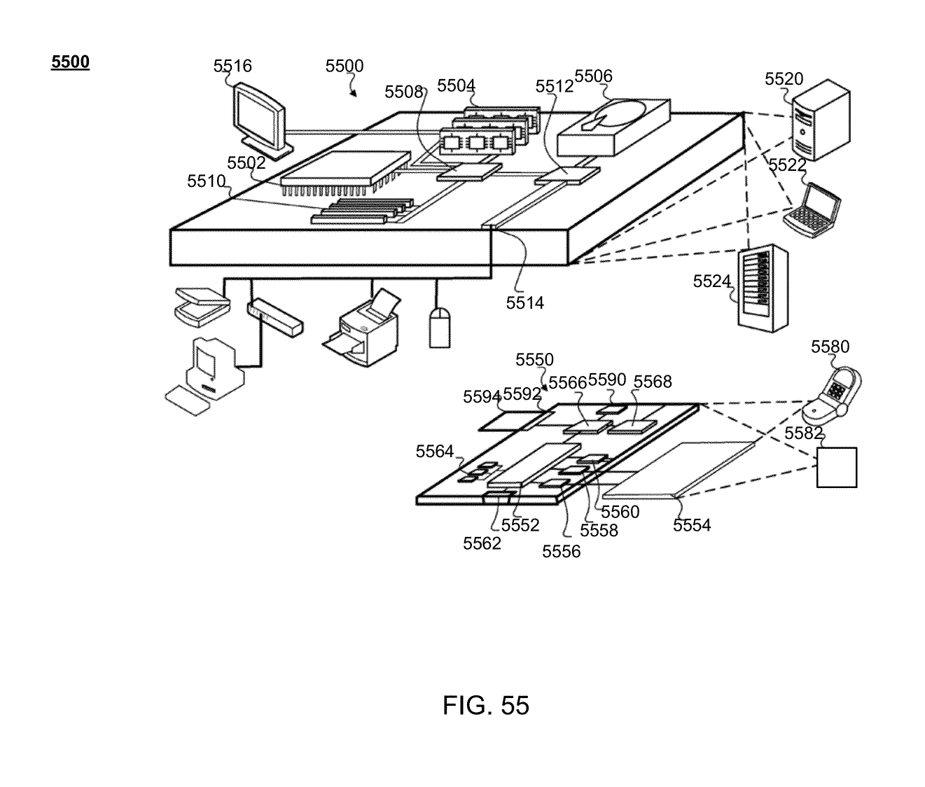

Referring now to FIG. 55, an example of a generic computer device 5500 and a generic mobile computer device 5550, which may be used with marketing process 10 is provided. Computing device 5500 is intended to represent various forms of digital computers, such as tablet computers, laptops, desktops, workstations, personal digital assistants, servers, blade servers, mainframes, and other appropriate computers. In some embodiments, computing device 5550 can include various forms of mobile devices, such as personal digital assistants, cellular telephones, smartphones, and other similar computing devices. Computing device 5550 and/or computing device 5500 may also include other devices, such as televisions with one or more processors embedded therein or attached thereto. The components shown here, their connections and relationships, and their functions, are meant to be exemplary only, and are not meant to limit implementations of the inventions described and/or claimed in this document.

In some embodiments, computing device 5500 may include processor 5502, memory 5504, a storage device 5506, a high-speed interface 5508 connecting to memory 5504 and high-speed expansion ports 5510, and a low-speed interface 5512 connecting to low-speed bus 5514 and storage device 5506. Each of the components 5502, 5504, 5506, 5508, 5510, and 5512, may be interconnected using various busses, and may be mounted on a common motherboard or in other manners as appropriate. The processor 5502 can process instructions for execution within the computing device 5500, including instructions stored in the memory 5504 or on the storage device 5506 to display graphical information for a GUI on an external input/output device, such as display 5516 coupled to high speed interface 5508. In other implementations, multiple processors and/or multiple buses may be used, as appropriate, along with multiple memories and types of memory. Also, multiple computing devices 5500 may be connected, with each device providing portions of the necessary operations (e.g., as a server bank, a group of blade servers, or a multi-processor system).

Memory 5504 may store information within the computing device 5500. In one implementation, the memory 5504 may be a volatile memory unit or units. In another implementation, the memory 5504 may be a non-volatile memory unit or units. The memory 5504 may also be another form of computer-readable medium, such as a magnetic or optical disk.

Storage device 5506 may be capable of providing mass storage for the computing device 5500. In one implementation, the storage device 5506 may be or contain a computer-readable medium, such as a floppy disk device, a hard disk device, an optical disk device, or a tape device, a flash memory or other similar solid-state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 5504, the storage device 5506, memory on processor 5502, or a propagated signal.

High speed controller 5508 may manage bandwidth-intensive operations for the computing device 5500, while the low-speed controller 5512 may manage lower bandwidth-intensive operations. Such allocation of functions is exemplary only. In one implementation, the high-speed controller 5508 may be coupled to memory 5504, display 5516 (e.g., through a graphics processor or accelerator), and to high-speed expansion ports 5510, which may accept various expansion cards (not shown). In the implementation, low-speed controller 5512 is coupled to storage device 5506 and low-speed expansion port 5514. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

Computing device 5500 may be implemented in a number of different forms, as shown in the figure. For example, it may be implemented as a standard server 5520, or multiple times in a group of such servers. It may also be implemented as part of a rack server system 5524. In addition, it may be implemented in a personal computer such as a laptop computer 5522. Alternatively, components from computing device 5500 may be combined with other components in a mobile device (not shown), such as device 5550. Each of such devices may contain one or more of computing device 5500, 5550, and an entire system may be made up of multiple computing devices 5500, 5550 communicating with each other.

Computing device 5550 may include a processor 5552, memory 5564, an input/output device such as a display 5554, a communication interface 5566, and a transceiver 5568, among other components. The device 5550 may also be provided with a storage device, such as a microdrive or other device, to provide additional storage. Each of the components 5550, 5552, 5564, 5554, 5566, and 5568, may be interconnected using various buses, and several of the components may be mounted on a common motherboard or in other manners as appropriate.

Processor 5552 may execute instructions within the computing device 5550, including instructions stored in the memory 5564. The processor may be implemented as a chipset of chips that include separate and multiple analog and digital processors. The processor may provide, for example, for coordination of the other components of the device 5550, such as control of user interfaces, applications run by device 5550, and wireless communication by device 5550.

In some embodiments, processor 5552 may communicate with a user through control interface 5558 and display interface 5556 coupled to a display 5554. The display 5554 may be, for example, a TFT LCD (Thin-Film-Transistor Liquid Crystal Display) or an OLED (Organic Light Emitting Diode) display, or other appropriate display technology. The display interface 5556 may comprise appropriate circuitry for driving the display 5554 to present graphical and other information to a user. The control interface 5558 may receive commands from a user and convert them for submission to the processor 5552. In addition, an external interface 5562 may be provide in communication with processor 5552, so as to enable near area communication of device 5550 with other devices. External interface 5562 may provide, for example, for wired communication in some implementations, or for wireless communication in other implementations, and multiple interfaces may also be used.

In some embodiments, memory 5564 may store information within the computing device 5550. The memory 5564 can be implemented as one or more of a computer-readable medium or media, a volatile memory unit or units, or a non-volatile memory unit or units. Expansion memory 5574 may also be provided and connected to device 5550 through expansion interface 5572, which may include, for example, a SIMM (Single In Line Memory Module) card interface. Such expansion memory 5574 may provide extra storage space for device 5550, or may also store applications or other information for device 5550. Specifically, expansion memory 5574 may include instructions to carry out or supplement the processes described above, and may include secure information also. Thus, for example, expansion memory 5574 may be provide as a security module for device 5550, and may be programmed with instructions that permit secure use of device 5550. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product may contain instructions that, when executed, perform one or more methods, such as those described above. The information carrier may be a computer- or machine-readable medium, such as the memory 5564, expansion memory 5574, memory on processor 5552, or a propagated signal that may be received, for example, over transceiver 5568 or external interface 5562.

Device 5550 may communicate wirelessly through communication interface 5566, which may include digital signal processing circuitry where necessary. Communication interface 5566 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 5568. In addition, short-range communication may occur, such as using a Bluetooth, WiFi, or other such transceiver (not shown). In addition, GPS (Global Positioning System) receiver module 5570 may provide additional navigation- and location-related wireless data to device 5550, which may be used as appropriate by applications running on device 5550.

Device 5550 may also communicate audibly using audio codec 5560, which may receive spoken information from a user and convert it to usable digital information. Audio codec 5560 may likewise generate audible sound for a user, such as through a speaker, e.g., in a handset of device 5550. Such sound may include sound from voice telephone calls, may include recorded sound (e.g., voice messages, music files, etc.) and may also include sound generated by applications operating on device 5550.

Computing device 5550 may be implemented in a number of different forms, as shown in the figure. For example, it may be implemented as a cellular telephone 5580. It may also be implemented as part of a smartphone 5582, personal digital assistant, or other similar mobile device.

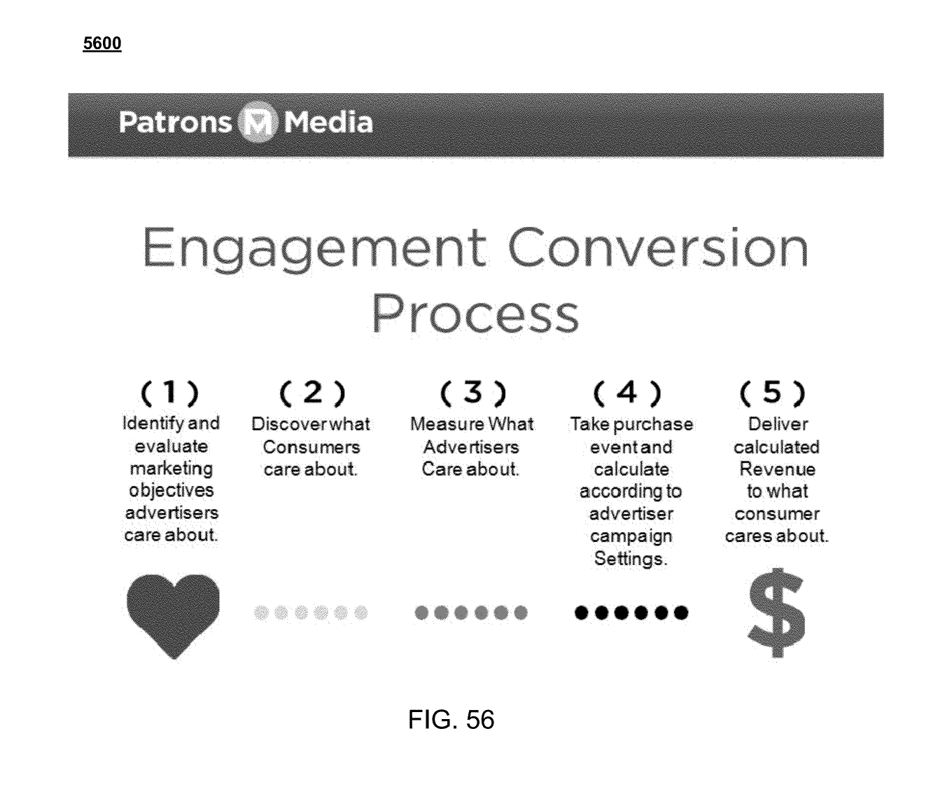

Referring now to FIG. 56, an embodiment showing one possible example of an engagement conversion process consistent with marketing process 10 is provided. In this five operation process, marketing process 10 may be configured to identify and evaluate the marketing objectives that advertisers are interested in and also identify what products, companies, etc consumers are interested in. Marketing process 10 may also measure what advertisers are interested in. Once a purchase event has been identified, marketing process 10 may be configured to use that purchase event to calculate revenue according to one or more advertiser campaign settings or parameters. In some embodiments, this calculated revenue may be delivered to one or more beneficiaries that have been set forth by the consumer.

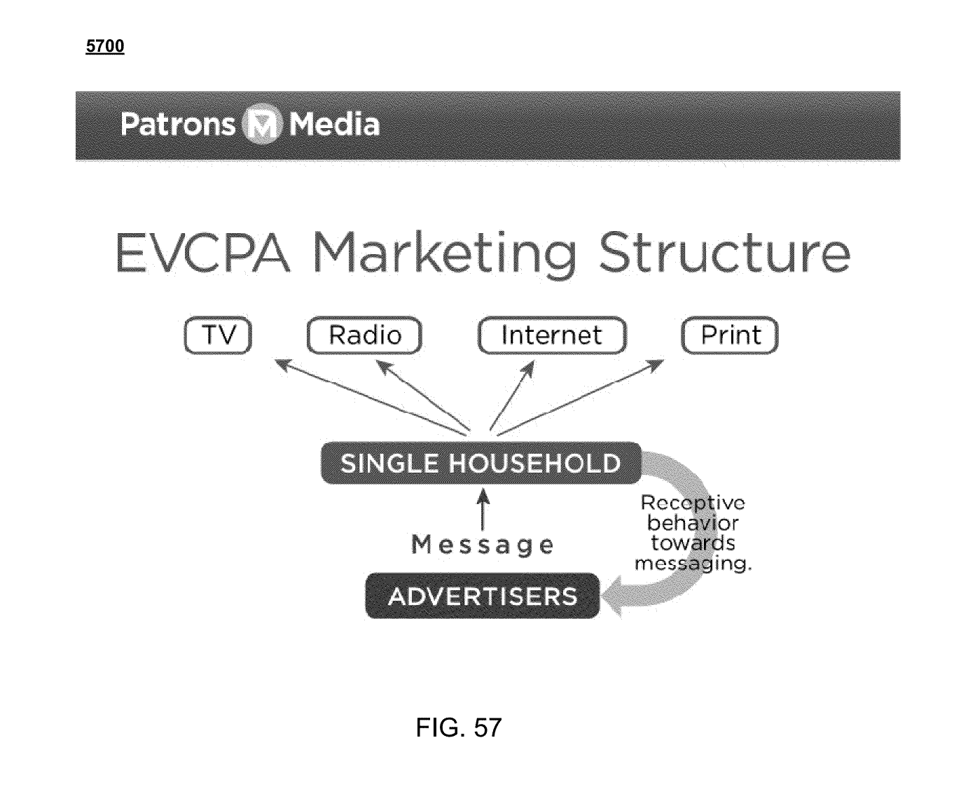

Referring now to FIG. 57, an embodiment showing an example of a marketing structure consistent with marketing process 10 is provided. As shown in the figure, in some embodiments, marketing process 10 may allow advertisers to transmit a particular message to a household if that household has indicated that they are receptive towards receiving such a message. This type of configuration may help to minimize unwanted advertisements and the resulting resentment of consumers.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

As will be appreciated by one skilled in the art, the present disclosure may be embodied as a method, system, or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present disclosure is described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here may be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system may include clients and servers. A client and server are generally remote from each other and typically interact through a communication network. The relationship of client and server arises by virtue of computer programs running on the respective computers and having a client-server relationship to each other.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

1. A computer-implemented method comprising:
generating, using one or more computing devices, a plurality of user accounts, each associated with a particular user, the plurality of user accounts associated with a crowd-funding website;
allowing, via a graphical user interface associated with at least one of the plurality of user accounts, the particular user to determine what personal information to disclose to one or more merchants;
assigning an initial engagement value to each user account based upon, at least in part, each user's actions with one or more merchants;
identifying at least one trackable purchase event associated with each user account; and
adjusting the initial engagement value based upon a level of personal information disclosed to the one or more merchants and the at least one trackable purchase event.

2. The computer-implemented method of claim 1, further comprising:
allowing, via the plurality of user accounts, at least one financial contribution to a beneficiary.

3. The computer-implemented method of claim 1, wherein allowing includes allowing a plurality of contributions to a plurality of beneficiaries.

4. The computer-implemented method of claim 1, wherein the plurality of user accounts each include a security randomizer.

5. The computer-implemented method of claim 1, wherein the crowd-funding website includes an ignition phase.

6. The computer-implemented method of claim 1, wherein the crowd-funding website includes an achievement phase.

7. The computer-implemented method of claim 1, wherein the crowd-funding website includes a sustain phase.

8. A computer-readable storage medium having stored thereon instructions that when executed by a machine result in the following operations:
generating, using one or more computing devices, a plurality of user accounts, each associated with a particular user, the plurality of user accounts associated with a crowd-funding website;
allowing, via a graphical user interface associated with at least one of the plurality of user accounts, the particular user to determine what personal information to disclose to one or more merchants;
assigning an initial engagement value to each user account based upon, at least in part, each user's actions with one or more merchants;
identifying at least one trackable purchase event associated with each user account; and
adjusting the initial engagement value based upon a level of personal information disclosed to the one or more merchants and the at least one trackable purchase event.

9. The computer-readable storage medium of claim 8, further comprising:
allowing, via the plurality of user accounts, at least one financial contribution to a beneficiary.

10. The computer-readable storage medium of claim 8, wherein allowing includes allowing a plurality of contributions to a plurality of beneficiaries.

11. The computer-readable storage medium of claim 8, wherein the plurality of user accounts each include a security randomizer.

12. The computer-readable storage medium of claim 8, wherein the crowd-funding website includes an ignition phase.

13. The computer-readable storage medium of claim 8, wherein the crowd-funding website includes an achievement phase.

14. The computer-readable storage medium of claim 8, wherein the crowd-funding website includes a sustain phase.

15. A system comprising:
a computing device having at least one processor configured to generate a plurality of user accounts, each associated with a particular user, the plurality of user accounts associated with a crowd-funding website, the one or more processors further configured to allow, via a graphical user interface associated with at least one of the plurality of user accounts, the particular user to determine what personal information to disclose to one or more merchants, the one or more processors further configured to assign an initial engagement value to each user account based upon, at least in part, each user's actions with one or more merchants, the one or more processors further configured to identify at least one trackable purchase event associated with each user account, the one or more processors further configured to adjust the initial engagement value based upon a level of personal information disclosed to the one or more merchants and the at least one trackable purchase event.

16. The system of claim 15, wherein the one or more processors are further configured to allow, via the plurality of user accounts, at least one financial contribution to a beneficiary.

17. The system of claim 15, wherein allowing includes allowing a plurality of contributions to a plurality of beneficiaries.

18. The system of claim 15, wherein the plurality of user accounts each include a security randomizer.

19. The system of claim 15, wherein the crowd-funding website includes an ignition phase.

20. The system of claim 15, wherein the crowd-funding website includes an achievement phase.
